(19) United States
(12) Patent Application Publication
(10) Pub. No.: US 2016/0130370 A1
(43) Pub. Date: May 12, 2016

(54) COMPOSITIONS AND STRUCTURES INCLUDING NONAGGREGATED STABILIZED CHARGED POLYSACCHARIDE NANOFIBERS, METHODS OF MAKING NONAGGREGATED STABILIZED CHARGED POLYSACCHARIDE NANOFIBERS, AND METHOD OF MAKING STRUCTURES

(71) Applicant: Georgia Tech Research Corporation, Atlanta, GA (US)

(72) Inventors: James Carson Meredith, III, Marietta, GA (US); Jie Wu, Pearland, TX (US)

(21) Appl. No.: 14/934,236

(22) Filed: Nov. 6, 2015

Related U.S. Application Data
(60) Provisional application No. 62/076,894, filed on Nov. 7, 2014.
(60) Provisional application No. 62/137,553, filed on Mar. 24, 2015.

(51) Int. Cl. C08B 37/08; C08L 71/02

(52) U.S. Cl. CPC C08B 37/003; C08L 71/02

(57) ABSTRACT

Embodiments of the present disclosure provide compositions, structures such as films and foams, methods of making nonaggregated stabilized charged polysaccharide nanofibers (e.g., nonaggregated stabilized cationized chitin nanofibers), methods of making structures such as films and foams, and the like.

### CLAIM OF PRIORITY TO RELATED APPLICATION

This application claims priority to co-pending U.S. application entitled “Methods for Producing Chitin or Chitosan Nanofibers and Barrier Materials Containing Chitin or Chitosan Nanofibers” having Ser. No. 62/076,894, filed on Nov. 7, 2014, which is entirely incorporated herein by reference.

This application also claims priority to co-pending U.S. application entitled “Controlled-Temperature Freeze Drying of Polysaccharide Nanofiber Dispersions” having Ser. No. 62/137,553, filed on Mar. 24 2015, which is entirely incorporated herein by reference.

### BACKGROUND

Chitin, poly (β-(1-4)-N-acetyl-D-glucosamine), is the second most abundant biopolymer in nature, and is found as a principal component of the exocuticle of arthropods. Chitin is renewable, biodegradable and anti-bacterial and its crystallinity leads to high stiffness, and strength. However, chitin crystallinity creates severe extraction and processing challenges. At the molecular level chitin polymer chains can form various types of crystalline domains due to the strong hydrogen bonding of chitin, where these crystalline domains assemble into chitin nanofibrils of diameter about 3 nm, and are interconnected by amorphous domains. In a crustacean exocuticle, the nanofibrils form complexes with various proteins that possess chitin binding domains that attach to the outer fibril surfaces, while these protein-coated nanofibrils then assemble into larger nanofibers, and the chitin nanofibers assemble into microfiber bundles (diameter ˜1 μm range). Then, these microfibers lay parallel to one another into a flat sheet structure, and these sheets then lay onto one another with a characteristic twisting angle between each sheet, resulting in the so-called Bouligand structure. These materials can also incorporate mineral filler particles within the walls, mainly composed of calcium carbonate. Unfortunately, the chitin nanofibers are very strongly embedded into the exocuticle wall and microfiber structures, and they are as well wrapped with proteins. While there are methods for processing chitin, the current methods have various disadvantages. Thus, there is a need to process chitin material in an effective manner.

### SUMMARY

Embodiments of the present disclosure provide compositions, structures such as films and foams, methods of making nonaggregated stabilized charged polysaccharide nanofibers (e.g., nonaggregated stabilized cationized chitin nanofibers), methods of making structures such as films, coatings, foams, and the like.

An embodiment of the present disclosure provides for a composition, among others, that includes: a suspension of nonaggregated stabilized charged polysaccharide nanofibers (e.g., chitin nanofibers nonaggregated stabilized cationized chitin nanofibers) at a pH of about 1 to 6 or about 4 to 4.5, wherein the chitin nanofiber has a zeta potential of about 10 to 1000 or about 55 to 60 mV, wherein each chitin nanofiber has an aspect ratio of about 1 to 1000 or about 1 to 100, wherein the chitin nanofibers have an average diameter of about 10 to 50, about 10 to 30, or about 20 nm and a diameter range of about 2 to 100 or about 5 to 50 nm, and wherein the suspension has a viscosity of about 0.002 to 10 Pa·s.

An embodiment of the present disclosure provides for a structure, among others, that includes: nonaggregated stabilized charged polysaccharide nanofibers (e.g., nonaggregated stabilized cationized chitin nanofibers), wherein each chitin nanofiber has an aspect ratio of about 1 to 100, wherein the chitin nanofibers have an average diameter of about 20 nm and a diameter range of about 5 to 50 nm.

In an embodiment, the structure is a film, where the film has a thickness of 100 nm to 500 μm, wherein the film is optically transparent, wherein the film has a porosity of about 2 to 4%, wherein the film has a tensile strength of about 135 to 140 MPa, wherein the film has a Young's modulus of about 4.35 to 4.40 GPa. In an embodiment, the film has a CO₂ gas permeability of about 0.016 to 0.020 barrer, wherein the film has a O₂ gas permeability of about 0.005 to 0.007 barrer.

In an embodiment, the structure is a porous foam having an open structure or a closed structure, wherein the foam has a thickness of about 10 μm to 20 cm. In an embodiment, the porous foam has a pore size that can be selected from about 2.5 to 4 μm and a porosity of about 98 to 99%, about 50 to 70 μm and a porosity of about 99 to 99.9%, about 80 to 110 μm and a porosity of about 99 to 99.9%, or about 0.3 to 0.35 μm and a porosity of about 99 to 99.9%.

An embodiment of the present disclosure provides for a structure, among others, that includes: providing a first mixture (e.g., aqueous suspension) of aggregated chitin (or a polysaccharide); adjusting the pH of the first mixture to a pH of about 1 to 5 to form a second mixture (e.g., aqueous suspension); homogenizing the second mixture at a first pressure to form a third mixture (e.g., aqueous suspension); and homogenizing the third mixture at a second pressure to form a fourth mixture (e.g., aqueous suspension), wherein the first pressure and the second pressure are different, wherein the fourth mixture includes a suspension of nonaggregated stabilized cationized chitin nanofibers at a pH of about 1 to 5, wherein the chitin nanofiber has a zeta potential of about 55 to 60 mV, wherein each chitin nanofiber has an aspect ratio of about 1 to 100, wherein the chitin nanofibers have an average diameter of about 20 nm and a diameter range of about 5 to 50 nm, and wherein the suspension has a viscosity of about 0.002 to 10 Pa·s. In an embodiment, homogenizing the second mixture includes passing the second mixture through a first restriction e.g., a first tube at the first pressure to cause a pressure shear and so that the second mixture impinges upon an end of the first tube, the pressure shear and impingement upon the end of the tube lead to defibrillation of the aggregated chitin. In an embodiment, homogenizing the second mixture includes passing the second mixture through a second restriction e.g., second tube at the second pressure so that the second mixture impinges upon an end of the second tube, the pressure shear and impingement upon the end of the tube lead to defibrillation of the aggregated chitin and the pH causes the chiton fibers to become cationized chitin nanofibers that form a suspension of nonaggregated stabilized cationized chitin nanofibers (nonaggregated stabilized charged polysaccharide nanofibers).

An embodiment of the present disclosure provides for a method, among others, that includes: providing a suspension nonaggregated stabilized charged polysaccharide nanofibers (e.g., nonaggregated stabilized cationized chitin nanofibers) at a pH of about 1 to 5, wherein the chitin nanofiber has a zeta potential of about 55 to 60 mV, wherein each chitin nanofiber has an aspect ratio of about 1 to 100, wherein the chitin nanofibers have an average diameter of about 20 nm and a diameter range of about 5 to 50 nm, and wherein the suspension has a viscosity of about 0.002 to 10 Pa·s; freezing the suspension at a temperature of about −20 to −200° C. to form a frozen suspension; and exposing the frozen suspension to a vacuum to remove the water crystals to form a cationized chitin nanofiber foam.

### BRIEF DESCRIPTION OF THE DRAWINGS

Many aspects of the present disclosure can be better understood with reference to the following drawing.

FIG. 1.1 shows ¹³C CP-MAS solid state NMR of purified chitin from crab shells.

FIGS. 1.2A-D are SEM images. FIGS. 1.2A and 1.2C are SEM images of purified chitin (before homogenization) and chitin that was produced by a high pressure homogenization process of a neutral chitin/water dispersion (pH 7), respectively. FIGS. 1.2B and 1.2D are SEM images with higher magnification in comparison to FIGS. 1.2A and 1.2C respectively.

FIGS. 1.3A-D illustrate chitin/water appearance. Appearance of a cationized chitin dispersion before homogenization (0.5 wt. % of chitin) (1.3A); FIGS. 1.3B and 1.3C are digital photos of a dispersion of 0.5 wt % of homogenized chitin in water with pH 4.1, which was produced by a high pressure homogenization process of the cationized chitin/water; FIG. 1.3D shows light transmittance spectra of the cationized chitin/water (a) and homogenized chitin/water (pH 4.1, b) in the wavelength range of 400 to 800 nm.

FIGS. 1.4A-E are SEM images of the cationized chitin and homogenized chitin. (1.4A) and (1.4C) are SEM images of the cationized chitin before and after homogenization with a pH of 4.1, respectively; (1.4B) and (1.4D) are SEM images with higher magnification in comparison to (A) and (1.4C), respectively. (1.4E) is an SEM image of cationized chitin (pH 4.1) processed in the homogenizer without using the additional 10 passes in the 0.13 mm nozzle.

FIG. 1.5 illustrates plots of shear viscosity as a function of shear rate for dispersions of ChNF in water with a pH of 4.1.

FIG. 1.6 shows the storage modulus (G′) and loss modulus (G″) as a function of frequency for dispersions of ChNF in water with a pH of 4.1.

FIG. 1.7 shows the storage modulus (G′) and loss modulus (G″) as a function of frequency for homogenized chitin/water dispersion with a pH of 4.1 after only 4 passes through the 0.20 mm nozzle.

FIGS. 1.8A-D illustrate the appearance and flexibility of optically transparent dried ChNF films: (1.8A) flat film; (1.8B) bent film; (1.8C) AFM topography image of a dried ChNF film obtained by using tapping mode in air at room temperature; (1.8D) Light transmittance spectra of dried ChNF film in the wavelength range of 400 to 800 nm.

FIG. 1.9 shows the representative stress-strain curve of the dried ChNF films.

FIG. 1.10 shows the ATR-FTIR spectra of purified chitin powder (A) and a ChNF film (B).

FIG. 2.1 illustrates a SEM image of homogenized chitin nanofibers. FIGS. 2.2A-F illustrate freeze-dried chitin; FIG. 2.2A) photo, FIG. 2.2B) top, FIG. 2.2C) bottom, FIG. 2.2D) cross section, and FIG. 2.2E) enlarged top SEM images and FIG. 2.2F) pore size distribution of freeze-dried chitin produced under −20° C. freezing (aluminum dish).

FIGS. 2.3A-F are SEM images of freeze-dried chitin: FIG. 2.3A) top and FIG. 2.3B) cross section of sample produced at −80° C. freezing, FIG. 2.3C) top and FIG. 2.3D) cross section of sample produced under liquid nitrogen freezing; Pore size distributions of freeze-dried chitin: 2.3E) −80° C. freezing and FIG. 2.3F) liquid nitrogen freezing.

FIG. 2.4 is a schematic representation of assembly of chitin nanofibers under −20° C. freezing using aluminum dish: a) chitin nanofiber/water dispersion; b) chitin nanofiber/water dispersion with advent of ice nuclei; c) chitin nanofiber bundles encapsulated in ice.

FIGS. 2.5A-C are SEM images of chitin freeze-dried using indented stainless-steel mold: FIG. 2.5A) bottom, FIG. 2.5B) cross section in touch with stainless steel wall; FIG. 2.5C) pore size distribution of freeze-dried chitin under −20° C. freezing (stainless-steel mold).

FIG. 2.6 illustrates a schematic of stainless steel mold used for −20° C. freezing of chitin nanofibers. The overall dimensions are length×width×depth: 50×50×15 mm³ and the indented central portion that contains the sample is 20×20×0.8 mm³.

FIGS. 3.1A-F are SEM images. Fractured cross section (FIG. 3.1A) and top-view (FIG. 3.1C) SEM images of 10% ChNF/PEO composites. Fractured cross section (FIG. 3.1B) and top-view (FIG. 3.1D) SEM images of 20% ChNF/PEO composites. Top-view SEM images of dried solvent-washed 10% (FIG. 3.1E) and 20% (FIG. 3.1F) ChNF/PEO composites.

FIGS. 3.2A-B demonstrate the (FIG. 3.2A) Elastic modulus and (FIG. 3.2B) tensile strength of neat PEO and ChNF/PEO composites.

FIG. 3.3 shows FTIR spectra of each composite films: (a) neat PEO, (b) 5% ChNF/95% PEO, (c) 10% ChNF/90% PEO, (d) 15% ChNF/85% PEO, (e) 20% ChNF/80% PEO, and (f) neat ChNF.

FIG. 3.4 shows FTIR spectra of composite films in the 1500 to 1800 cm⁻¹ region: (a) neat PEO, (b) 5% ChNF/95% PEO, (c) 10% ChNF/90% PEO, (d) 15% ChNF/85% PEO, (e) 20% ChNF/80% PEO, and (f) neat ChNF.

FIGS. 3.5A-B are SEM images. FIG. 3.5A) SEM image of an AFM probe of ChNF-coated PS particle after all AFM force measurements; FIG. 3.5B) Enlarged SEM image of surface morphology of ChNF-coated PS particle.

FIG. 3.6 shows adhesion forces for ChNF-coated and bare PS particles on various polymer surfaces.

FIG. 3.7 demonstrates fitting of the planar model of equation 4 to adhesion force data for ChNF-coated PS colloidal probes with five substrates of varying polarity.

FIG. 3.8 shows fractured cross section SEM image of neat PEO film (note: voids in the image were caused by electron beam radiation damage during imaging).

FIGS. 3.9A-E are digital photos. FIGS. 3.9A, 3.9C, and 3.9E are digital photos of neat PEO, 5% ChNF/PEO and 20% ChNF/PEO films that were immersed in water, respectively. The photos were taken ˜30 s after placing these films in water; (3.9B) is digital photo of neat PEO film after ˜3 hours of water immersion; (3.9D) and (3.9F) are digital photos of 5% ChNF/PEO and 20% ChNF/PEO films that were immersed in ethanol, respectively. The films were firstly immersed in water for 10 days and then immersed in ethanol for 3 days.

FIG. 3.10 shows typical AFM force-distance curves for ChNF-coated PS particles adhering to various polymer surfaces.

FIG. 4.1 illustrates the structure of a chitin co-polymer, x and y can independently have values over a wide range, from 1 to 10,000,000, wherein x is greater than y.

FIGS. 4.2A-B are SEM images of (4.2A) fibrillated ChNFs from the purified chitin and (4.2B) CNF dense film.

FIGS. 4.3A and 4.3C photos represent 1% ChNF aqueous suspension at pH 4.1 before and after frothing by a rotor-stator homogenizer, respectively; 4.3B and 4.3D photos represent 1% ChNF aqueous suspension at pH 5.8 before and after frothing respectively. 4.3C and 4.3D photos were immediately taken after frothing.

FIG. 4.4 is a schematic of the formation of ChNF stabilized foams.

FIGS. 4.5A-C are digital photos of the 50 mmol/l valeric acid in water before, during and after frothing by a rotor-stator homogenizer, respectively; 4.5D-F are digital photos of the frothed 1 mmol/l, 5 mmol/l and 25 mmol/l valeric acid in 0.1% ChNF/water dispersion, respectively (photos were taken 2 mins after frothing); 4.5G and 4.5H photos represent 30 mins and 24 hours after the aeration of 5 mmol/l valeric acid/0.1% ChNF/water dispersion, respectively; 4.5Iphoto was taken 24 hours after the aeration of 25 mmol/l valeric acid/0.1% ChNF/water dispersion.

FIG. 4.6 is an optical microscope image of 5 mmol/l valeric acid/0.1% ChNF in water dispersion.

FIGS. 4.7A-D are SEM images of 0.1% ChNF/5 mmol/l valeric acid foams. (4.7A) Top of the bubble cluster; (4.7B) Top of the single dispersed bubble; (4.7C) and (4.7D) are enlarged top SEM images of the bubble edge and bubble center respectively.

FIGS. 4.8A-C are digital photos of the frothed 1 mmol/l, 5 mmol/l and 25 mmol/l valeric acid in 1% ChNF/water dispersion, respectively (photos were taken 2 mins after frothing); FIGS. 4.8D-F photos represent 1, 3 and 24 hours after the aeration of 5 mmol/l valeric acid/1% ChNF/water dispersion, respectively.

FIG. 4.9 is an optical microscope image of 5mmol/l valeric acid/1% ChNF in water dispersion.

FIGS. 4.10A-F are SEM images of 1% ChNF/5 mmol/l valeric acid foams. (4.10A) Top of bubble cluster; (4.10B) Top of single dispersed bubble; (4.10C) Cross section of bubble cluster; (4.10D), (4.10E) and (4.10F) are the enlarged top SEM images of intersections of three bubbles, bubble edge and bubble center, respectively.

FIGS. 4.11A and 4.11B represent the 1% ChNF/water dispersion with top-down and upside-down placement, respectively.

FIG. 4.12 demonstrates representative curves of fifth overtone QCM shifts in frequency (Hz) as a function of time for valeric acid adsorption on the ChNF surface.

FIGS. 4.13A-C represent the frothed 1% ChNF dispersions with addition of propionic acids (25 mmol/l), enanthic acids (0.5 mmol/l) and caprylic acids (0.5 mmol/l), respectively.

### DISCUSSION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of organic chemistry, material science, and the like, which are within the skill of the art. Such techniques are explained fully in the literature.

Prior to describing the various embodiments, the following definitions are provided and should be used unless otherwise indicated.

Unless otherwise defined, all technical and scientific terms used herein have the same meaning as commonly understood by one of ordinary skill in the art of microbiology, molecular biology, medicinal chemistry, and/or organic chemistry. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion:

Embodiments of the present disclosure provide compositions, structures such as films and foams, methods of making nonaggregated stabilized charged polysaccharide nanofibers (e.g., nonaggregated stabilized cationized chitin nanofibers), methods of making structures such as films and foams, and the like. Embodiments of the present disclosure can be advantageous in that by-product materials (e.g., waste from processing shell fish) have low cost current uses (e.g., fillers in concrete) and are sometimes discarded as waste can be used as a base material to produce the materials of the present disclosure. In addition, embodiments of the present disclosure can be advantageous in that strongly acidic conditions and use of toxic and volatile organic solvents are not needed for the homogenization step as compared to currently used processes. In addition, the high barrier properties of embodiments of the present disclosure are advantageous, supporting application in barrier packaging. The compositions and structures of the present disclosure are biodegradable unlike currently used petroleum-based plastics. While providing an alternative and “green” solution to currently used materials, embodiments of the present disclosure provide structures that have as good as or superior properties or characteristics (e.g., gas barrier properties for O₂ and CO₂) as presently used materials.

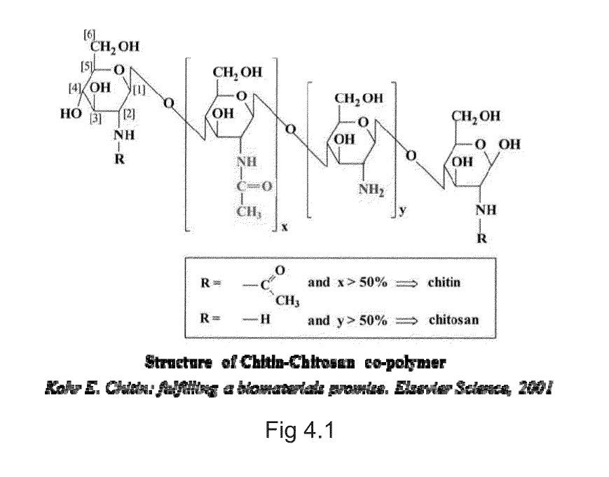

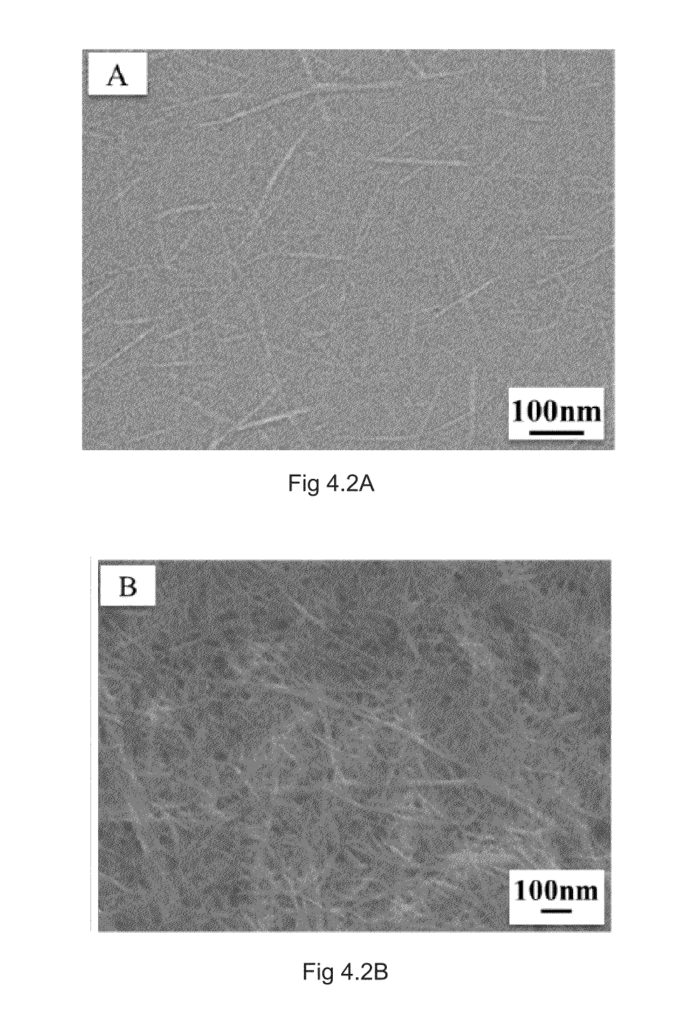

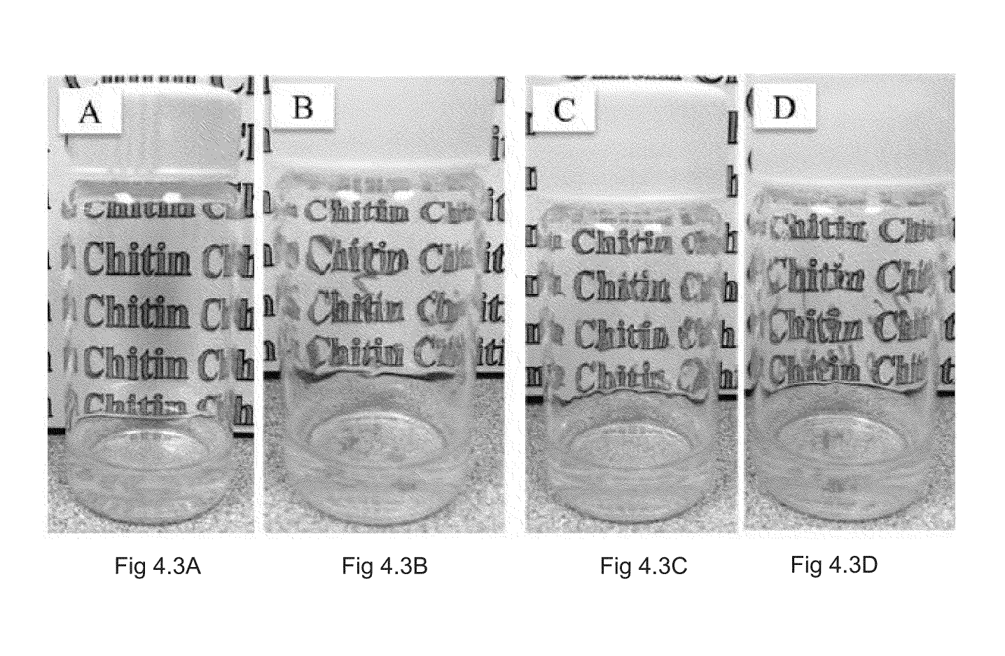

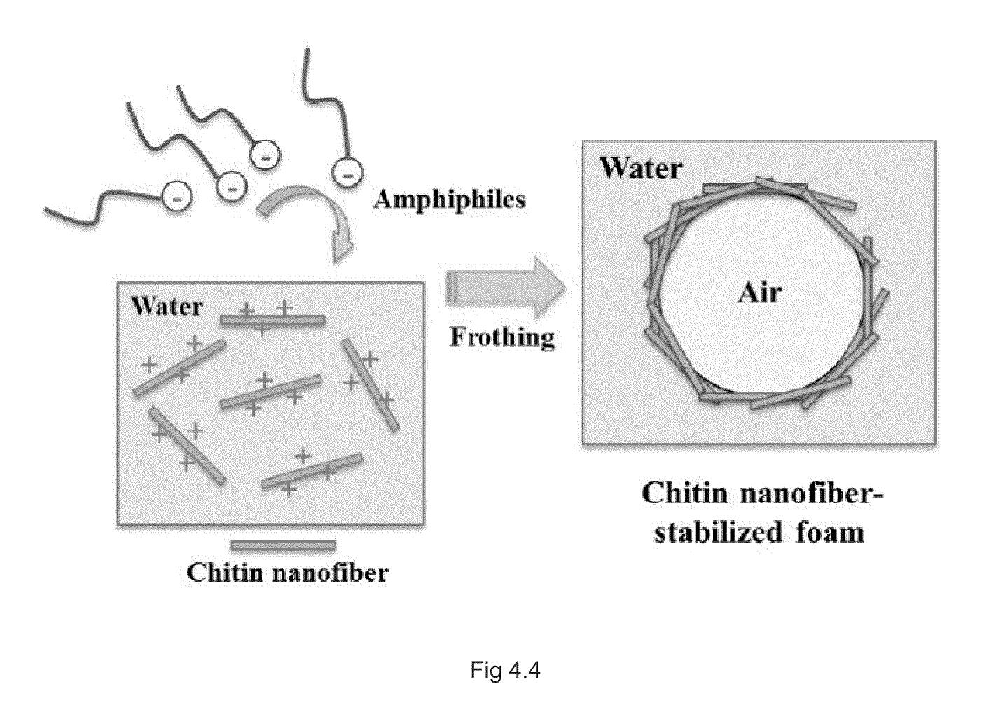

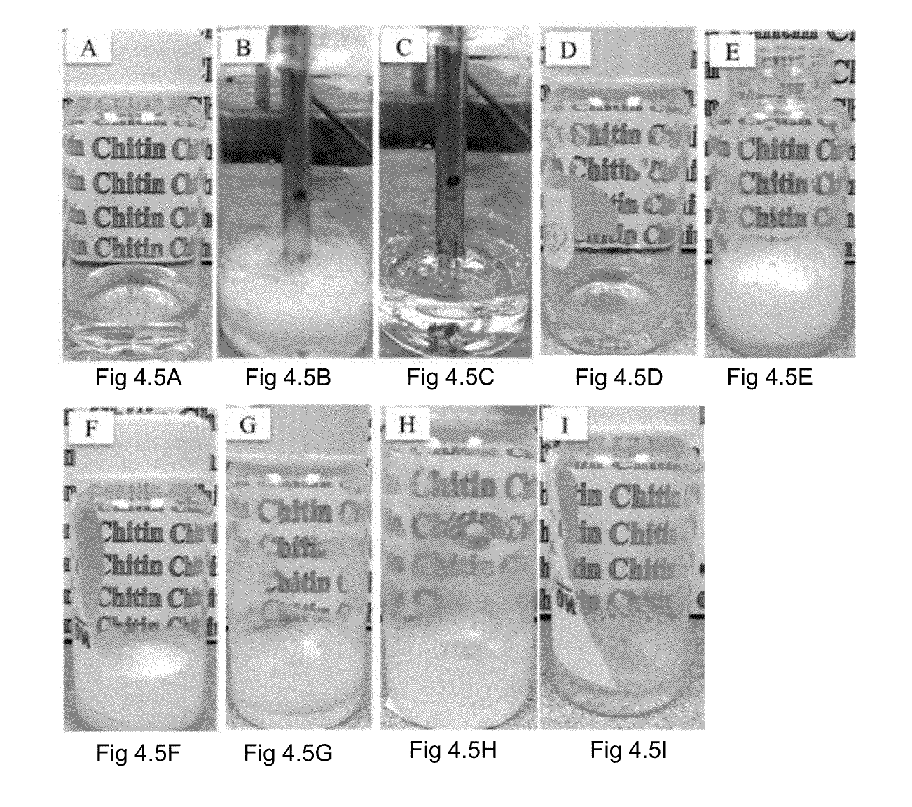

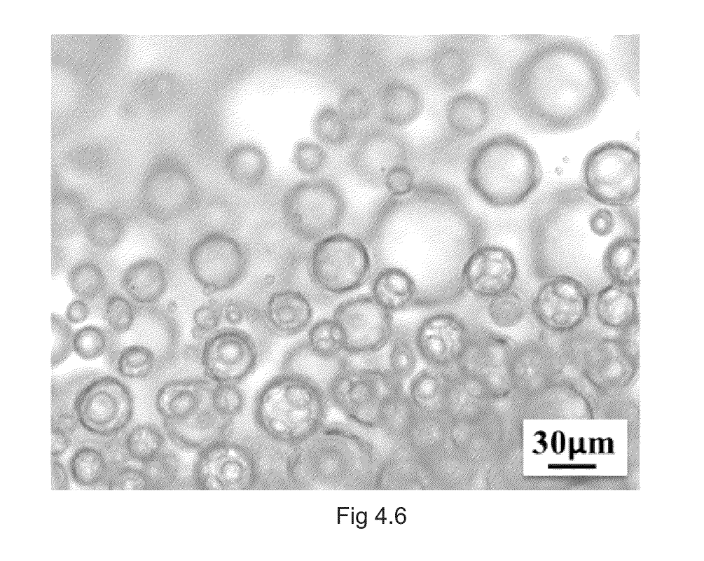

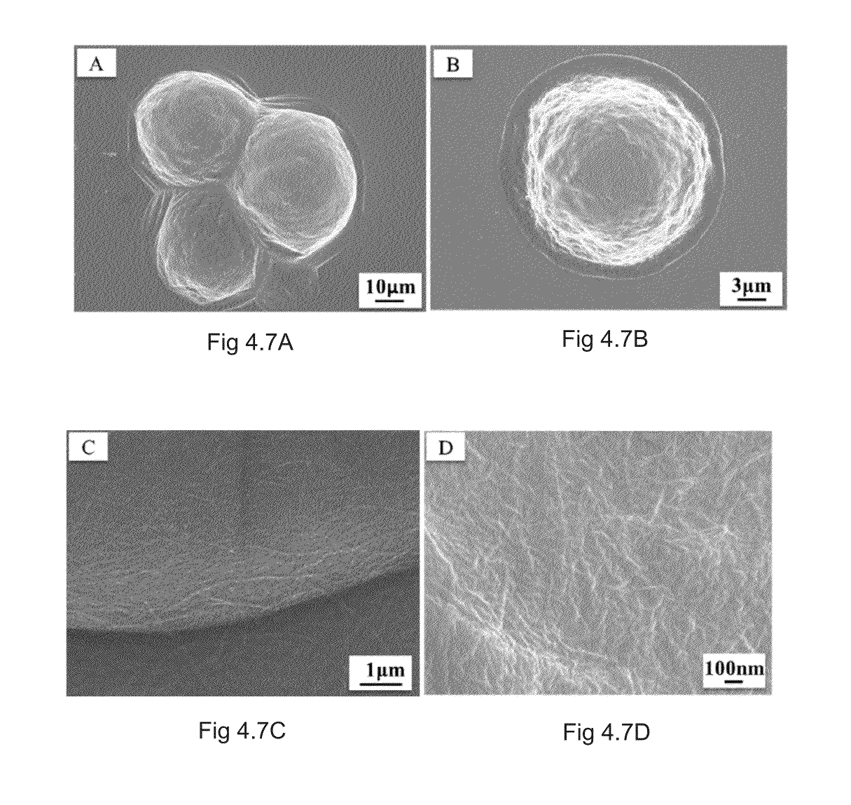

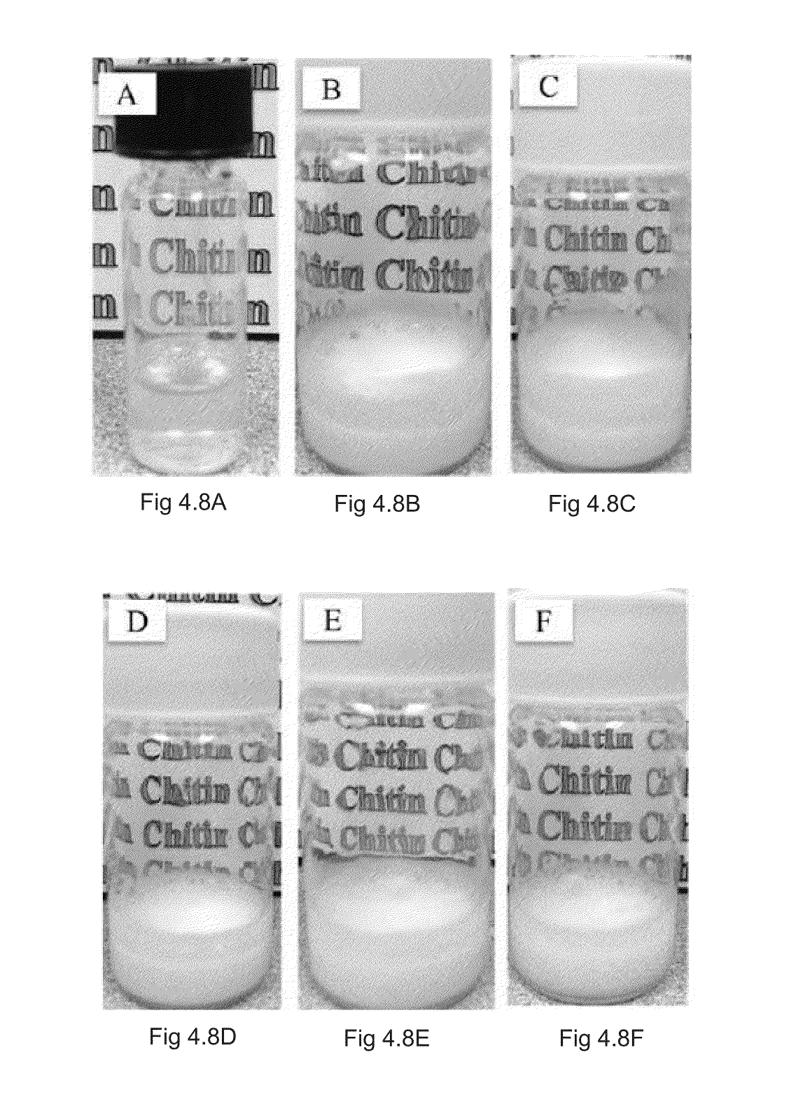

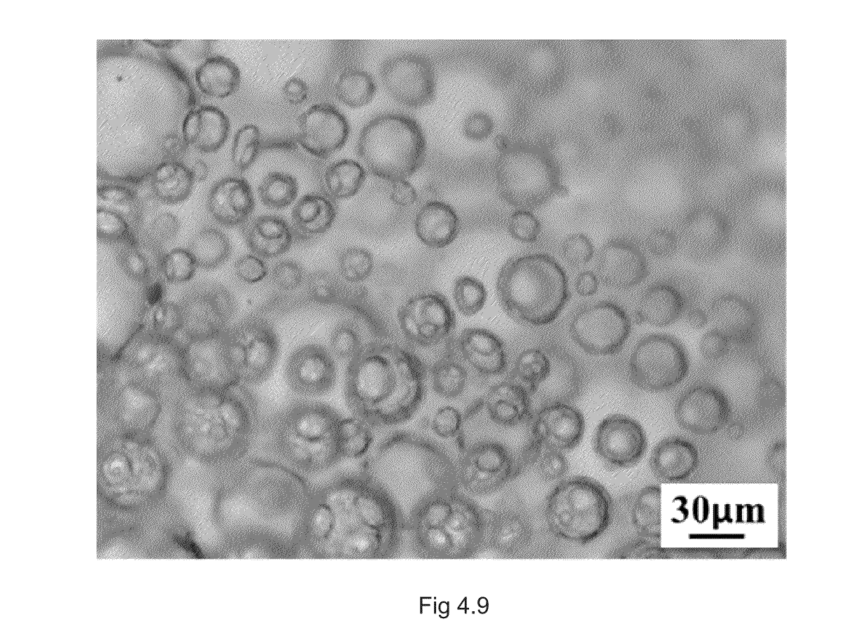

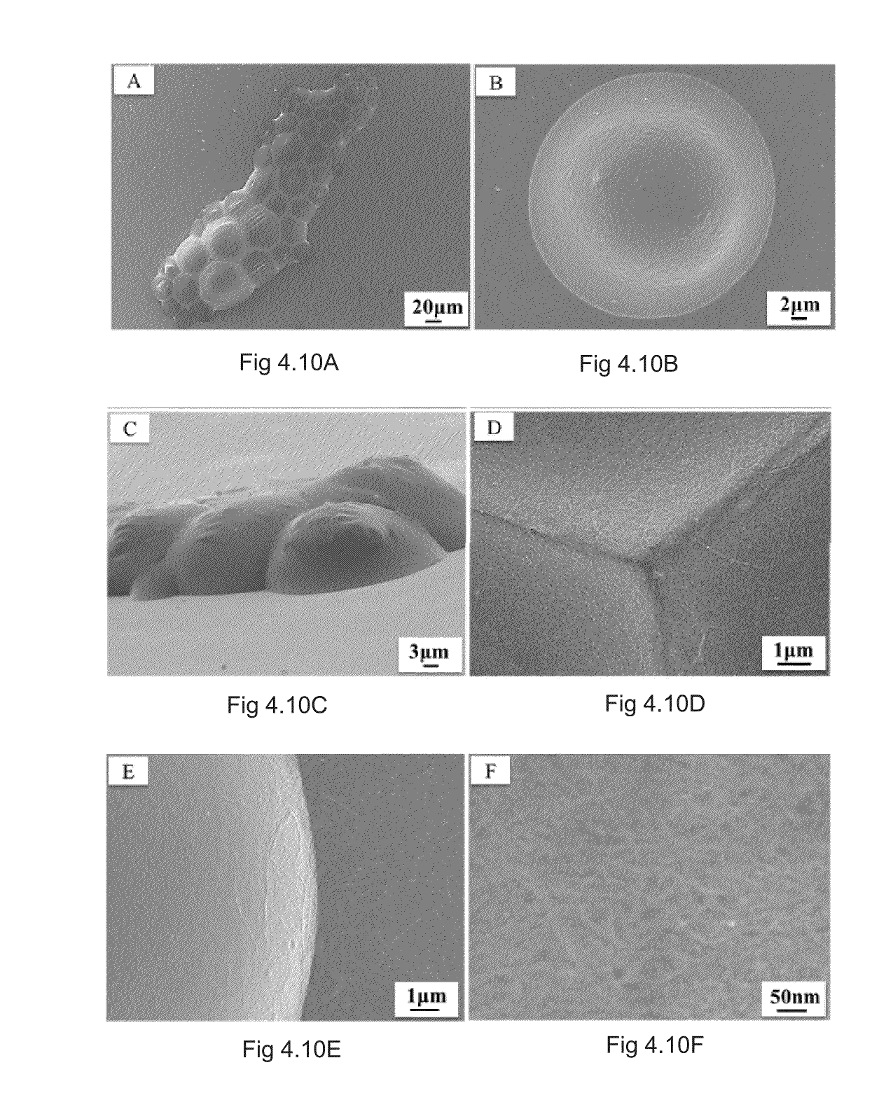

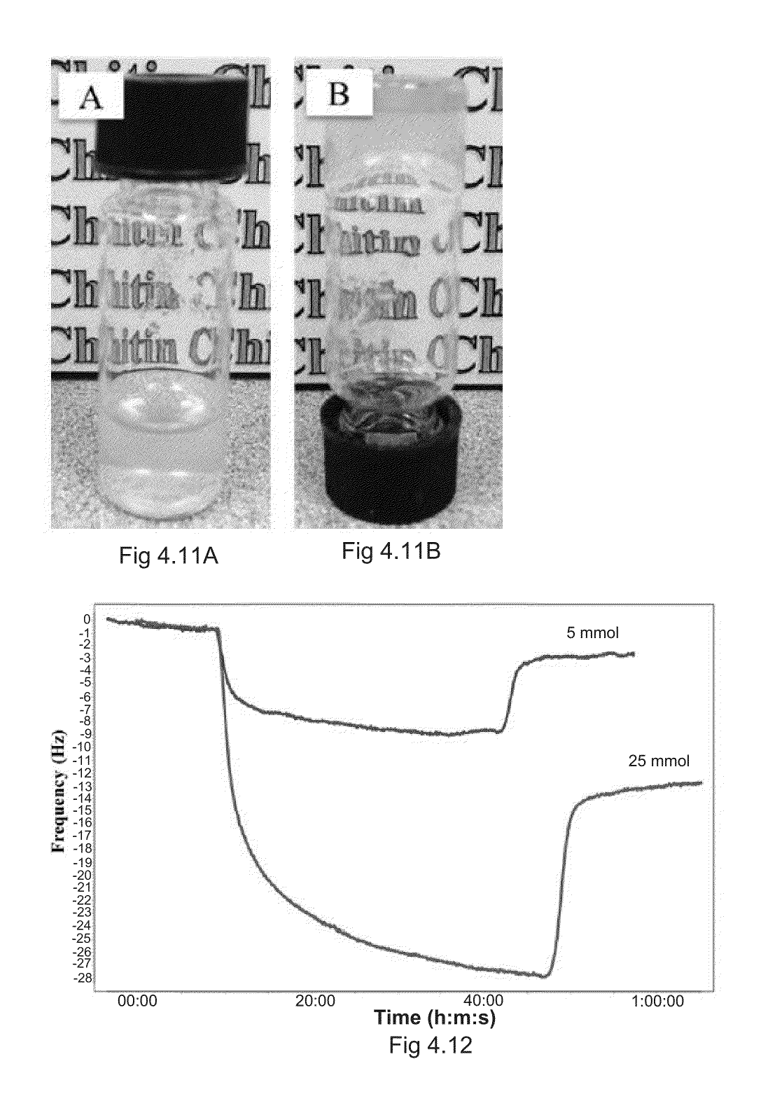

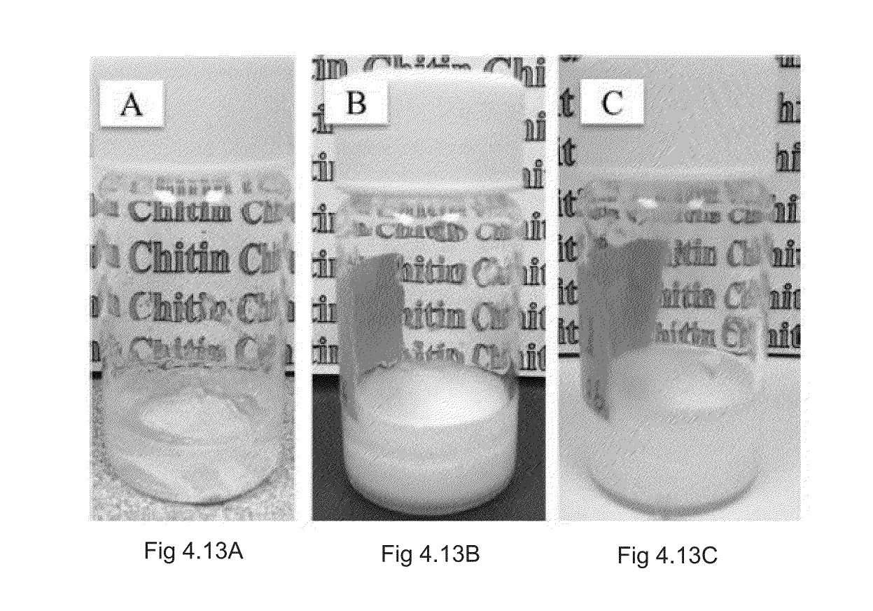

An embodiment of the present disclosure provides for a composition that includes nonaggregated stabilized charged polysaccharide nanofibers at a pH of about 1 to 5. In an embodiment, the compositions and structures can include polysaccharide fibers such as chitin, cellulose, starch, and the like. In an embodiment, polysaccharide does not include chitosan since chitosan dissolves and does not form a fiber. In particular, the present disclosure provides for nonaggregated stabilized cationized chitin nanofibers. FIG. 4.1 illustrates the structure of chitin. As described herein, chitin is a co-polymer of pure chitin and pure chitosan monomers, as seen in the structure in FIG. 4.1. It is commonly accepted that a material is considered chitin, and as defined for purposes of the present disclosure, when the content of the co-polymer is greater than 50% pure chitin and less than 50% pure chitosan. Pure chitin and pure chitosan differ by the presence, or absence, of an acetyl group. In an embodiment, chitin nanofibers have about 6-10% chitosan groups.

Although the present disclosure is broadly directed to nonaggregated stabilized charged polysaccharide nanofibers, some descriptions and discussions are directed towards nonaggregated stabilized cationized chitin nanofibers, however, this is done for reasons of clarity, and embodiments directed to nonaggregated stabilized charged polysaccharide nanofibers is intended to be covered without limitation to nonaggregated stabilized cationized chitin nanofibers.

In a particular embodiment, the composition includes a suspension of nonaggregated stabilized cationized chitin nanofibers at a pH of about 1 to 5, about 2 to 5, about 3.5 to 4.5, or about 4 to 4.5. Although not intended to be bound by theory, as mentioned above chitin fibers are bound tightly together (e.g., very strong intra- and inter-hydrogen bonding) but once the chitin material is mechanically defibrillated and exposed to a pH of about 1 to 5, where the pH protonates surface —NH₂ groups to NH₃⁺, the protonated groups produce electrostatic repulsion between individual chitin nanofibers that stabilize the dispersion chiton nanofibers so the chitin fibers do not reform their previous structure.

In an embodiment, the nonaggregated stabilized cationized chitin nanofibers can have a zeta potential of about +10 mV to +100 mV or about +55 to +60 mV. In an embodiment, the nonaggregated stabilized cationized chitin nanofiber dispersion in water can have a viscosity of about 0.002 to 10 Pa·s, about 0.005 to 1 Pa·s or about 0.01 to 0.1 Pa·s, depending on concentration, aspect ratio, and zeta potential.

In an embodiment, each of the nonaggregated stabilized cationized chitin nanofibers can have an aspect ratio of about 1 to 200 or about 1 to 50. The chitin nanofibers can have an average diameter of about 15 to 25 or about 20 nm. The chitin nanofibers can have a diameter of about 5 to 400, about 5 to 200, about 5 to 100, or about 5 to 50 nm.

In an embodiment, the nonaggregated stabilized charged polysaccharide nanofibers can be used to form structures such as films or foams. In an embodiment, the structure is a self-standing film or a film coating applied to a polymeric material. In an embodiment, the polymeric material can be a thermoplastic, thermoset, or elastomer. In a particular embodiment, the stabilized charged polysaccharide nanofibers can be stabilized cationized chitin nanofibers. In an embodiment, the structures can be 100% (e.g., pure) stabilized cationized chitin nanofibers, while in other embodiments, the film can include other materials such as polymers (e.g., poly(ethylene terephthalate) (PET), polyethylene (PE), poly(propylene) (PP), polyethylene oxide (PEO), poly(amide) (PA) epoxy, polyurethane (PU), poly(vinyl alcohol) (PVOH) and poly(ethylene vinyl alcohol) (EVOH)) and conventional additives such as tackifiers, stabilizers, viscosity regulators, fillers, pigments, plasticizers, and antioxidants, where the each of the other materials can be about 0.5 wt % to 90 wt % of the film.

In an embodiment, the cationized chitin nanofiber can be modified by the adsorption of an anionic amphiphile to its surface. In an embodiment, the anionic amphiphile can include a C1 to C10 carboxylic acid such as propionic acid, butyric acid, valeric acid, caproic acid, enanthic acid, and the like. In an embodiment, the anionic amphiphile can cover about 0.1 to 90% of the surface of the cationized chitin nanofiber.

In regard to a film, the film is flexible and mechanically stable. In particular, the film can have a tensile strength of about 135 to 140 MPa, about 100 to 500 MPa or about 10 to 1000 MPa. In an embodiment, the film can have a Young's modulus of about 1 to 10 GPa or about 4.0 to 5.0 GPa or about 4.3 to 4.4. The strain at break of the film can be about 5 to 10% or about 7 to 8%.

In an embodiment, the film can be a composite film of a water-soluble polymer and nonaggregated stabilized cationized chitin nanofibers. The composite film can have improved properties over the pure polymer film, where the properties include tensile strength, elastic modulus, optical clarity, barrier performance and abrasion resistanceBV. In these films, nonaggregated stabilized cationized chitin nanofiber (ChNFs) form an interconnected network that results in significant stress transfer during mechanical loading, resulting in improved mechanical properties. The optical clarity of the original polymer is maintained due to the nanoscale size of the ChNFs. The randomly oriented network of ChNFs is expected to result in improved barrier performance, due to the crystalline nature of ChNFs. For example, the polymer can be PEO, for which a composite film of PEO with ChNFs has a tensile strength of about 6 to 10 MPa at a nonaggregated stabilized cationized chitin nanofiber loading of about 10 to 20 wt % and an elastic modulus of about 14 to 30 at nonaggregated stabilized cationized chitin nanofibers loading of about 10 to 20 wt %.

In an embodiment, the film can have a thickness of about 100 nm to 500 μm, while the length/width/diameter can vary depending upon the application (e.g., from mm to cm to larger). In an embodiment, the film is optically transparent, with optical transmission over wavelengths of 400 to 800 nm in excess of 70%.

In an embodiment, the film can have superior gas permeability properties relative to other known films. For example, an embodiment of the film can have a dry CO₂ gas permeability of up to about 0.02 or about 0.01 to 0.02 barrer and a dry O₂ gas permeability of up to about 0.007 or about 0.005 to 0.007 barrer. Other gas permeabilities that can be achieved by the film of the present disclosure includes up to about 0.03 or about 0.02 to 0.03 barrer for H₂, up to about 0.004 or about 0.003 to 0.004 barrer for N₂ and/or up to about 0.003 or about 0.002 to 0.003 barrer for CH₄. In an embodiment, the film can have gas permeability for each of the gases listed above.

Embodiments of the films can be used in barrier packaging where the packaging is to be a barrier for gases such as O₂, CO₂, and the like. For example, the barrier packaging can be used in food product packaging such as meat, poultry, seafood, vegetables, fruits, and the like. In addition, the film can be used in electronics to prevent contamination or degradation that can be caused by exposure to air or particular gases such as O₂ and CO₂ and in pharmaceuticals to prevent exposure to water, water vapor and O₂.

In regard to foams, embodiments of the foams can include a porous solid foam having an open structure or a closed structure. In an embodiment, the solid foam can have a thickness of about 10 μm to 20 cm. The porous solid foam can have pores that extend through the entire width of the foam, while other porous solid foams can include closed or substantially closed pores that do not extend through the entire width of the foam. In an embodiment, the pore size and porosity can be controlled by selecting the freezing temperature (the method for forming solid foams is described in more detail below) or the geometry or thermal conductivity in which the foam is formed. In general, the pore size can be about 0.3 to 110 μm and the porosity can be about 90% to 99.9%. As mentioned above, the foam can be designed to have a particular pore size and porosity by adjusting the freezing temperature. For example, when the freezing temperature is about −20° C. the foam has a pore size of about 0.3 to 4 μm and a porosity of about 98 to 99%, when the freezing temperature is about −80° C. the foam has a pore size is about 50 to 70 μm and a porosity of about 99 to 99.9%, or when the freezing temperature is about −200° C. the foam has a pore size is about 80 to 110 μm and a porosity of about 99 to 99.9%. The freezing temperature and the geometry can also be used to control the orientation of the foam cells, varying from randomly oriented to orient along an axis parallel to the freezing direction.

In an embodiment, the solid foam can be used in a variety of technology areas depending in part upon if the foam is a closed structure or an open structure. For example, foams can be used in tissue engineering, filtration, energy storage, insulation, battery electrodes, and the like.

In an embodiment, the structure can be a porous liquid foam having a closed structure. The liquid foam can be formed by aerating or frothing a suspension of nonaggregated stabilized cationized chitin nanofibers to introduce air bubbles, which are stabilized by adsorption of nonaggregated stabilized cationized chitin nanofibers to the air-water interface. The nonaggregated stabilized cationized chitin nanofibers can be pure or they can be surface modified by physical adsorption of a surfactant or by chemical functionalization with a surface modifier. In an embodiment, the surface modifying surfactant can be selected from carboxylic acids (e.g., such as those described above) that adsorb to the ChNF surface. The surface modifier may be attached to the nonaggregated stabilized cationized chitin nanofiber prior to the nonaggregated stabilized cationized chitin nanofibers suspension in the water, or it may be added directly to the nonaggregated stabilized cationized chitin nanofiber—water suspension prior to aeration. In an embodiment, the porous liquid foam can have a thickness of 1 mm to 1 m, depending on the vessel dimensions and height of the liquid in the vessel in which the foam is generated.

In an embodiment, the liquid foam can be used in a variety of technology areas including paper coatings, food, cosmetics, oil-recovery, flotation, insulation, and materials for transportation and biomedical engineering.

An embodiment of the present disclosure includes methods for making nonaggregated stabilized charged polysaccharide nanofibers, in particular, nonaggregated stabilized cationized chitin nanofibers. In an embodiment, a mixture of aggregated chitin is provided. The aggregated chitin can be obtained from sources such as arthropods (e.g., Crustacea, Chelicerata, and Tracheata), which may include waste products from processing arthropods such as shell fish. Prior to processing using methods of the present disclosure, the aggregated chitin can be processed to remove materials such as proteins, minerals, and the like using acid and/or base processes.

Subsequently, the pH of the mixture including the aggregated chitin is adjusted to a pH of about 1 to 5, about 2 to 4.5, about 3 to 4.5, or about 4 to 4.5 to form a pH adjusted mixture. The pH can be adjusted using acids such as HCl, H₂SO₄, or acetic acid, or a combination thereof Next the pH adjusted mixture is homogenized at a first pressure to form a first homogenized mixture. The first pressure can be about 10,000 to 45,000 psia or about 10,000 to 20,000 psia.

In an embodiment, homogenization is a mechanical separation process that includes passing the pH adjusted mixture through a restriction (e.g., nozzle, orifice, valve, tube, or similar restriction (or a series of such)) at a desired pressure so that the mixture increases velocity in the flow restriction, experiences high shear forces, and impinges upon an end of the tube. In an embodiment, the nozzle, orifice, valve, or tube can have a diameter of about 0.05 to 0.5 mm or about 0.1 to 0.3 mm and a length of about 1 to 10 mm or about 3 to 6 mm. The first homogenization process can be repeated in order to refine the obtained fiber size, for 1 to 30 repetitions (cycles) or 15 to 25 repetitions. Although not intending to be bound by theory, the pressure shear caused by the high pressure spray through the narrow restriction (e.g., nozzle, orifice, valve, tube, or combination thereof), the shear forces within and near the flow restriction, the impingement of the mixture upon the end of the restriction (e.g., tube), the flow of the mixture off the end of the tube back towards the high pressure spray, and collisions between fibers within the flow causes defibrillation of the aggregated chitin. As defibrillation occurs the pH causes nonaggregated chitin fibers to become cationized chitin nanofibers that form a suspension including at least partially nonaggregated stabilized cationized chitin nanofibers. The pH causes protonation of surface —NH₂ groups to NH₃⁺ and the protonated groups produce electrostatic repulsion between individual chitin nanofibers that stabilize the dispersion of chitin nanofibers so the chitin fibers to not reform their previous structure.

The first homogenized mixture can be again homogenized (a second homogenization step) at a different pressure and/or in a tube having different dimensions (e.g., diameter). The use of a second homogenization step can complete the homogenization process, at least under the described conditions (e.g., See Examples). It should be noted that a second homogenization step may not be needed if the conditions (e.g., pressure, tube dimensions, tube including varying dimensions, temperature, combinations thereof, and the like) in the first homogenization produced the desired nonaggregated stabilized cationized chitin nanofibers. The second homogenization is similar to the first homogenization except that the pressure, restriciton (e.g., nozzle, valve, orifice, tube, or combination thereof) dimensions, pH, homogenization time, number of recycle passes, and/or temperature are different. In an embodiment, the pressure, number of recycle passes, and/or the restriction dimensions of the first and second homogenization are different. In an embodiment, the difference in pressure, number of recycle passes, and/or restriction dimensions can facilitate completion of the homogenization process to form the nonaggregated stabilized cationized chitin nanofibers. Once the second homogenization step is complete the mixture of nonaggregated stabilized cationized chitin nanofibers can be stored for further processing.

Additional homogenization steps can be undertaken to produce the desired nonaggregated stabilized charged polysaccharide nanofibers or nonaggregated stabilized cationized chitin nanofibers. In addition, the processing steps and parameters used in them (e.g., pressure, restriction dimensions, pH, homogenization time, concentration, and/or temperature) can be controlled to produce the nonaggregated stabilized charged polysaccharide nanofibers having the desired dimensions or characteristics (e.g., protonation). As a result, the method of making the nonaggregated stabilized charged polysaccharide nanofibers can be controlled to produce the desired product.

In an embodiment the nonaggregated stabilized charged polysaccharides nanofibers, in particular, the nonaggregated stabilized cationized chitin nanofibers can be processed to form a film, a foam, or another structure. In regard to forming a film, a film can be formed by disposing the nonaggregated stabilized cationized chitin nanofiber mixture (or a mixture of nonaggregated stabilized cationized chitin nanofibers with other components) having an appropriate amount of nanofibers in a container and removing (e.g., evaporation) the water to form the film of desired dimensions and characteristics (e.g., gas permeability, optical transparency, and the like). Details regarding the film are described herein.

In regard to the foam, the foam can be made by providing a mixture or suspension of nonaggregated stabilized cationized chitin nanofibers. The mixture is frozen at a temperature of about −20 to −200° C. to form a frozen, which is at a higher temperature than typical freeze drying processes that use liquid nitrogen. Using a higher temperature and varying the temperature is advantageous in that the formation of ice crystals is different than when formed at the temperature of liquid nitrogen. Example 2 provides a detailed discussion regarding ice crystal formation and the resultant formation of open and closed foams based on the selection of the freezing temperature. After the suspension is frozen, the frozen suspension is introduced to a vacuum system and placed under vacuum (e.g., less than 1 torr) to remove the ice crystals, which results in the creation of pores and the formation of the cationized chitin nanofiber foam. The following provides a description of some embodiments of forms formed and the conditions under which they were formed: when the freezing temperature is about 20° C. the foam has a pore size of about 0.3 to 4 μm and a porosity of about 98 to 99%, when the freezing temperature is about −80° C. the foam has a pore size is about 50 to 70 μm and a porosity of about 99 to 99.9%, or when the freezing temperature is about −200° C. the foam has a pore size is about 80 to 110 μm and a porosity of about 99 to 99.9%. Additional details regarding the foam are described herein. Additional details are provided in the Examples.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

Chitin is the second most abundant biopolymer in nature and has tremendous potential in renewable materials for packaging, energy storage, reinforced composites and biomedical engineering. Despite attractive properties including biodegradability, antibacterial activity and high strength, chitin is not utilized widely due to strong molecular interactions, which make solubilization and processing difficult. We report a high pressure homogenization route to produce pure chitin nanofibers (ChNFs) starting with a mildly acidic aqueous dispersion of purified crab α-chitin. The well-dispersed ChNFs with diameter ˜20 nm do not form strong network structures under conditions explored herein and can be directly processed into useful materials, bypassing the need to dissolve the chitin. Dried ChNFs form pure self-standing chitin films with the lowest to-date reported O₂ and CO₂ permeabilities of 0.006 and 0.018 barrer, respectively. Combined with high flexibility and optical transparency, these materials are ideal candidates for sustainable barrier packaging.

Developing renewable materials to reduce the dependence on fossil fuel as a feedstock for a wide range of applications is becoming increasingly important to society.^{1,2} Chitin, poly (β-(1-4)-N-acetyl-D-glucosamine), is the second most abundant biopolymer with 10¹⁰ to 10¹¹ tons produced annually in nature. Chitin is renewable, biodegradable and anti-bacterial and its crystallinity leads to high stiffness, strength and barrier properties, supporting applications in barrier packaging. However, chitin crystallinity creates severe extraction and processing challenges.³⁻⁷ Chitin can be obtained from numerous sources, including the exoskeletons of crustaceans and insects, and some fungi. The shells of crustaceans, for example, mainly consist of proteins, minerals and chitin.⁵⁻⁷ Crab shells have intricate hierarchical structures that are produced by the assembly of chitin and proteins.⁵ For example, at the molecular level chitin polymer chains can form various types of crystalline domains due to the strong hydrogen bonding of chitin. These crystalline domains assemble into chitin nanofibrils of diameter ˜3 nm, and are interconnected by amorphous domains. The nanofibrils form complexes with various proteins that possess chitin binding domains that attach to the outer fibril surfaces. These protein-coated nanofibrils then assemble into larger nanofibers of approximate diameter ˜100 nm, and the chitin nanofibers assemble into microfiber bundles (diameter ˜1 μm range). Then, these microfibers lay parallel to one another into a flat sheet structure, and these sheets then lay onto one another with a characteristic twisting angle between each sheet, resulting in the so-called Bouligand structure. These sheets are layered and twisted to achieve a final exocuticle thickness of ˜1 mm.⁵ This composite material also incorporates mineral filler particle within the walls, mainly composed of calcium carbonate. The focus of this study is on the chitin nanofibers (ChNFs) themselves, which must be removed from the hierarchical shell structure described above. Unfortunately, the ChNFs are very strongly embedded into the wall and microfiber structures, and they are as well wrapped with proteins. Two main approaches have been utilized to process native chitin: 1) regeneration, where the chitin is dissolved and then precipitated or 2) extraction/dispersion, in which chitin micro- or nano-fibers are recovered from native chitin as a dispersion. Regeneration approaches include production of chitin-based nanofibers from dissolved chitin by electrospinning, phase separation, and coagulant-induced gelation of solutions.⁸ These techniques rely on the utilization of strong acids, bases or volatile organic solvents that detract from chitin's sustainability and disrupt its intrinsically high crystallinity. An alternative is extraction of dispersed ChNF building blocks, without dissolving them, which can be controllably assembled into useful materials without requiring solubilization. Chitin nanofibers and whiskers have been extracted by using chemical methods such as strong acid hydrolysis, resulting in fibers with diameters in the range of 10 to 50 nm and lengths of 150 to 2200 nm, depending on acidification conditions (chitin source, pH and time).³² In order to avoid the utilization of strong acids, it is also possible to use mechanical means to extract chitin nanofibers, which is the focus of this paper. For example, ChNFs were extracted from crab shell α-chitin and squid pen β-chitin using mechanical grinding and high-power ultrasonication, respectively,⁹⁻¹¹ which formed a highly viscous gel at concentrations of 1 wt. % at pH of 3-4,⁹⁻¹¹ which supports film formation but also can create processing challenges.¹² The crab chitins processed via grinding from a never-dried¹⁰ and dried state¹¹ both resulted in ChNFs with diameter of 10-20 nm and lengths that were difficult to quantify, but seemed to vary from hundreds to thousands of nm. The squid chitin resulted in ChNFs with diameter of 3-4 nm and lengths of over 1 μm.⁹ Ultrasonication was not able to disintegrate ChNFs from crab α-chitin, possibly due to the higher crystallinity, anti-parallel configuration and greater intermolecular interactions of α-chitin compared with β-chitin.⁹ Homogenization is an alternative process, distinct from grinding and ultrasonication. During homogenization, a suspension of fibers is passed through a small orifice and/or tube at high pressure. The confined geometry creates high shear, and in addition, the resulting jet of fluid can be forced to impinge on a surface. Both impingement and shear forces lead to defibrillation and extraction of fibrils. Prior to this publication, homogenization had not been applied to ChNF extraction.

Currently, there is great demand for bio-derived gas barrier materials for food, beverage and medical packaging and polysaccharides are of interest because of their reduced environment impact relative to conventional plastics.^{8,13-15} Cellulose has been utilized for many decades as a barrier in ‘cellophane’, and recent studies report that micro- or nano-fibrillated cellulose films show promise as barrier films.¹⁴ Films with oxygen barrier properties that meet or exceed those of commercial barrier polymers (poly(ethylene terephthalate) (PET), poly(vinyl chloride), and poly(vinylidene chloride)) have been reported for nanofibrillated cellulose from high-pressure fluidization,¹⁶ TEMPO-oxidized cellulose nanowhiskers,¹⁷ and cellulose coagulated from NaOH/urea/water solution.¹⁸ Few reports of chitin barrier properties have been published, and in contrast to cellulose, self-standing pure chitin films with high barrier properties have not been reported. Regenerated chitin films plasticized with glycerol, produced from NaOH/urea/water solutions, had an impressive O₂ permeability of 0.003 barrer (35° C.).⁸ Composite films of TEMPO-oxidized chitin nanowhiskers coated on PLA are reported to have an O₂ permeability of 0.001 barrer.¹⁹ An important advance would be the ability to produce self-standing, pure chitin films with combined transparency, flexibility, and barrier properties, by using an aqueous fibrillation and casting process that does not require dissolution of chitin. This goal is the focus of the present study.

In the present disclosure, starting from crab α-chitin powder, we report a high-pressure homogenization method that produces water-dispersed ChNFs with narrow diameter distribution and rheological properties suitable for facile processing. Self-standing, pure chitin films prepared from these ChNF dispersions are transparent, mechanically robust and flexible, and have gas barrier properties for O₂ and CO₂ that meet or exceed those of the conventional petroleum-based barrier polymers like PET.

### Experimental Section

### Materials

Dried crab shell flakes were purchased from TCI America. Deionized water (18.2 MΩ cm) was prepared in a Barnstead Easypure RoDi purification system. Hydrochloric acid, sodium hydroxide, acetone and ethanol were purchased from EMD Chemical Inc.

### Methods

Dried crab shell flakes were processed to obtain purified chitin using a method developed from previous literature.^{3,10,12} Ground crab shells were refluxed in 5 wt. % sodium hydroxide in DI water for 6 h. The suspension was filtered and washed with DI water until the pH was 7. Subsequently, the filtered solids were treated with 7% hydrochloric acid for 6 h at room temperature. After filtration and washing with DI water, the treated sample was refluxed in a 5% NaOH solution for 2 days to remove residual proteins and the other residues were eliminated by acetone and ethanol extraction. The purified chitin was dispersed in DI water under acidic condition (aqueous pH ˜4) by magnetic stirring, where HCl was used to adjust medium pH. To generate ChNFs, this mixture was processed through a high-pressure homogenizer by using a 0.20 mm nozzle (Bee International Inc., MA) operating at a pressure of 15,000 psi and room temperature for 20 passes, followed by homogenization with a 0.13 mm nozzle operating at a pressure of 22,000 psi and room temperature for 10 passes. The resulting ChNF/water dispersion was cast into a Petri dish, followed by drying at room temperature for 6 days to produce solid ChNF films.

The degree of acetylation (DA) of the purified chitin was characterized using ¹³C cross-polarization under magic-angle spinning (CP-MAS) NMR, which was performed on a Bruker 400 spectrometer with a spinning rate of 5 kHz, contact times of 1 ms and pulse intervals of 5 s.²⁰ The DA of chitin was determined using the ratio of the integral of methyl carbon atom of the N-acetyl group to the summation integrals of the six carbon atoms of the D-glucopyranosyl ring (C₁-C₆ atoms: δ 50 to 105 ppm)²¹

$$DA = 100 ( {I}_{N - {CH}_{3}} ) / ( \frac{1}{6} \sum {I}_{main chain carbons} ) \qquad ( 1 )$$

The light transmittances (wavelengths: 400 to 800 nm) of chitin dispersions and ChNF solid films were measured using a UV-Vis spectrometer (JASCO-V630). A cuvette filled with DI water was used as a reference for chitin dispersion measurement. The morphologies of chitin-based materials were obtained using field emission scanning electron microscopy (Zeiss Ultra 60). Before imaging, these samples were coated with a thin layer of gold/palladium (Hummer IV Sputtering System) to promote conductivity. The surface features of ChNF film were characterized using atomic force microscopy (AFM, Veeco Dimension 3100). The flat film was firstly attached onto a smooth silicon wafer, and then the images were collected under tapping mode. The cantilever had a nominal spring constant of 37 N/m and a nominal frequency of 300 kHz (Applied NanoStructures, Inc., Santa Clara, Calif.). The surface charge of ChNFs at pH 4.1 in water was measured by a Malvern Zetasizer Nano ZS 90.

Dynamic rheology of ChNF dispersions (0.5 wt. % of chitin) was carried out by a MCR 300 rheometer (Anton Paar, Graz, Austria) using a plate and plate geometry at 23° C. Before the dynamic viscoelastic measurements, the linear viscoelastic region was accessed by a strain sweep experiment in the range of 0.01 to 10% at a frequency of 1 Hz. The frequency sweep was conducted from 0.1 to 10 rad/s with a controlled stain of 0.005, which was within the linear viscoelastic region. Shear viscosity was measured by increasing the shear rate from 0.1 to 1001/s at 23° C. The attenuated total reflectance-Fourier transform infrared spectra (ATR-FTIR) of chitin powders and ChNF films were recorded using Bruker platinum ATR connected to a Bruker Vertex 80 FTIR (Bruker Optics, Inc., Billerica, Mass.).

Water content in prepared ChNF films was assessed with thermogravimetric analysis (TGA, TA Instruments TGA Q50). Approximately 5-10 mg of sample was loaded into the ceramic pan. The sample was heated from room temperature to 120° C. at a rate of 10° C./min under a flowing nitrogen atmosphere (N₂ purity>99.999%, gas flow rate: 50 ml/min), and then held at 120° C. for 30 min. The amount of water absorbed was calculated by the mass loss during these two steps. Density of the ChNF films was determined at 23° C. using a density gradient column containing calcium nitrate-water solution (Techne™, Burlington, N.J.). To limit the effect of water uptake on sample density, the density measurements were recorded 20 minutes after introducing the samples into the column. The porosities of ChNF films were determined using Equation 2. The density of chitin is taken to be 1425 kg/m³.²¹

$$Porosity = 1 - \frac{{ρ}_{ChNF Film}}{{ρ}_{Chitin}} \qquad ( 2 )$$

The ultimate tensile strength, Young's modulus and ultimate strain at break of ChNF films were measured using a RSA III Dynamic Mechanical Analyzer (TA Instruments) at room temperature. At least 3 specimens with dimensions of 50 mm in length, 3 mm in width and 30 μm in thickness were cut from the films and were tested at a strain rate of 0.6 mm/min with a gap distance of 10 mm. Uniaxial tensile testing was also performed using a Universal Testing Machine (MTS Systems, Insight 2) equipped with a 100 N load cell, by using samples cut into strips measuring approximately 35 mm in length and 3 mm in width. The test section measured 13 mm and the strain rate was 1.3 mm/min. The strain rate and sample width were chosen based on ASTM D882-10. All samples were 0.03 mm thick. The grips were lined with crocus cloth in order to mitigate slipping.

Gas permeabilities of ChNF films were measured using a constant volume permeation system at room temperature and 0% relative humidity. The detailed experimental setup has been described previously.²² Briefly, a ChNF film was firstly sandwiched between two concentric pieces of impermeable aluminum tape and then was assembled into a permeation cell. The cell was subsequently loaded in the permeation system. The entire permeation system was degassed for over 24 hours. After a leak test, the upstream was pressurized with feed gas (O₂, N₂, H₂, CO₂ or CH₄), while the downstream was kept at vacuum. The pressure change in a constant downstream volume was recorded over time and the permeability of ChNF film was calculated based on equation 3,

$$P = \frac{( 2.94 {10}^{4} ) ( V ) ( l ) ( d p / d t )}{( T ) ( A ) ( Δ p )} \qquad ( 3 )$$

where V is the downstream volume, L is the thickness of measured film, dp/dt is the steady state rate of pressure rise, T is the absolute temperature, A is the measured film area, and Δp is the pressure difference between the upstream and downstream.²²

### Results and Discussion

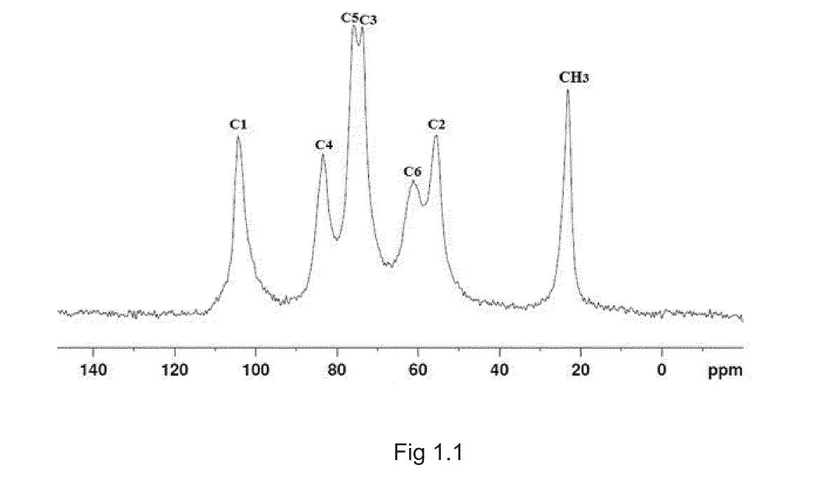

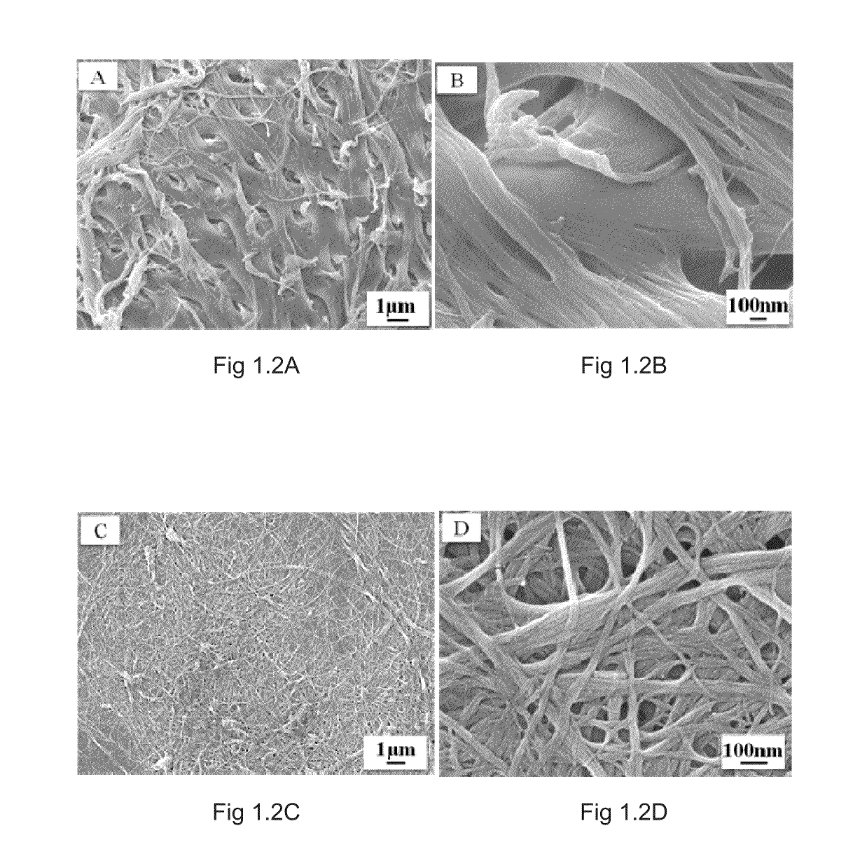

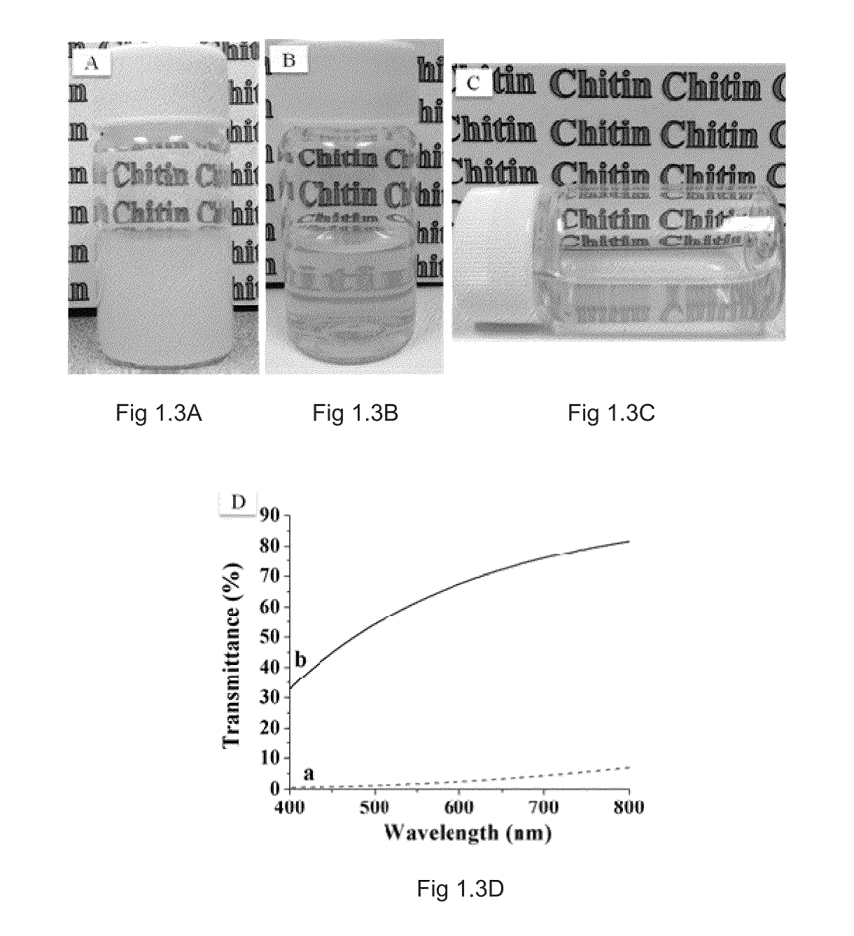

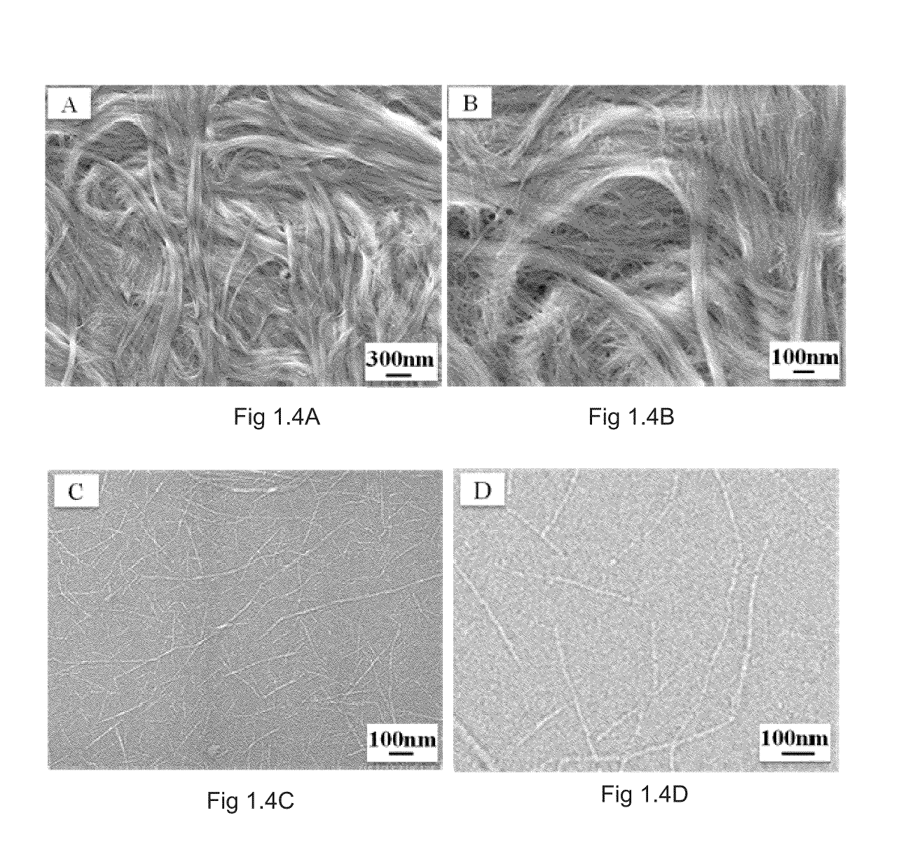

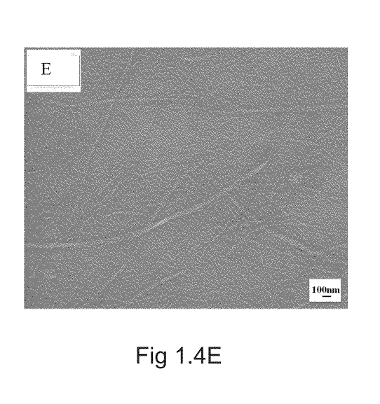

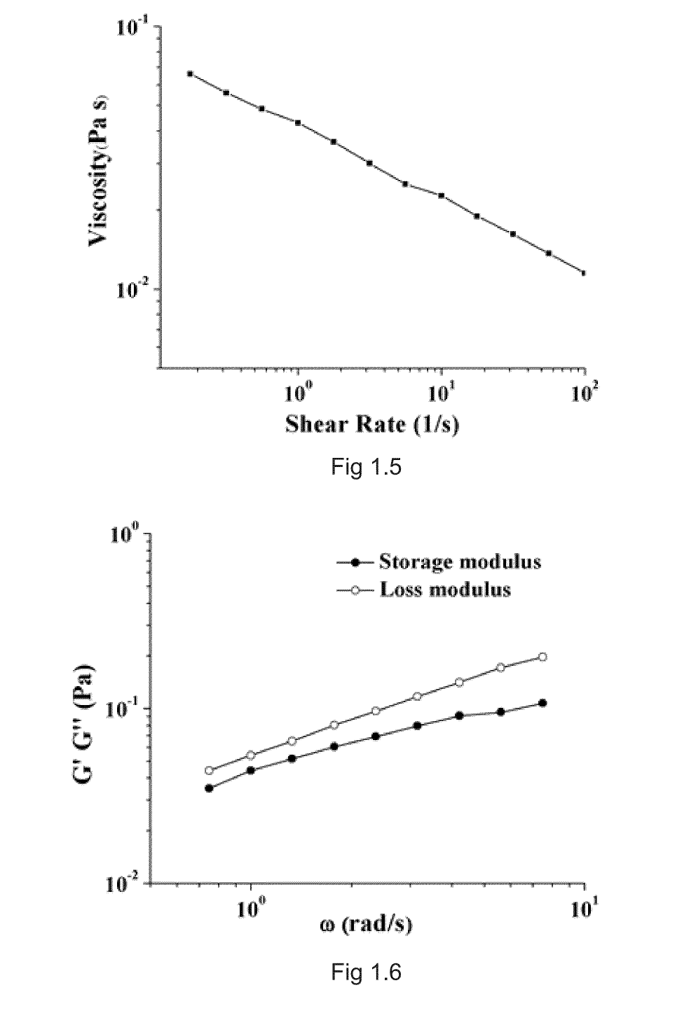

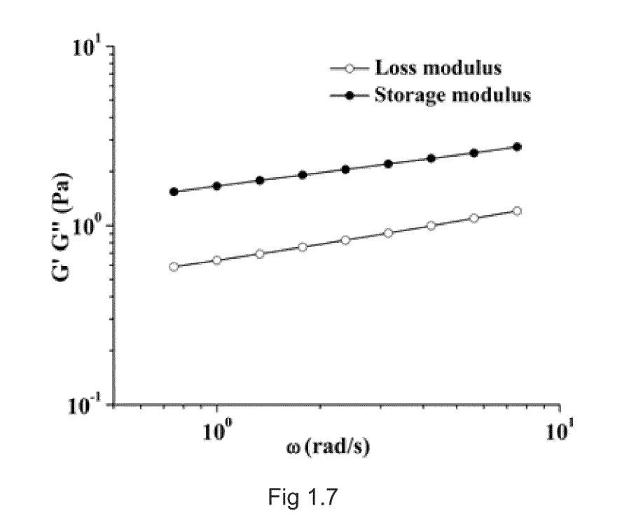

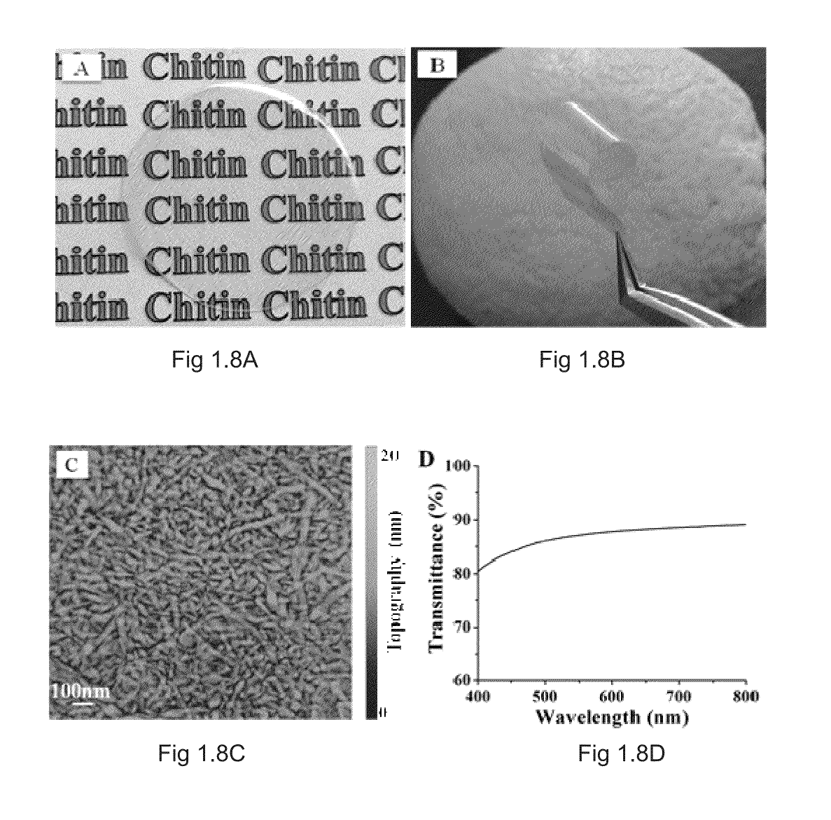

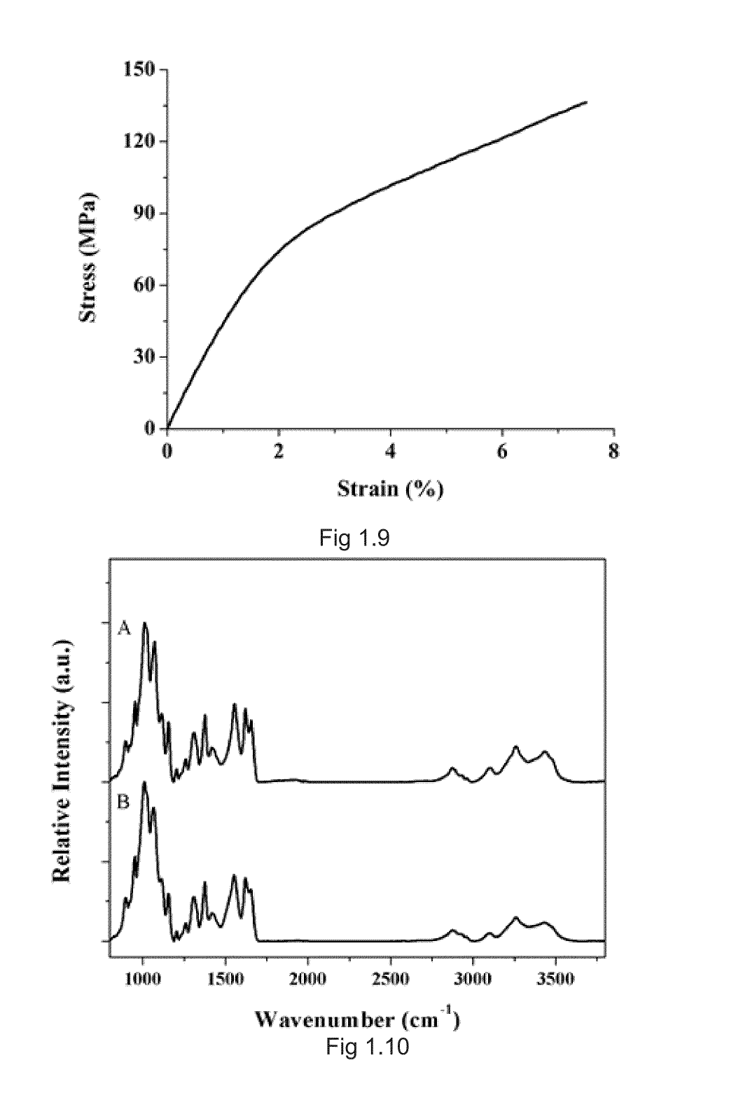

Crab shells mainly consist of proteins, minerals and chitin.⁵⁻⁷ To obtain the purified chitin starting material, a series of chemical treatments were performed on crab shells, including acid treatment to remove minerals and base treatment to deplete proteins. The degree of acetylation (DA) is an important parameter of chitin and has been used to differentiate chitin from chitosan. While all natural chitin contains some substitution with chitosan along the chain, the polymer is called chitin when DA is greater than 50%.^{6, 7} Here, a non-destructive method, ¹³C CP-MAS solid state NMR, was used to determine the DA of the purified chitin from crab shells. The positions of C₁, C₂, C₃, C₄, C₅, C₆ and N—CH₃ in ¹³C NMR spectra are 104.36, 55.54, 73.81, 83.51, 75.91, 61.20, and 23.17 ppm, as illustrated in FIG. 1. According to equation 1, the DA of purified chitin is 92.4%.

Crab shells have intricate hierarchical structures that are mainly produced by the assembly of chitin and proteins, and ChNFs are its key elements.⁵ The purified chitin was obtained as micron-sized particles, and it consisted of fibers with diameters ranging from a few tens of nanometers to hundreds of nanometers (FIGS. 1.2A and 1.2BB). When the purified chitin/water dispersion with a neutral pH of 7 was treated by a high pressure homogenization process that includes 20 passes with a 0.20 mm nozzle at 15,000 psi and 15 passes with a 0.13 mm nozzle at 22,000 psi, the resulting chitin dispersion is turbid and the diameters of chitin fibers were decreased in comparison to the purified chitin, but those fibers were still largely connected, as shown in FIGS. 1.2C and 1.2D. The fibrillation of large fibers resulted from mechanical shearing during homogenization.

The obtained purified chitin was dispersed in acidic water resulting in cationization due to the protonation of —NH₂(0.5 wt % of chitin). The cationized chitin dispersion was hazy and had a transmittance of 7% at 800 nm (FIGS. 1.3A and 1.3D). In contrast, the 0.5 wt % of homogenized chitin dispersion with a pH of 4.1, which was produced by a high pressure homogenization of the cationized chitin, exhibits high transparency and has a transmittance of 81% at 800 nm, as illustrated in FIGS. 1.3B and 1.3D. Meanwhile, it flowed easily under gravity (FIG. 1.3C) and the homogenized chitin has a zeta potential of +57.5 mV in water at pH 4.1.

After acid treatment, cationized chitin was still present as micron-sized particles, but the fraction of nanofibers with diameters of less than 50 nm increased (FIGS. 1.4A and 1.4B), which resulted from the fibrillation of fibers with larger diameters. The disintegration of large fibers occurred as a result of mechanical shearing during magnetic stirring aided by electrostatic repulsion between fibers due to protonated —NH₃⁺on the chitin surface. As shown in FIGS. 1.4C and 1.4D, well-dispersed ChNFs were created after high pressure homogenization of the cationized chitin dispersion. These nanofibers have an average diameter (d_{avg}) of 20 nm, mainly ranging from 5 to 50 nm and lengths that vary between hundreds of nanometers to several micrometers. Chitin has very strong intra- and inter-hydrogen bonding,^{6,7} which not only leads to its insolubility in common solvents, but also hinders the defibrillation of large chitin fibers. Previously, Fan et al. prepared individualized ChNFs from squid pen chitin (largely consisting of β-chitin) using a high-power ultrasonication technique, but ChNFs could not be produced from crab α-chitin by this method despite cationization of the chitin under acid conditions (pH 4). It was argued that non-fibrillation of α-chitin may result from its higher crystallinity index, anti-parallel configuration and greater intermolecular forces in comparison to β-chitin.⁹ The formation of dispersed ChNFs by the high pressure homogenization of crab α-chitin indicates that the strong molecular interactions between chitin can be effectively broken with the combination of the high mechanical shearing induced by the homogenizer and electrostatic repulsion between chitin nanofibers (zeta potential: +57.5 mV at pH 4.1). As shown before, cationized chitin dispersions showed poor transparency while dispersions of homogenized chitin with acidic treatment were transparent. We argue that the different appearances are related to the size of particles in dispersion, since the large chitin particles in the cationized, non-homogenized dispersion would lead to strong light scattering. It is noteworthy to mention that ChNF dispersions in FIGS. 1.3B and 1.3C flow easily under gravity, and show high transparency and excellent stability without apparent aggregation over one year. This stability indicates that although the percentage of amino groups in chitin was very low (DA: 92.4%), the positively charged —NH₃⁺ on ChNFs at pH 4.1 were still quite effective in preventing ChNF aggregation.

The shear viscosities of 0.5 wt % ChNF dispersions were studied as a function of shear rate. As shown in FIG. 1.5, the dispersion in water of pH 4.1 shows shear thinning behavior with increasing shear rate. In addition to ChNF dispersion, the shear thinning of dispersions of chitin nanocrystals and cellulose nanocrystals, microfibers and nanofibers have also been reported previously.^{19, 23-27} It is understood to be a consequence of breakup of any fiber entanglements as well as fiber orientation in the flow field at higher shear rates. The shear viscosity of ChNFs at 1 rad/s is 0.04 Pa·s, which is close to the reported value of ˜0.01 Pa·s for rodlike cellulose nanowhiskers with similar dimensions at the same concentration of 0.5 wt %.^{19, 23-27} In contrast, highly-entangled dispersions of long cellulose nanofibers at the same concentration (0.5 wt %) were reported to have a much large viscosity of ˜1 Pa·s at the same shear rate.^{19, 23}-27

Dynamic rheology results in FIG. 1.6 show that G′<G″ over the entire range investigated for the ChNF dispersion, indicating that viscous dissipation dominates mechanical response. In addition to viscosities in FIG. 1.5, this data suggests that the ChNFs did not form strong network structures in water at 0.5 wt %. For example, in the literature for cellulose nanofiber and microfiber dispersions, short, highly-charged fibers that do not form strong entanglements generally show G′<G″ at sufficiently low concentration.^{19, 23-27} The difference between G″ and G′ can be taken as a qualitative indicator of the relative contributions of the viscous and elastic responses. For the ChNF dispersions, G′=0.044 Pa and G″=0.054 Pa for loss modulus at 1 rad/s. Because G′ and G″ are of the same order of magnitude and do not differ greatly, there may be weak interactions or entanglements among ChNFs. These values are in a similar range as those reported for negatively-charged CNC dispersions with similar dimensions, 10⁻²-10⁻¹ Pa.^{19, 23-27} However, the reported concentration of CNC dispersions where G″>G′ is lower than 0.5 wt %. In contrast, many reports of CNC dispersions often show G″<G′ even at low concentrations <0.5 wt %, which is nearly always attributed to entanglement and network formation.^{19, 23}-27

In order to explore the rheological effects of entanglement with longer chitin fibrils, we also prepared partially defibrillated ChNFs by using only 4 passes through the 0.20 mm nozzle at 15,000 psi in the homogenizer. The fibrils in this case are not nearly as well-separated and are larger and longer than the ChNFs discussed above. As shown in FIG. 1.7, the resulting 4-pass chitin/water dispersion has G′>G″ and higher storage and loss moduli than the ChNF dispersion produced by 35 passes, indicating the formation of relatively strong networks. For example, G′=1.7 Pa and G″=0.6 Pa at 1 rad/s (FIG. 1.7). According to FIGS. 1.6 and 1.7, it is apparent that the strong network structures were broken and chitin fibers were shortened with increasing homogenization duration.

When allowed to dry at room temperature, the ChNF dispersion formed an optically transparent and flexible film that is composed of relatively densely packed nanofibers (FIGS. 1.8A-C). The mean (Ra) and root-mean-square (rms) surface roughness of the ChNF film were 3.0±0.7 nm and 2.3±0.5 nm, respectively. The film has transmittances of 89% at 800 nm and 80% at 400 nm (FIG. 1.8D) and the high transparency is attributed to low light scattering and adsorption of nanosized ChNFs. The water content of ChNF films was measured by TGA and it was 7.0±0.7%. The film had a density of 1382 kg/m³ and a porosity of 3% that was calculated according to equation 2. FIG. 1.9 shows that the ChNF film had an ultimate tensile strength of 137 MPa, a Young's modulus of 4.37 GPa, and an elongation at break of 7.4%, which is consistent with previous reports.^{19, 23-27}

FIG. 1.10 shows the normalized ATR-FTIR spectra of the purified chitin powders and ChNF film dried from ChNF dispersion at room temperature. The characteristic peaks of chitin such as amide band I at 1654 and 1620 cm⁻¹, amide band II at 1554 cm⁻¹, OH stretching band at 3478 cm⁻¹ and NH stretching at 3260 and 3098 cm⁻¹ are observed from both of these spectra.^{4, 6, 7} In addition, these two spectra do not show any differences in the number of peaks. This indicated that chemical structures of chitin were well maintained after the high pressure homogenization.

TABLE 1
Gas permeabilities in ChNF films at 0% relative humidity.

| | Kinetic diameter (Å) | Permeability |
|---|---|---|
| Gas | [32] | (barrer) |
| H₂ | 2.89 | 0.024 |
| CO₂ | 3.30 | 0.018 |
| O₂ | 3.46 | 0.006 |
| N₂ | 3.64 | 0.0034 |
| CH₄ | 3.80 | 0.0027 |

All the gas permeabilities of ChNF films were in the range from 0.002 to 0.03 barrer, as shown in Table 1. Owing to its small kinetic diameter, H₂ had the highest gas permeability value in comparison to other gases (CO₂, O₂, N₂ and CH₄).²⁸ Poly(ethylene terephthalate) (PET), poly(ethylene) (PE) and poly(propylene) (PP) are widely used for packaging applications where O₂ and CO₂ barrier properties are key criteria. PET, PE and PP have O₂ permeabilities of 0.015-0.076, 0.75-4.73 and 0.75-1.52 barrer, respectively and CO₂ permeabilities of 0.3, 11.7-14.6 and 4 barrer, respectively.^{8, 13, 29-31} We note that there is variation in gas barrier properties of polymers based on processing and crystallinity, as well as the humidity under which permeability is measured. While we report gas permeabilities under dry conditions here, the behavior of chitin films under humid conditions is the subject of ongoing work. The values provided for comparison to PET, PE and PP are typical for commercial films under dry conditions. Compared with these synthetic polymer films, the dry O₂ and CO₂ permeabilities of the self-standing pure ChNF films produced here are much lower, only 0.006 and 0.0018 barrer, respectively. This is attributed to the highly crystalline structure of ChNFs, which result in low free volume and low gas permeability.^{8, 13-15}

To put our results in context, we discuss several recent reports of high barrier property membranes based on cellulose or chitin. Barrier properties that meet or exceed those of commercial barrier polymers such as PET, PVC, and PE were reported for films composed of nanofibrillated cellulose obtained by high-pressure fluidization (flow through a narrow “z-shaped” chamber).¹⁶ When concentrated by filtration, a wet gel film was produced which was wet pressed at room temperature and then hot pressed at 100° C. to produce a dense film with an O₂ permeability of 0.00091 barrer (at 23° C.).¹⁶ A remarkably low O₂ permeability for a self-standing cellulose membrane was produced by regeneration of cellulose fully dissolved in an NaOH/urea/water solution via a freeze/thawing process.¹⁸ Following addition of acetone coagulant and drying, the resulting film had an O₂ permeability of 4.6×10⁻⁶ barrer (23° C.), which is lower than the best performing barrier materials commonly used in food packaging, such as poly(vinylidene chloride). When the same freeze/thaw dissolution process was applied to chitin, the chitin was fully dissolved but produced gel films formed after addition of coagulant that were too brittle to survive gas permeation testing. Only after plasticizing with glycerol was a film with O₂ permeability of 0.003 barrer (35° C.) produced.⁸ Self-standing films of cellulose nanowhiskers produced by TEMPO oxidation were reported to have O₂ permeability of 7.5×10⁻⁵ barrer.¹⁷ The chemical TEMPO process was also used to produce chitin nanowhiskers that were dried on PLA films.¹⁹ The composite PLA/chitin films had an impressive O₂ permeability of 0.001 barrer, lower than PLA itself (0.28 barrer). In the studies referenced here, an inverse correlation between film density and permeability is evident, illustrating the primary importance of preserving fiber crystallinity and alignment or packing nanofibers during the gelation or drying steps. In the spectra in FIG. 1.8D, the drop-off in transmission at low wavelengths may indicate scattering by small pore defects. Surface topography in the AFM image in FIG. 1.8C may also indicate small surface pores. Density measurements presented above suggest that porosity is near 3%. The good barrier properties indicate that any pores were not highly interconnected. However, this observation suggests that there may be room for improvement in the barrier properties by applying densification strategies to the films to eliminate isolated pores.

### Conclusions

In summary, ChNFs were successfully extracted from crab α-chitin by a high pressure homogenization process under acidic conditions. Neither high pressure homogenization nor cationization of chitin alone could disintegrate large chitin fibers effectively. Rather, only homogenization of cationized chitin was effective in producing ChNFs. The well-fibrillated ChNF had an average diameter of 20 nm and a zeta potential of +57.5 mV at pH 4.1, which arises from protonated —NH₃⁺ groups that stabilize the dispersion via electrostatic repulsion. The homogenized ChNFs are well dispersed in water without forming strong network structures at room temperature, and the obtained ChNF dispersion has low viscosity and storage modulus. Self-standing, pure chitin films obtained by simply drying the ChNF dispersions exhibited high optical transparency and tensile strength, flexibility, and excellent gas barrier properties. To our knowledge, these are the first reported self-standing, pure chitin films with O₂ and CO₂ barrier properties that exceed PET, an important benchmark for commercial barrier applications. Sustainably-sourced nanofibrous materials are potentially useful for applications including food, beverage, electronics and medicine packaging.

### REFERENCES

(1) Serrano-Ruiz, J. C.; Luque, R.; Sepúlveda-Escribano, A. Chem. Soc. Rev. 2011, 40, 5266-5281
(2) Irimia-Vladu, M. Chem. Soc. Rev. 2014, 43, 588-610
(3) Nair, K. G.; Dufresne, A. Biomacromolecules 2003, 4, 657-665
(4) Pillai, C. K. S.; Paul, W.; Sharma, C. P. Prog. Polym. Sci. 2009, 34, 641-678
(5) Raabe, D.; Sachs, C.; Romano, P. Acta Mater. 2005, 53, 4281-4292
(6) Rinaudo, M. Prog. Polym. Sci. 2006, 31, 603-632
(7) Rinaudo, M. Polym. Int. 2008, 57, 397-430
(8) Duan, B.; Chang, C.; Ding, B.; Cai, J.; Xu, M.; Feng, S.; Ren, J.; Shi, X.; Dud, Y.; Zhang, L. Journal of Materials Chemistry A 2013, 1, 1867-1874
(9) Fan, Y.; Saito, T.; Isogai, A. Biomacromolecules 2008, 9, 1919-1923
(10) Ifuku, S.; Nogi, M.; Abe, K.; Yoshioka, M.; Morimoto, M.; Saimoto, H.; Yano, H. Biomacromolecules 2009, 10, 1584-1588
(11) Ifuku, S.; Nogi, M.; Yoshioka, M.; Morimoto, M.; Yano, H.; Saimoto, H. Carbohydr. Polym. 2010, 81, 134-139
(12) Wu, J.; Meredith, J. C. ACS Macro Lett. 2014, 3, 185-190
(13) Lange, J.; Wyser, Y. Packag. Technol. Sci. 2003, 16, 149-158
(14) Lavoine, N.; Desloges, I.; Dufresne, A.; Bras, J. Carbohydrate Polymers 2012, 90, 735-764
(15) Miller, K. S.; Krochta, J. M. Trends Food Sci. Technol. 1997, 8, 228-237
(16) Österberg, M.; Vartiainen, J.; Lucenius, J.; Hippi, U.; Seppälä, J.; Serimaa, R.; Lai, J. ACS Applied Materials & Interfaces 2013, 5, 4640-4647
(17) Fujisawa, S.; Okita, Y.; Fukuzumi, H.; Saito, T.; Isogai, A. Carbohydrate Polymers 2011, 84, 579-583
(18) Yang, Q.; Fukuzumi, H.; Saito, T.; Isogai, A.; Zhang, L. Biomacromolecules 2011, 12, 2766-2771
(19) Fan, Y.; Fukuzumi, H.; Saito, T.; Isogai, A. International Journal of Biological Macromolecules 2012, 50, 69-76
(20) Duarte, M. L.; Ferreira, M. C.; Marvão, M. R.; Rocha, J. Int. J of Biol. Macromol. 2001, 28, 359-363
(21) Kasaai, M. R. Carbohydr. Polym. 2010, 79, 801-810
(22) Rungta, M. Carbon Molecular Sieve Dense Film Membranes for Ethylene/Ethane Separations. Ph.D. Dissertation, Georgia Institute of Technology, Atlanta, Ga., November, 2012.
(23) Li, J.; Revol, J. F.; Marchessault, R. H. J. Colloid Interface Sci. 1996, 183, 365-373
(24) Lima, M. M. S.; Borsali, R. Macromol. Rapid Commun. 2004, 25, 771-787
(25) Orts, W. J.; Godbout, L.; Marchessault, R. H.; Revol, J. F. Macromolecules 1998, 31, 5717-5725
(26) Pääkkö, M.; Ankerfors, M.; Kosonen, H.; Nykanen, A.; Ahola, S.; Österberg, M.; Ruokolainen, J.; Laine, J.; Larsson, P. T.; Ikkala, O.; Lindström, T. Biomacromolecules 2007, 8, 1934-1941
(27) Tzoumaki, M. V.; Moschakis, T.; Biliaderis, C. G. Biomacromolecules 2010, 11, 175-181
(28) Low, B. T.; Chung, T. S.; Chen, H.; Jean, Y.; Pramoda, K. P. Macromolecules 2009, 42, 7042-7054
(29) Gholizadeh, M.; Razavi, J.; Mousavi, S. A. Mater. Des. 2007, 28, 2528-2532
(30) Jams, D.; Hiltner, A.; Baer, E. Polymer 2002, 43, 2401-2408
(31) Tsai, T.; Li, C.; Chang, C.; Cheng, W.; Hwang, C.; Wu, R. Adv. Mater. 2005, 17, 1769-1773
(32) Zeng, J.-B.; He, Y.-S.; Li, S.-L.; Wang, Y.-Z.; Biomacromolecules 2012, 13,

### Example 2

The intricate hierarchical architectures in natural creatures are usually derived from assembly of molecular building blocks into nanoscale structures that then organize into micro- and macroscopic sizes. An example is the complex structure in arthropods (crustaceans, insects) constructed primarily of chitin. Because of chitin's inherent insolubility in common solvents, processes for mimicking the fascinating natural chitin-based nanostructures are still at an early stage of development. Here, we present a facile freeze drying approach to assemble chitin nanofibers (20 nm diameter) into a variety of structures whose size and morphology are tunable by adjusting freezing temperature and heat transfer characteristics. We show that reducing freezing rate allows controllable formation of structures ranging from oriented sheets to three-dimensional aperiodic nanofiber networks that mimic the size and interconnectivity of the white Cyphochilus beetle cuticle. The formation of nanofibrous structures is not predicted by the widely-used particle encapsulation model of freeze-drying. We reason that this structure occurs due to a combination of attractive interactions of the nanofibers and a slow freezing rate that encapsulates and preserves the network structure. The method outlined here is likely applicable to creating fine nanofibrous structures with other polymers and materials classes with size ranges useful in diverse applications such as tissue engineering, filtration and energy storage.

Chitin is a renewable and biodegradable polymer that assembles into crystalline nanofibers that are utilized by animals (arthropods) and fungi through organization into many sophisticated hierarchical structures. Being the second-most abundant naturally-produced biopolymer (second to cellulose), 10¹⁰ to 10¹¹ tons of chitin is produced each year in nature. However, chitin biomimicry remains a significant and unsolved challenge.¹⁻³ Chitin-based structures include the high-stiffness twisted plywood structure of lobster shells.⁴ Another example is the Cyphochilus ‘white’ beetle, which has unique whiteness arising from the chitin-rich three-dimensional aperiodic network structure within its cuticle.⁵ This kind of porous nanofibrous structure is significant to a wide range of practical applications, including white paints and coatings, tissue engineering, catalysis, sensors, filtration, absorbents, actuators, structural materials and energy storage (supercapacitors and batteries).⁶⁻¹⁵ Constructed primarily of chitin and some protein, the white beetle cuticle is a model for mimicry to produce such porous nanofibrous materials from a renewable resource.

However, owing to its insolubility in common solvents and strong molecular interactions, chitin is challenging to process into controlled nanostructures.¹⁻³ Previously, man-made processes have not been reported to use chitin directly to reproduce the intricate cuticle structure. While self-assembly and electrospinning are potential candidates, they have not been demonstrated on chitin nanofibers directly, but rather they often require structure-directing additives (self-assembly) or depolymerization and use toxic or volatile organic solvents (electrospinning) These alterations detract from the sustainable nature of chitin.¹⁶⁻¹⁸ Often, chitin is deacetylated to form chitosan, which is soluble in dilute acidic solutions. The processing of chitosan into nanostructured materials has been the subject of numerous investigations.^{1, 2, 19, 20} In contrast, we seek a method to assemble extracted chitin directly into nanofibrous structures with controlled size and interconnectivity, without any other additives or pretreatments that alter the polymer structure.

Freeze drying has attracted intense interest as a general route to fabricate porous materials for a wide range of applications. Starting with a solution, emulsion, or dispersion, freezing causes solute or solids to be excluded by an advancing ice front into the interstitial spaces between ice crystals. Subsequent sublimation leads to porous structures. By controlling concentration and freezing direction, complex hierarchical morphologies are produced, including well-aligned channels, honeycombs, and brick-mortar-bridges.²¹⁻²⁷ Most studies focus on directional freezing under liquid nitrogen, but non-directional, aperiodic nanofibrous structures similar to that of the white beetle have not been achieved by freeze drying. In this letter, we demonstrate that adjusting variables expected to control freezing rate (freezing temperature or heat transfer characteristics), allows tuning the dimensions and connectivity of the chitin structures formed from an aqueous chitin nanofiber (CNF) dispersion. Depending on freezing conditions this method allows a broad variety of structures to be formed from chitin, from nanofibrous networks that mimic the white beetle to micrometer-scale oriented and random sheets. The general principle of reducing ice growth rate to achieve finer control of porous network structures, applied here to chitin, is likely applicable to other polymer and materials classes to produce structures of relevance to many practical applications, as noted above.⁶⁻¹⁵

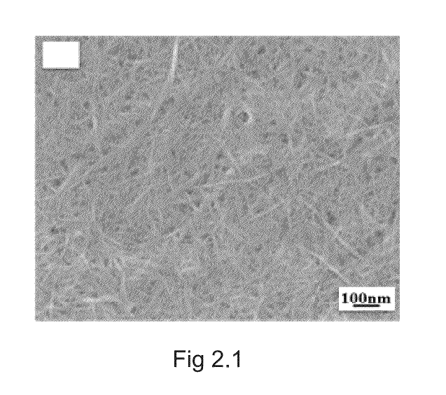

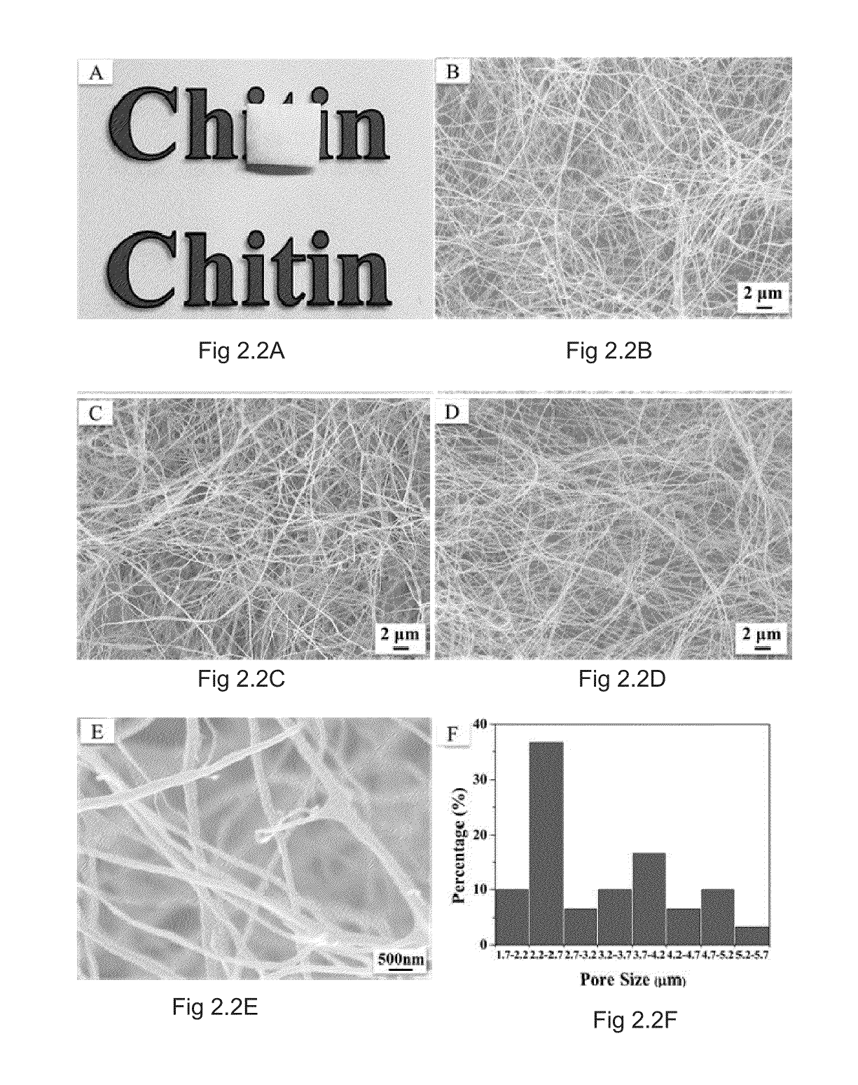

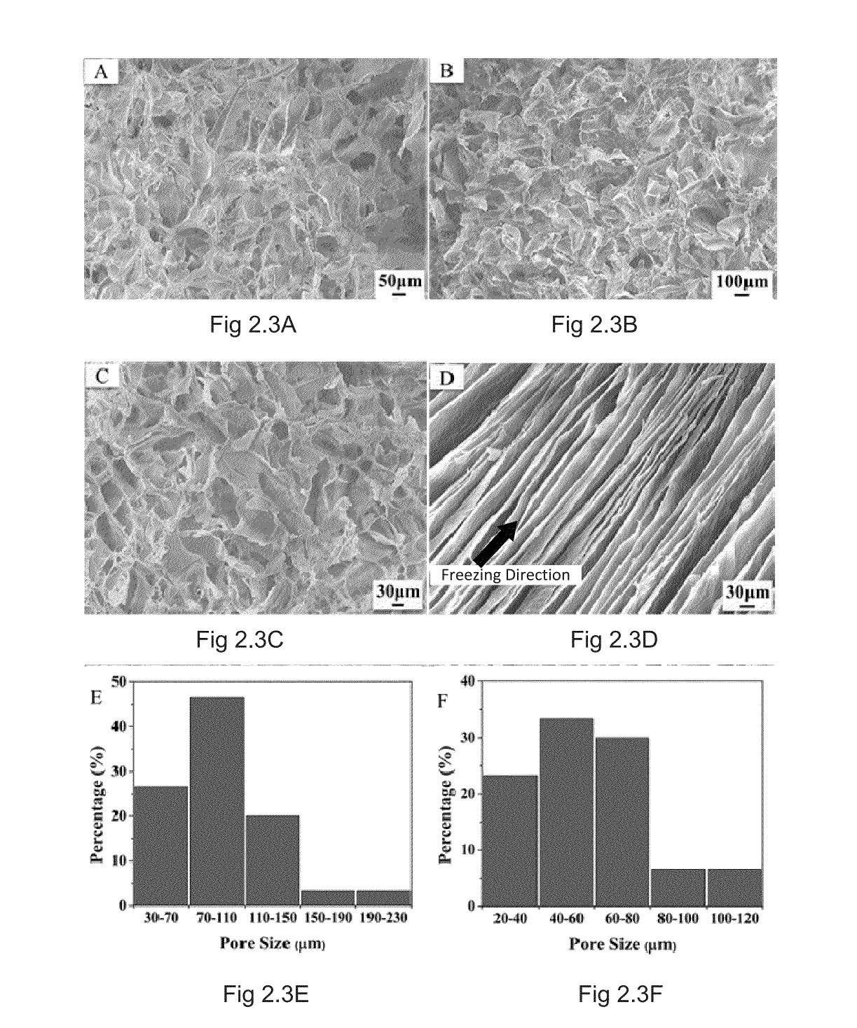

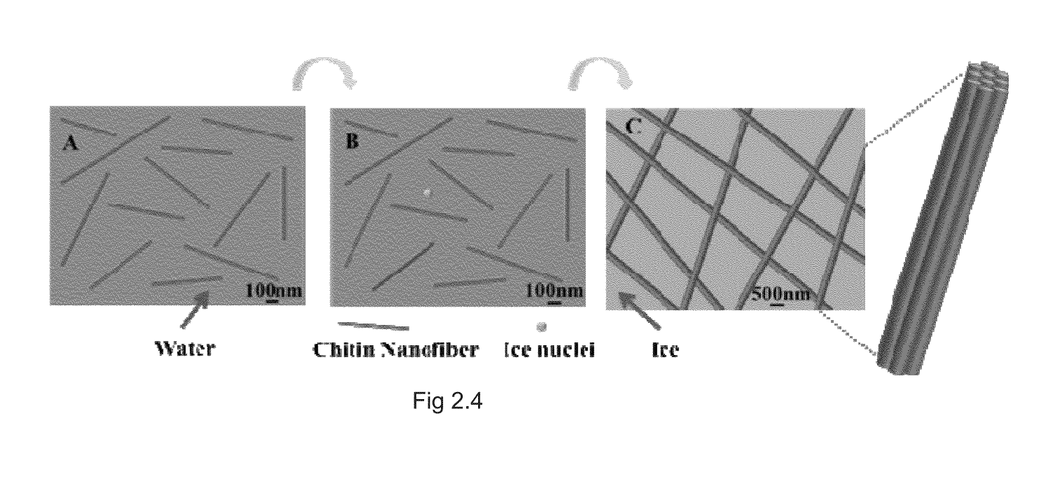

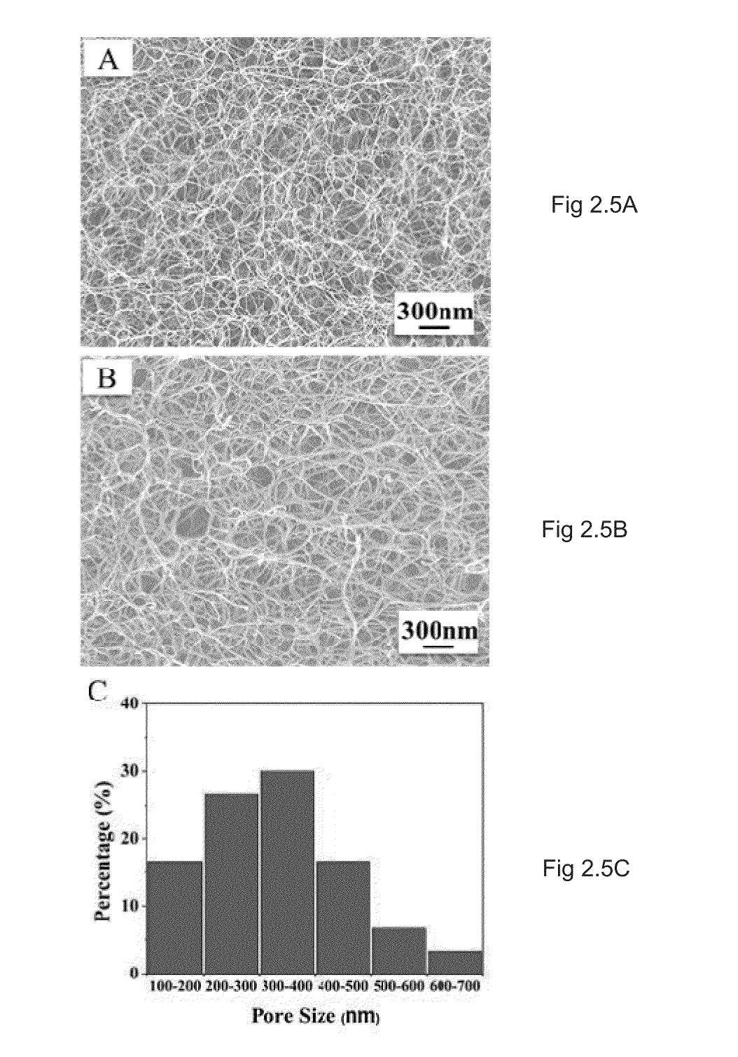

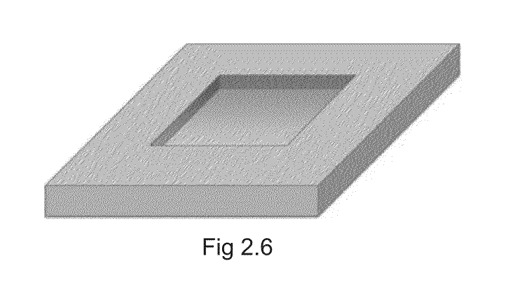

CNFs were fabricated via fibrillation of purified chitin by high shear homogenization, as described in the experimental section of the supporting materials. After homogenization, the CNF dispersion exhibits high optical transparency and CNF has a zeta potential of +57.5 my at pH 4.1, which originates from protonated —NH₃⁺ groups and stabilizes the dispersion via electrostatic repulsion. FIGS. 1.4D and 1.4C illustrates that single CNFs are present in water with an average diameter (d_{avg}) of 20 nm distributed over a range of 5 to 50 nm and lengths that vary between ˜100 nm to several micrometers. When allowed to dry at room temperature, the CNF dispersion forms an optically transparent film that is composed of relatively densely packed nanofibers (FIGS. 2.1 and 1.8A). Dense structures like these are typically formed when fibrous materials are dried from water under ambient conditions, due to compaction and adhesion of fibers that occurs as solids concentration increases, and additionally due to pore shrinkage in late stages of drying due to the high surface tension of water.

TABLE 1
Pore size and porosity of freeze-dried chitin

| Temperature | | Pore Size | Porosity | |
|---|---|---|---|---|
| (° C.) | Mold | (μm) | (%) | Morphology |
| −20 | Aluminum | 3.2 ± 0.4 | 98.5 | open fibers |
| −80 | Aluminum | 96 ± 12 | 99.5 | open cells |
| −196 | Aluminum | 59 ± 7.6 | 99.5 | closed cells |
| | | | | open oriented walls |
| −20 | Stainless | 0.33 ± 0.05 | 99.6 | open interconnected |
| | Steel | | | fibers |

All freeze-dried structures were produced at −20° C., −80° C. and −196° C. (liquid N₂), using a CNF aqueous suspension. The freeze-dried chitin prepared at −20° C. freezing temperature is white and opaque (FIG. 2.2A), and consists of a three-dimensional aperiodic fibrous network structure with d_{avg}=220 nm, ranging from 150 nm to 350 nm based on top, bottom and cross-sectional SEM images (FIGS. 2.2B-E). These results show that single CNFs assemble into larger, randomly oriented interconnected fibril bundles during freezing, very similar to the white beetle scale structure (fibrous network structure with fiber diameter of around 250 nm).⁵ While the fiber size and interconnectivity of freeze-dried chitin are similar to the white beetle structure, the synthetic structures are much more porous (>90% in Table 1) than the beetle structure (˜30%) (pore size distribution listed in FIG. 2.2F). CNF suspensions were also frozen at −80° C. and −196° C. (liquid nitrogen), but these conditions do not produce fibrous structures. At −80° C., the frozen chitin has a random porous architecture (FIGS. 2.3A-B) consisting of sheet-like structures, while parallel-walled structures result from liquid nitrogen freezing (FIG. 2.3D). Oriented and sheet-like porous structures, similar to those derived here at −80° C. and −196° C., have been reported before by utilizing different starting materials and their structure formation mechanism has already been established.^{22-24, 28} Reports of freeze drying chitosan (not chitin) at high temperature (−20° C.) have demonstrated macroporous sheet-like structures,^{19, 20} but not fine nanofibrous structures created herein with chitin. As discussed below, we propose that the solubility of chitosan likely leads to precipitation into large domains during freezing, whereas starting with insoluble chitin nanofibers leads to a preservation of the nanoscale features.

Ice crystallization is well-characterized and consists of two successive processes: crystal nucleation and growth. The rate of ice nucleation is determined by the degree of supercooling whereas the ice growth rate is largely controlled by the rate of heat transfer from the crystal surface to the bulk water.²⁹⁻³¹ A suspended particle close to an advancing ice front is acted on by two opposing forces: a repulsive force derived from van der Waals forces and an attractive force owing to viscous drag. A balance of these two forces yields a critical ice growth velocity at which particle encapsulation by the ice occurs. Below this velocity, particles repelled by ice should be pushed together into the interstitial spaces between ice crystals, e.g., formed structures are larger than the original particles. Above this critical velocity the structures are encapsulated as ice grows around the particles.^{24, 32, 33} The formation of large (>10 μm) porous structures at −80° C. and −196° C. (FIGS. 2.3E and 2.3F), starting with 20 nm CNFs, indicates that ice front velocity was below the critical encapsulation velocity. At −196° C., the CNF suspension is subject to a significant temperature gradient in the thickness direction, leading to fast ice crystallization in this direction to the orthogonal, leading to oriented porous structures (FIG. 2.3C and 2.3D). Under −80° C. freezing, there was no preferred growth direction, likely due to the reduced temperature gradient, and CNFs were expelled by ice fronts to form large, disoriented sheet-like structures.

Ice growth rate should be slower at −20° C. than at −80° C. or −196° C. based on the reduced driving force for heat removal.^{30, 34} Thus the ice growth velocity at −20° C. will be even further below the critical velocity for encapsulation of CNFs than at −80° C. Hence, we expect that ice crystal size at −20° C. should be larger than that at −80° C. because slower freezing rate generally results in larger ice crystals.^{26, 31, 35, 36} However, the pore size of freeze-dried chitin observed from FIGS. 2.2B-E and FIGS. 2.3A-B is smaller at −20° C. than at −80° C. (pore size distribution shown in table 1, FIGS. 2.2F and 2.3E), which indicates that they are not controlled by ice crystal size. This implies that CNFs are encapsulated and are not pushed to interstitial boundaries. Hence, the observation of smaller pore size at −20° C. contradicts the prediction of the particle encapsulation model. We suggest that this discrepancy is due to the fact that CNFs do not behave as independent particles, but experience significant interactions. For example, chitin nanocrystals exhibit strong van der Waals attraction and electrostatic interactions and are known to form nematic gels with increasing concentration in water.³⁷

The proposed mechanism for formation of fibrous network structures under −20° C. freezing is illustrated in FIG. 2.4. First, CNFs are well dispersed in water at pH 4 due to strong electrostatic repulsion. When the CNF suspension is supercooled sufficiently, ice starts to nucleate and grow. Initially, isolated CNFs are pushed together by the advancing ice fronts, leading to fiber-fiber interactions such as van der Waals attraction, electrostatic repulsion, and hydrogen bonding. At this stage we propose that individual CNFs assemble into interconnected nanofiber bundles between 150-350 nm in diameter. As ice continues to grow slowly, these bundles do not become oriented, but rather form a three-dimensional aperiodic network structure with fiber diameters averaging about 220 nm. This network structure can apparently resist being broken by the advancing ice fronts, and the growing ice crystals pass around and encapsulate this network instead. Since the ice growth rate is expected to be relatively slower at −20° C. than at −80° C., we argue that single CNFs have more time to reorient and align into packed bundles at −20° C., whereas the advancing ice front more quickly expels CNFs and then ruptures the developed network structure under −80° C. and −196° C. freezing to form sheet-like structures (faster aggregation). A previous report showed that chitosan dissolved in acetic acid formed large macroporous sheet structures under −20° C. freezing.²⁰ Because chitosan was dissolved, fibers were not initially present to form a network in the early stages of freezing. Rather, the chitosan formed phase-separated micron-sized structures as solution concentration increased in the interstitial spaces. Hence, formation of the fine network structure likely depends on the initial presence of fine insoluble chitin fibers.

Above, we have shown that tuning freezing temperature results in adjustable pore structure and have argued that this is the result of adjustments in the ice crystallization rate. Hence, tailoring the geometry and material of the freezing substrate to achieve finer control of cooling rate may allow further opportunities to tune the freeze-dried structure. To investigate this, the CNF/water suspension was frozen at −20° C. using an indented stainless-steel mold that is considerably thicker than the aluminum dishes used above (schematic in FIG. 2.6). In FIGS. 2.5A and 2.5B, we observe that the resulting freeze-dried chitin is comprised of a fibrous network structure with an average pore size of 326 nm (pore size distribution listed in FIG. 2.5C) and filament diameter near 40 nm, much smaller than the dimensions of chitin frozen in the aluminum dish at −20° C. The porosity of the structures produced at −20° C. in the stainless-steel mold was 99.6%, compared to 98.5% for the aluminum dish, which is consistent with the finer structures observed in the stainless-steel system. Supercritical drying and organic solvent-based freeze drying have been shown to produce such finely porous materials previously,^{13, 38} but it is very rare that this fine structure can be achieved directly by water-based freeze drying, because ice fronts usually advance so quickly that solute or dispersed solids are expelled to form large aggregates. Compared with −20° C. freezing in the aluminum pans, we expect a slowing in ice growth rate in the steel mold due to lower heat transfer rate. The conductive resistance of the steel substrate wall is about 1000 times larger than that of the aluminum substrate (Rₐₗᵤₘ=Δx/kₐₗᵤₘ=0.2 mm/229 W·(m·K)⁻¹=8.7×10⁻⁷ (m²·K)/W versus Rₛₜₑₑₗ=Δx/kₛₜₑₑₗ=14.2 mm/16 W·(m·K)⁻¹=8.9×10⁻⁴ (m²·K)/W, where Δx=thickness and k=thermal conductivity).³⁹ The further decrease in the fiber size and pore size is consistent with the model proposed above, since the slower moving ice front (steel substrate) exerts less shearing force on the CNF network structure (compared to aluminum substrate), allowing preservation of finer structures that form early in the CNF aggregation process.

In summary, we have produced the first porous nanofibrous materials derived solely from chitin nanofibers by using a facile freeze drying method. These structures mimic the size and interconnectivity of the white Cyphochilus beetle cuticle, but with improved porosity well-beyond that of the natural structure (30% to >95%). The formation of such fine nanofibrous structures is not predicted by the widely-used particle encapsulation model, and has not been demonstrated previously using freeze-drying. We reason that the nanofibrous network structure is made possible because chitin nanofibers are insoluble and they experience significant attractive interactions, and combined with a slow freezing rate, the network structure remains intact during freezing. We have shown that versatile porous structures can be achieved by simply adjusting freezing temperature or system geometry. Previously, supercritical drying and organic solvent-based freeze drying have been used to generate delicately porous fibrous materials because water-based freeze drying usually results in significant aggregations of original building blocks. In contrast, our findings show how to achieve such fine structures by more facile water-based freeze drying. The innovative, sustainably-sourced chitin materials are of ideal size range to be useful in a wide variety of applications, including as components of thermal insulation, reflective energy-efficient exterior coatings, reinforcing phase for polymer composites and as a basic template for sensors, tissue scaffolds, catalyst supports, filtration, absorbents and energy storage materials.^{6-15, 40} The freeze drying method outlined here should be applicable to tunable assembly of nanofibrous structures from other network-forming water-dispersible polymers and other materials.

### REFERENCES

(1) Rinaudo, M. Prog. Polym. Sci. 2006, 31, 603-632.
(2) Pillai, C. K. S.; Paul, W.; Sharma, C. P. Prog. Polym. Sci. 2009, 34, 641-678.
(3) Nair, K. G.; Dufresne, A. Biomacromolecules 2003, 4, 657-665.
(4) Raabe, D.; Sachs, C.; Romano, P. Acta Mater. 2005, 53, 4281-4292.
(5) Vukusic, P.; Hallam, B.; Noyes, J. Science 2007, 315, 348-348.
(6) Ye, C.; Li, M.; Hu, J.; Cheng, Q.; Jiang, L.; Song, Y. Energy Environ. Sci. 2011, 4, 3364-3367.
(7) Ng, R.; Zang, R.; Yang, K. K.; Liu, N.; Yang, S. T. R. Soc. Chem. Adv. 2012, 2, 10110-10124.
(8) La Torre, A.; Gimenez-Lopez, M. d. C.; Fay, M. W.; Rance, G. A.; Solomonsz, W. A.; Chamberlain, T. W.; Brown, P. D.; Khlobystov, A. N. ACS Nano 2012, 6, 2000-2007.
(9) Korhonen, J. T.; Hiekkataipale, P.; Malm, J.; Karppinen, M.; Ikkala, O.; Ras, R. H. A. ACS Nano 2011, 5, 1967-1974.
(10) Liang, H. W.; Wang, L.; Chen, P. Y.; Lin, H. T.; Chen, L. F.; He, D.; Yu, S. H. Adv. Mater. 2010, 22, 4691-4695.
(11) Yuan, J.; Liu, X.; Akbulut, O.; Hu, J.; Suib, S. L.; Kong, J.; Stellacci, F. Nat. Nanotechnol. 2008, 3, 332-336.
(12) Gu, G.; Schmid, M.; Chiu, P. W.; Minett, A.; Fraysse, J.; Kim, G. T.; Roth, S.; Kozlov, M.; Munoz, E.; Baughman, R. H. V₂O₅ Nat. Mater 2003, 2, 316-319.
(13) Capadona, J. R.; Van Den Berg, O.; Capadona, L. A.; Schroeter, M.; Rowan, S. J.; Tyler, D. J.; Weder, C. Nat. Nanotechnol. 2007, 2, 765-769.
(14) Chen, L. F.; Zhang, X. D.; Liang, H. W.; Kong, M.; Guan, Q. F.; Chen, P.; Wu, Z. Y.; Yu, S. H. ACS Nano 2012, 6, 7092-7102.
(15) Qie, L.; Chen, W. M.; Wang, Z. H.; Shao, Q. G.; Li, X.; Yuan, L. X.; Hu, X. L.; Zhang, W. X.; Huang, Y. H. Adv. Mater 2012, 24, 2047-2050.
(16) Hartgerink, J. D.; Beniash, E.; Stupp, S. I. Science 2001, 294, 1684-1688.
(17) Aida, T.; Meijer, E. W.; Stupp, S. I. Science 2012, 335, 813-817.
(18) Min, B. M.; Lee, S. W.; Lim, J. N.; You, Y.; Lee, T. S.; Kang, P. H.; Park, W. H. Polymer 2004, 45, 7137-7142.
(19) Madihally, S. V.; Matthew, H. W. T. Biomaterials 1999, 20, 1133-1142.
(20) Qian, L.; Zhang, H. Green Chem. 2010, 12, 1207-1214.
(21) Munch, E.; Launey, M. E.; Alsem, D. H.; Saiz, E.; Tomsia, A. P.; Ritchie, R. O. Science 2008, 322, 1516-1520.
(22) Gutierrez, M. C.; Ferrer, M. L.; del Monte, F. Chem. Mater. 2008, 20, 634-648.
(23) Deville, S.; Saiz, E.; Nalla, R. K.; Tomsia, A. P. Science 2006, 311, 515-518.
(24) Zhang, H. F.; Hussain, I.; Brust, M.; Butler, M. F.; Rannard, S. P.; Cooper, A. I. Nat. Mater. 2005, 4, 787-793.
(25) Xu, Z.; Zhang, Y.; Li, P. G.; Gao, C. ACS Nano 2012, 6, 7103-7113.
(26) Deville, S. Adv. Eng. Mater. 2008, 10, 155-169.
(27) Yan, J.; Chen, Z.; Jiang, J.; Tan, L.; Zeng, X. C. Adv. Mater. 2009, 21, 314-319.
(28) Koehnke, T.; Lin, A.; Elder, T.; Theliander, H.; Ragauskas, A. J. Green Chem. 2012, 14, 1864-1869.
(29) Petzold, G.; Aguilera, J. M. Food Biophys. 2009, 4, 378-396.
(30) Kiani, H.; Sun, D. W. Trends Food Sci. Tech. 2011, 22, 407-426.
(31) Hobbs, P. V. Ice Physics, Clarendon Press, Oxford, 1974.
(32) Korber, C.; Rau, G.; Cosman, M. D.; Cravalho, E. G. J. Cryst. Growth 1985, 72, 649-662.
(33) Wegst, U. G. K.; Schecter, M.; Donius, A. E.; Hunger, P. M. Phil. Trans. of the R. Soc. A 2010, 368, 2099-2121.
(34) Rodrigues, M. A.; Miller, M. A.; Glass, M. A.; Singh, S. K.; Johnston, K. P. J. Pharm. Sci. 2011, 100, 1316-1329.
(35) Gutierrez, M. C.; Garcia-Carvajal, Z. Y.; Jobbagy, M.; Rubio, T.; Yuste, L.; Rojo, F.; Ferrer, M. L.; del Monte, F. Adv. Funct. Mater. 2007, 17, 3505-3513.
(36) Svagan, A. J.; Jensen, P.; Dvinskikh, S. V.; Furo, I.; Berglund, L. A. J. Mater. Chem. 2010, 20, 6646-6654.
(37) Tzoumaki, M. V.; Moschakis, T.; Biliaderis, C. G. Biomacromolecules 2010, 11, 175-181.
(38) Nogi, M.; Kurosaki, F.; Yano, H.; Takano, M. Carbohydr. Polym. 2010, 81, 919-924.
(39) Welty, J. R.; Wicks, C. E.; Wilson, R. E.; Rorrer, G. Fundamentals of Momentum, Heat, and Mass Transfer, John Wiley and Sons, Inc., Hoboken, N.J., 2001.
(40) Clyne, T. W.; Golosnoy, I. O.; Tan, J. C.; Markaki, A. E. Phil. Trans. R. Soc. A 2006, 364, 125-146.

### Example 3

With excellent reinforcing performance and many remarkable inherent properties, such as renewability and high strength-per-unit-mass, chitin nanofibers (ChNFs) are attractive resources for polymer composite applications. However, significant challenges resulting from chitin's insolubility have hindered efforts to incorporate it effectively into polymer matrices. Here, ChNFs extracted from crab shells were used as fillers to reinforce polyethylene oxide (PEO). The dispersion of ChNFs in the polymer matrix and the interactions between fiber and matrix were studied by utilizing solvent-etching of the polymer matrix, FTIR spectroscopy and AFM colloidal probe adhesion measurements. The results show that the ChNFs were dispersed well and formed a fine interconnected network structure in the PEO matrix. ChNFs also exhibited strong adhesion with PEO, resulting from hydrogen bond and van der Waals forces. The ChNF interconnected network greatly enhanced the mechanical properties of PEO, with a 3-fold increase in both the tensile strength and elastic modulus of the nanocomposites at 20% ChNF loading. Processing ChNFs in suspensions with slight acidity and water-soluble polymers appears to support the formation of highly interconnected networks that makes ChNF-polymer composites excellent candidates for reinforced, light-weight, renewable materials.

The development of nanofiller-reinforced polymer composites has attracted intense attention from researchers over the past two decades due to the large surface area/volume ratio of nanofillers, and various materials have been utilized to enhance the mechanical properties of polymer matrices, such as single-walled/multi-walled carbon nanotubes, layered silicate and nanocellulose.^{[}1-7] To date, tremendous efforts have been devoted to improving filler adhesion with polymers and their dispersion in matrices since these two factors significantly influence stress transfer in nanocomposites. Methods applied to address these issues include physical-mechanical treatment and chemical functionalization.[2-7] However, it is still challenging to enhance particle or fiber dispersion and adhesion with the matrix simultaneously.[2-7]

Chitin, the second most abundant naturally occurring polymer, forms a highly ordered crystalline structure in living organisms.[8, 9] Nanosized crystalline chitin (chitin nanocrystal or chitin nanowhisker) can be produced by strong acid hydrolysis, and shows excellent mechanical properties, such as a longitudinal modulus of 150 GPa and transverse modulus of 15 GPa.[10] Recently, our group reported that ChNFs with diameter of ˜20 nm could be extracted from crab shells by a high pressure homogenization process.[11, 12] The size and mechanical properties of ChNF features make them ideal reinforcing materials for polymer matrices. PEO is a water-soluble and biocompatible semi-crystalline polymer that has found applications in many fields, such as electrolytes, and biomedical engineering.[1, 13, 14] However, its low modulus and tensile strength limit applications. These mechanical limitations and its water solubility make PEO an ideal model system for examining dispersion, adhesion and strengthening possible with ChNFs. In this work, we prepared ChNF-PEO composites with up to 20% ChNF content. Solvent-etching of the polymer matrix followed by SEM, FTIR spectroscopy and AFM colloidal probe adhesion measurements were used to study the ChNF dispersion and adhesion between ChNF and PEO matrix. The results demonstrate that without utilizing chemical surface modification, ChNFs can be readily dispersed in PEO, form a remarkable interconnected network nanostructure and have strong adhesion with PEO, significantly enhancing tensile strength and elastic modulus simultaneously.

### Experimental Section

### Materials

Dried crab shell flakes were purchased from TCI America. Deionized water (18.2 MΩ cm) was prepared in a Barnstead Easypure RoDi purification system. Hydrochloric acid, sodium hydroxide, acetone and ethanol were purchased from EMD Chemical Inc. Poly(ethylene oxide) (PEO, My=1,000,000 g/mol, Sigma-Aldrich), poly(ethylene) (PE, Mw=40,000 g/mol, Sigma-Aldrich), poly(styrene) (PS, Mw=230,000 g/mol, Sigma-Aldrich), poly(vinyl acetate) (PVAc, Mw=50,000 g/mol, Alfa Aesar), and poly(vinyl alcohol) (PVOH, Mw=89,000-98,000 g/mol, Sigma-Aldrich) were used as received without further purification. 1,2,3-trichlorobenzene (TCB, Sigma-Aldrich), hexafluoroisopropanol (HFIP, TCI America), and toluene (Sigma-Aldrich), glycerol (Alfa Aesar, purity>99%) and diiodomethane (Alfa Aesar, purity>99%) were used as received. Polystyrene (PS) particle with diameters of ˜10 μm was purchased from Alfa Aesar Inc.

### Methods

Preparation of ChNFs: Dried crab shell flakes were processed to obtain purified chitin.[11, 12, 15, 16] Ground crab shells were refluxed in 5 wt % sodium hydroxide in DI water for 6 h to remove protein. The suspension was filtered and rinsed with DI water until the pH was 7. Next, the filtered solids were treated with 7% hydrochloric acid for 6 h at room temperature to remove minerals. After filtration and washing with DI water, the treated sample was refluxed in a 5% NaOH solution for 2 days to remove residual proteins. A final extraction with acetone and ethanol was used to remove any remaining residues (soluble dye for example). The purified chitin was dispersed in distilled water under acidic condition and then this mixture was passed through a high-pressure homogenizer (Bee International Inc., MA) to generate ChNFs (aqueous medium pH is ˜4.1). Detailed information on ChNF production is described elsewhere.[11]

Preparation of ChNF/PEO Nanocomposite Films: The PEO was firstly dissolved at 2 wt. % in DI water at room temperature under a magnetic stirring. To prepare 5, 10, 15 and 20 wt. % ChNF/PEO composite films, the proper amount of ChNF/water dispersions were added to the PEO solution. These mixtures were magnetically stirred for two days, and were subsequently casted into a PS Petri dish, followed by drying under vacuum at 40° C. for two days. The free standing dried ChNF/PEO nanocomposite films were obtained by carefully peeling films from the PS substrate. Neat PEO films were prepared using the same processing conditions for comparison. Both neat PEO and composite films had a thickness of ˜50 μm, as determined by an interferometer (Model ID-C112CEB, Mitutoyo Corp.).

Preparation of ChNF Coated Polystyrene (PS) Colloidal Particles: In order to fabricate colloidal probes coated with ChNFs for adhesion measurements, a 0.5 wt. % ChNF in water dispersion was added to a PS particle suspension (10 μm, 2.5 wt % in water), followed by agitation using a rotational shaker for 12 h. The mixture was then centrifuged in a micro-centrifuge (VWR Micro 1207). The ChNF coated PS particles were settled at the bottom of the container and dried in air at room temperature.

Preparation of Polymer Films: Substrates for colloidal-probe adhesion studies were prepared by coating a series of polymer films on Piranha-cleaned silicon wafers. The PE solution was prepared by dissolving 5% PE by mass in hot 1,2,3-trichlorobenzene at ˜100° C. The PS solution was prepared by dissolving 10% PS by mass in toluene. 5 wt. % PVOH and PVAc solutions were prepared in hexafluoroisopropanol. The PEO solution was prepared by dissolving 1 wt. % by mass in DI water. Polymer films were prepared on Piranha-etched silicon substrates, by using a knife-edge coating method described in detail elsewhere.[17] The cast polymer films were firstly dried at room temperature for 24 h and then dried under vacuum for at least 12 h (PVAc at 20° C. for 48 h and other polymers at 60° C. for 12 h) to remove the residual solvent. After drying, films were transferred to a desiccator and stored prior to measurements. Film thickness was approximately 10-20 μm, determined by using an interferometer (Model ID-C112CEB, Mitutoyo Corp.).

Measurements of Adhesion Forces: Adhesion force measurements were carried out using atomic force microscopy (AFM) (Veeco Dimension 3100). Tipless rectangular cantilevers with nominal spring constants of 0.6-3.7 N/m (Applied NanoStructures, Inc., Santa Clara, Calif.) were used. Single ChNF-coated or bare PS particles were glued to the tipless cantilevers with a small amount of epoxy resin (Epoxy Marine, Loctite, Westlake, Ohio USA) using a procedure described in detail elsewhere.[18] The actual spring constants for the cantilevers with the attached ChNF-coated or bare PS particles (0.7-1.1 N/m) were determined directly by the methods of Burnham and Hutter et al.[19] A series of 20 force-distance curves were measured for each combination of PS/ChNF or bare PS tip-polymer surface, taken on three separate substrate surfaces within three randomly chosen 1 cm×1 cm areas on each substrate at 20° C., humidity 25-30%. Three separate ChNF-coated or bare PS particle tips were used for each set of measurements with a given substrate. The applied load during force measurements was 2.5 nN. The mean (R_{α}) and root-mean-square (rms) surface roughness of each polymer film for adhesion measurements were obtained from topography scans of three randomly-chosen 10 μm×10 μm areas on each polymer surface by using AFM with a standard pyramidal silicon nitride probe.

Contact Angle Measurements: Contact angles of each polymer surface were measured at 20° C. using a video contact angle system (AST products 2500XE, Billerica, Mass.). Three standard testing liquids were chosen, two polar liquids (DI-water and glycerol) and one nonpolar (diiodomethane), to calculate the surface tension components of each polymer surfaces. Nine 1 μL drops of each liquid were used for the contact angle test of each polymer surface. Surface tension components corresponding to van der Waals (VDW), Lewis acid, and Lewis basic interactions were calculated from measured contact angle data by using van Oss and Good's van der Waals acid-base theory.[20] According to this theory, the surface energy is accessed from Equation 1.

γΣ=γΣ^{ω̅Ω}+2(γΣ⁺γΣ^{□})^{1/2} (1)

where, γ_{S} is the total surface tension, y_{S}^{vW} is the van der Waals component, y_{S}⁺ is the acid (electron acceptor) component, and y_{S}⁻ is the base (electron donor) component of the solid substrate. The relation between surface energy components and the liquid-solid-air contact angle (θ) is given as:

γ_{L}(1+cos θ)=2(γ_{S}^{vW}γ_{L}^{vW})^{1/2}+2(γ_{S}⁺γ_{L}⁻)^{1/2}+2(γ_{L}⁺γ_{S}⁻)^{1/2} (2)

where, γ_{L} represents the surface energy of the testing liquids. By using the known components of γ_{L} for three carefully-chosen liquids, the γ_{S} components can be determined by regression. The surface tensions of the testing liquids are as follows: water, γ⁺=γ⁻=25.5, γ^{vW}=21.8 , γ=72.8 mJ/m²; glycerol, γ⁺=3.92, γ⁻=57.4, γ^{vW}=34.0, γ=64.0 mJ/m²; diiodomethane, γ⁺=γ⁻=0, y^{vW}=50.8, γ=50.8 mJ/m².[21, 22]

Characterizations of ChNFs: The morphologies of the prepared materials were characterized using Field-Emission Scanning Electron Microscopy (SEM, Zeiss Ultra 60, Carl Zeiss SMT, Ltd., Thornwood, N.Y.). Before imaging, these samples were coated with a thin layer of gold/palladium (Hummer IV Sputtering System) to prevent sample charging. A solvent-etching procedure was used to selectively remove PEO domains from composites in order to aid in visualization of the ChNF morphology. Etched films were prepared by washing with water followed by rinsing with ethanol and drying at room temperature for 2 days prior to SEM imaging.

The attenuated total reflectance-Fourier transform infrared spectra (ATR-FTIR) of ChNF, neat PEO and nanocomposite films were recorded using a Bruker Vertex 80v FTIR spectrometer coupled to a Hyperion 2000 IR microscope under a 20× magnification ATR objective (Broker Optics, Inc., Billerica, Mass.). Measurements were collected from 4000 to 400 cm⁻¹ with a resolution of 4 cm⁻¹, and were averaged over 64 scans. The surface charge of ChNFs at pH 4.1 in water was measured by a Malvern Zetasizer Nano ZS 90.

Mechanical characterization of neat PEO and PEO nanocomposites was conducted using a high-throughput mechanical characterization (HTMECH) apparatus under ambient conditions, described in detail elsewhere.[23, 24] Briefly, the polymer films were mounted in between two stainless steel plates and indented by a steel pin with a diameter of 1.5 mm at a constant strain rate (0.5 mm/s), resulting in equi-biaxial deformation. For each sample, a minimum of 9 stress-strain tests were performed to obtain films' mechanical properties, such as elastic modulus and tensile strength.

The glass transition temperatures of the materials were measured using dynamic mechanical analysis (DMA, Q800, TA Instruments, DE USA). The samples were cut into rectangular strips about ˜3 cm long and ˜3 mm wide and were tested in a tension mode while being heated from −90° C. to 40° C. with a heating rate of 2° C./min at a frequency of 1 Hz. All tests were performed in the linear viscoelastic region.

Differential scanning calorimetry (DSC) (Q200, TA Instruments, USA) was used to obtain the melting temperature and crystallinity of neat PEO and PEO nanocomposites. Approximately 5-10 mg of sample was loaded into aluminum pan. The PEO samples were heated and cooled at a rate of 10° C./min under a nitrogen flow of 50 mL/min. The samples were firstly cooled from room temperature to −80° C., held at −80° C. for 5 min, and were heated to 120° C., followed by maintaining at this temperature for 5 min and cooling to room temperature.

### Results and Discussion

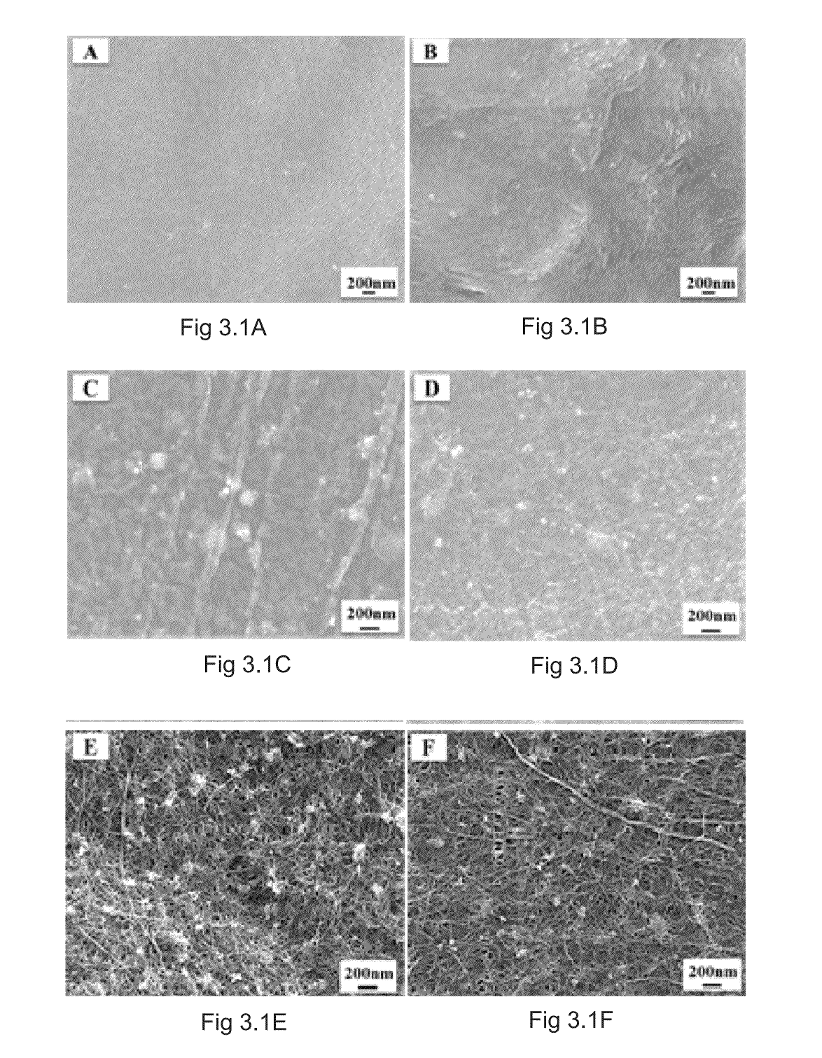

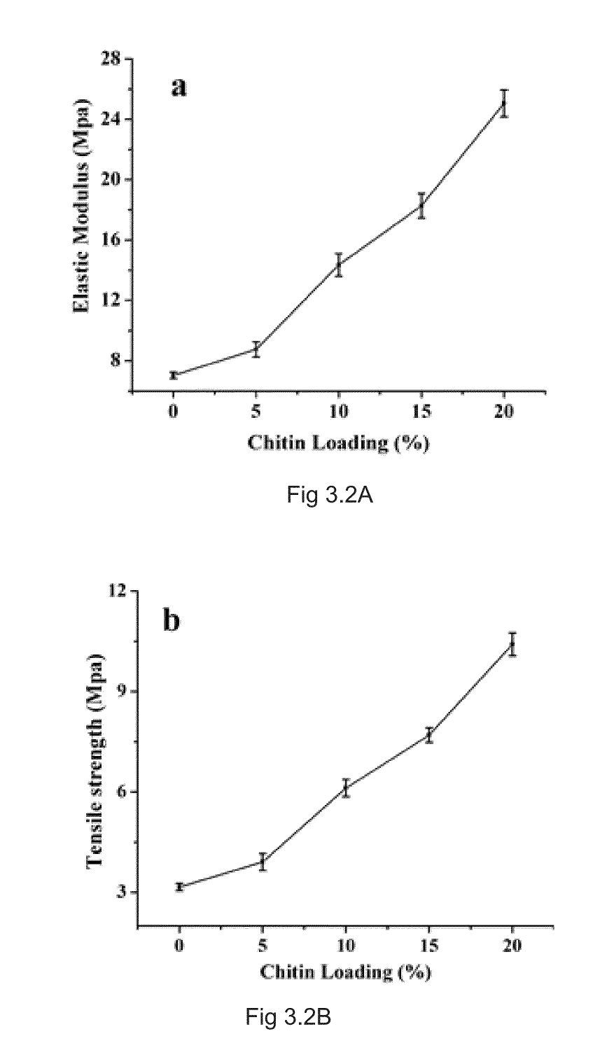

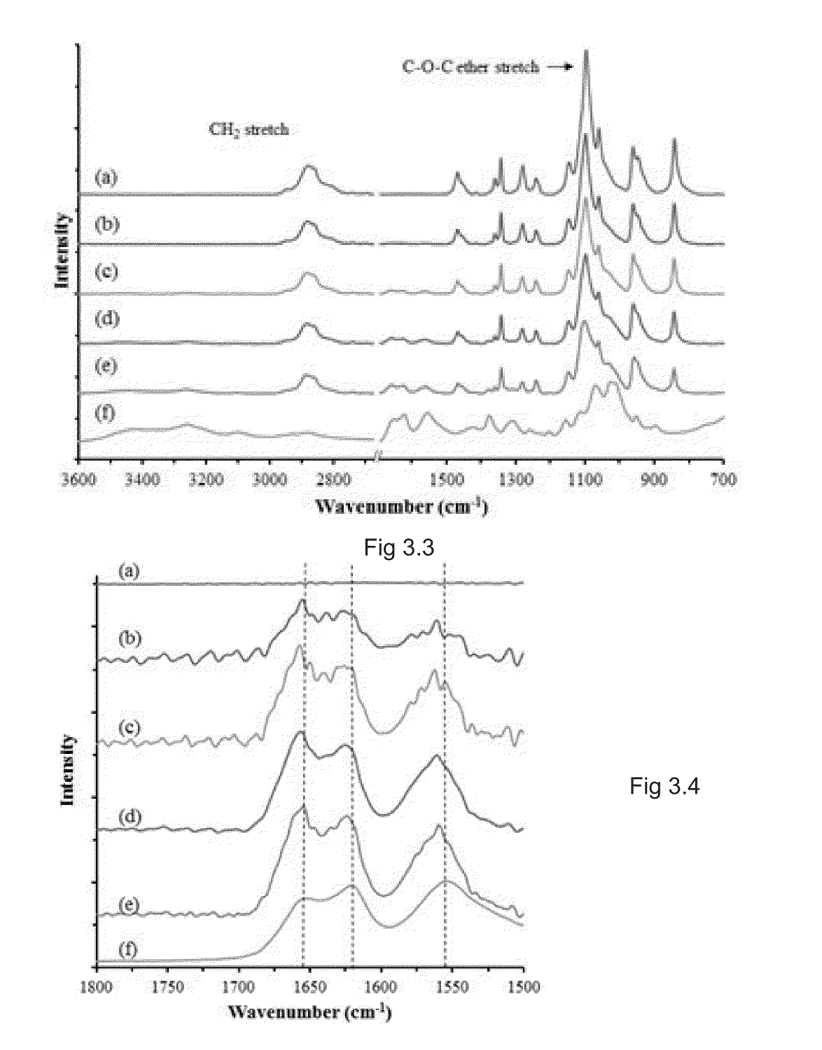

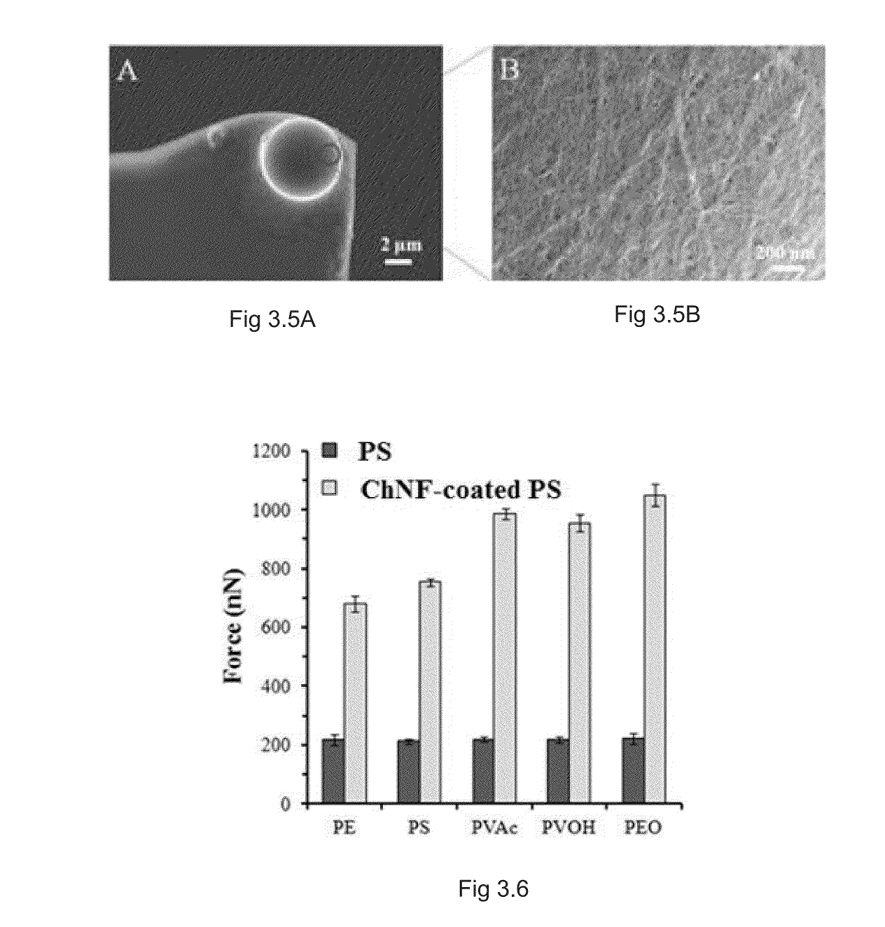

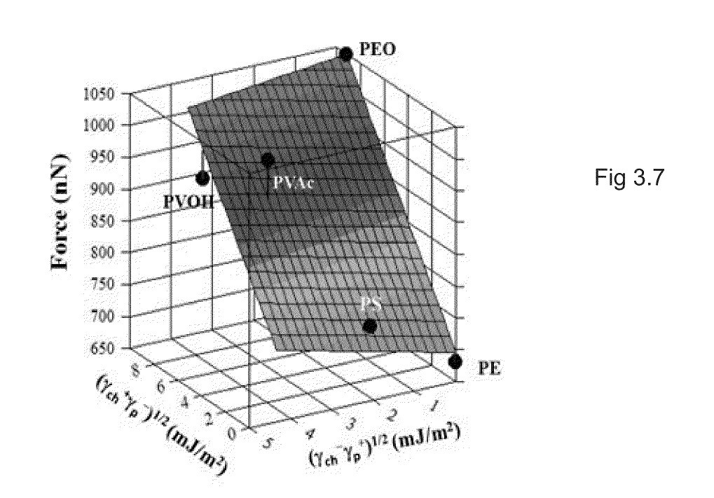

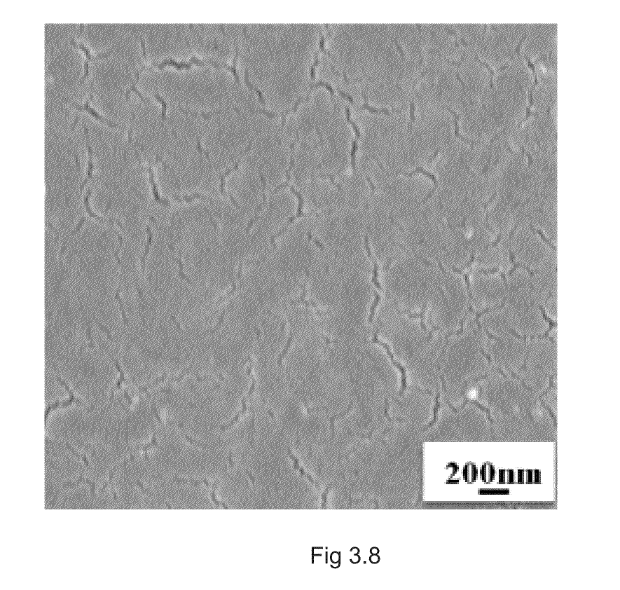

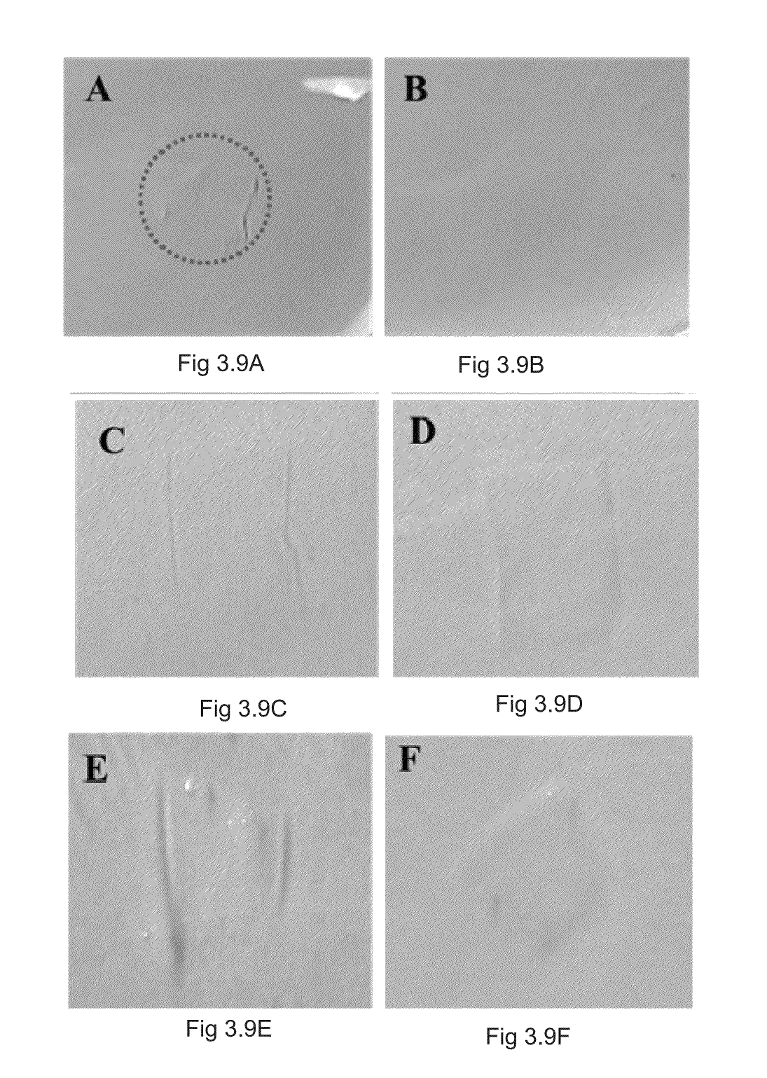

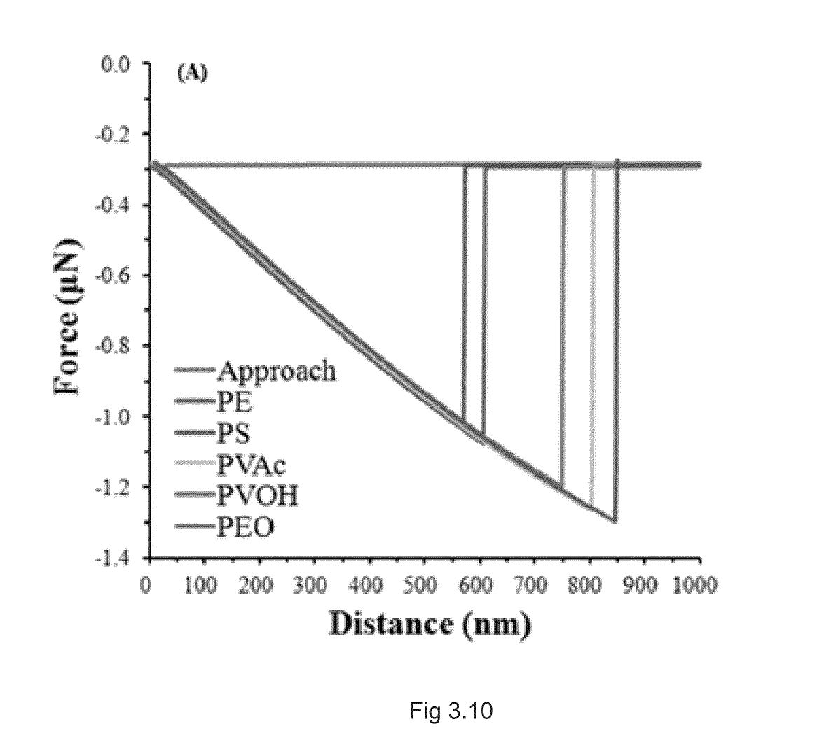

Morphologies of ChNF/PEO Nanocomposite Films: ChNFs produced from the high-pressure homogenization process have an average diameter of 20 nm, mainly ranging from 5 to 50 nm and lengths that vary between hundreds of nanometers to several micrometers, as shown in FIG. 1.4D. They have a zeta potential of +57.5 mV at pH 4.1 due to protonated —NH₃⁺ groups.[11] SEM images of the as-prepared films, shown as cross-section (FIGS. 3.1A-B, and FIG. 3.8) and top-view (FIG. 3.1 C-D) indicated that 10% and 20% ChNF composites have void-free surfaces. The outlines of fibrous morphologies assumed to be ChNFs can be observable, suggesting that ChNFs were imbedded in the PEO matrix and had good adhesion with PEO. However, the identity, size and interconnectivity of the ChNFs cannot be observed directly from FIGS. 3.1A-D. Since PEO is water soluble, but ChNFs are not, a solvent-etching procedure was used to selectively remove PEO domains in composites. As shown in supplementary data (FIGS. 3.9A-F), neat PEO films were totally dissolved within 3 hours of water immersion, while ChNF/PEO composites maintained their shape after 10 days of water immersion and 3 days of ethanol immersion before drying. FIG. 3.1E and 3.1F show SEM images of the top surfaces of the dried solvent-etched 10% and 20% ChNF composite films, respectively. Porous fibrous network structures are observed in both samples, and most fibers in the 10% ChNF sample (FIG. 3.1E) have diameters ranging from 5 to 50 nm. Despite more fiber aggregates being observed for 20% ChNF/PEO, there are still many fibers with diameters of below 50 nm (FIG. 3.1F). FIGS. 3.1A-F and 3.9A-F clearly show that the ChNFs were dispersed well and formed network structures in the PEO matrix. We propose that the good dispersion of ChNFs is ascribed to the excellent dispersion of ChNFs in water before their mixing with PEO, electrostatic repulsion between ChNFs in PEO solution (pH<6), and strong adhesion between ChNF and PEO, as discussed below in detail.

### Mechanical Properties of ChNF/PEO Nanocomposite Films

Nanofibrous fillers can lead to composite materials with better mechanical properties than those of the neat polymers. However, their reinforcing effect depends on many factors, including filler morphologies, filler concentration and filler dispersion in matrices and filler adhesion with matrices.[1-7, 25-32] The mechanical properties of neat PEO and ChNF/PEO composite films are shown in FIG. 3.2A-B. The elastic modulus and tensile strength increased significantly with increasing ChNF loading, up to a factor of ˜3 times for 20% ChNF compared to neat PEO. It is worth noting that not all nanofibrous fillers show a simultaneous increase of modulus and strength that is observed with ChNFs. For example, Xu et al. studied the reinforcing effects of cellulose nanocrystals and cellulose nanofibrils in PEO matrices.[32] The authors found that the tensile strength and modulus of the prepared composites initially increased when loading fillers up to 7% and then decreased as cellulose content further increased. The authors further reasoned that the decreases in mechanical properties at higher filler loading resulted from filler agglomeration. [32] In contrast, compared with cellulose nanofibrils in PEO matrix[32], the ChNFs obtained through a high-pressure homogenizer in this work exhibited a more uniform size, less entanglement and smaller bundles and were more well dispersed in the PEO matrix (FIGS. 3.1 and 1.4D). Herein, the continuous increases in tensile strength and modulus of ChNF/PEO composites with up to 20% ChNF loading are likely due to ChNFs' high mechanical properties, strong adhesion between PEO and ChNFs (as demonstrated below in FTIR and adhesion results), and good dispersion of ChNFs in the PEO matrix, resulting in efficient stress transfer within the ChNF network structure observed in SEM above.

### FTIR of ChNF/PEO Nanocomposite Films

In terms of chemical structures of chitin and PEO, it is expected that hydrogen bonds may form between them since the ether oxygen (C—O—C) in PEO is a hydrogen bond acceptor and there are —OH and —NH hydrogen bond donors in chitin Infrared spectroscopy is a highly effective method for investigating hydrogen bond interactions in blend composites.[33] As shown in FIG. 3.3, the characteristic absorption bands for PEO are detected at 1095 and 2878 cm⁻¹, which are attributed to C—O—C stretching and CH₂ stretching, respectively.[33, 34] The characteristic peaks of chitin such as the amide band I at 1654 and 1620 cm⁻¹ and the amide band II at 1554 cm⁻¹ are observed.[8, 9] All these characteristic peaks from chitin and PEO can be detected in all the composites. With decreasing ChNF loading from 100% to 5%, the amide I and amide II shift to higher frequencies from 1620 to 1628 cm⁻¹ and from 1554 to 1562 cm⁻¹, respectively (FIG. 3.4). This suggests that ChNF—ChNF hydrogen bonds involving the amide nitrogen have been disrupted after addition of PEO by formation of hydrogen bonds between surface-NH groups on ChNF fibers and the ether oxygen of PEO. We note that the h-bonds between O—H^{. . .} N (29 kJ/mol) and N—H^{. . .} N (13 kJ/mol) (representative of ChNF—ChNF) are stronger than N—H^{. . .} O (8 kJ/mol) (representative of ChNF-PEO).[35, 36] Thus the shift to higher amide frequencies is consistent with the expectation of some fraction of weaker h-bonds between PEO to ChNF.

Interaction of ChNF with Polymer Films

An alternative possibility is that ChNF—ChNF h-bonds are broken during fiber dispersion without any new PEO-ChNF h-bonds formed, which is difficult to ascertain using ATR-FTIR alone. To provide additional characterization of the nature of ChNF adhesion with PEO, adhesion force measurements were conducted using an AFM colloidal probe method. FIGS. 3.5A-B shows the morphologies of the ChNF-coated PS particle that was attached to the tipless cantilever. The adsorption of ChNFs on the PS surface was driven by their electrostatic attraction, where the PS particle has a negative charge due to surface sulfate groups and ChNF has positive charge because of protonated —NH₃⁺ groups. Five kinds of polymer substrates (PE, PS, PVAc, PVOH and PEO) were chosen to examine the effect of surface chemistry on the adhesion forces of ChNFs. The surface roughness, contact angles and calculated surface tension components of these polymers are listed in Tables 1-3. As shown in Table 3, PE and PS are essentially apolar, while PEO, PVAc and PVOH have large Lewis basic components, where lone electron pairs are provided by ether, carbonyl and hydroxyl groups, respectively. These surface tension results are consistent with polarity considerations of the molecular structures.

As shown in FIG. 3.6, the adhesion forces for bare PS were independent of the polymer surface types. FIG. 3.10 shows the typical raw force-distance curves for ChNF-coated PS particles on varied polymer surfaces, which indicates that their interactions are in a short-range (<5 nm). This is consistent with the expectation that adhesion between PS and the polymer surfaces is governed by VDW forces. Furthermore, according to the Hamaker model, VDW adhesion between a particle and a flat surface depends on the Hamaker constant and a contact radius, which should be approximated well by the Hamaker model.[37]

$${F}_{Hamaker} = \frac{AR}{6 {d}^{2}} \qquad ( 3 )$$

Since the values of the Hamaker constant for these five polymers are very close (˜8-9×10⁻²⁰ J), the VDW forces are determined largely by the contact radius.[38] Therefore, the similar VDW adhesion forces between bare PS and these polymer surfaces suggest that the small variation in surface roughness of these polymers (Table 3.1) didn't affect their contact radii.

TABLE 3.1
Surface roughness of the various polymer surfaces.

| Surface | PE | PS | PVAc | PVOH | PEO |
|---|---|---|---|---|---|
| Ra | 4.2 ± 0.8 | 2.4 ± 0.4 | 1.5 ± 0.3 | 1.6 ± 0.4 | 8.3 ± 2.2 |
| (nm) | | | | | |
| rms | 4.3 ± 0.8 | 2.8 ± 0.4 | 1.7 ± 0.3 | 1.9 ± 0.4 | 8.7 ± 2.4 |
| (nm) | | | | | |

In contrast, the adhesion forces for ChNF-coated PS were all higher than PS alone, and they varied with different polymer surfaces (FIG. 3.6). The marked increase in adhesion for ChNF-coated PS on PE and PS, apolar surfaces, is indicative of an increase in contact area for the ChNF-coated PS probes, which is consistent with the added roughness due to the ChNF coating observed in FIG. 3.5. PE, the most apolar in the series, shows the lowest adhesion force value, while PVAc, PVOH, and PEO with high Lewis basic components possess higher adhesion forces. Typically, the short-range interaction (<5 nm) includes dispersion (nonpolar, VDW force) and non-dispersion force (polar, acid-base interaction). Since the γ^{vW} of these polymer surfaces are not significantly different (Table 3.3), the VDW forces for ChNF are almost independent of polymer surface types. Therefore, the differences in adhesion forces suggest that Lewis acidic and basic components of the polymer surfaces play an important role in adhesion with ChNF.

Assuming van Oss and Good's Lifshitz-van der Waals acid-base theory for the solid (chitin surface, Ch)-solid (polymer surface, P) interface, the relationship of the adhesion force with the surface energy of the polymers can be expressed as:

$$\text{?} \text{?} \text{indicates text missing or illegible when filed} \qquad ( 4 )$$

where, F_{ad} is the experimentally determined adhesion force, and a, b and c are coefficients scaling the VDW and acidic-basic contributions, respectively. Since the VDW components of the five polymers (γ_{P}^{vW}) are similar, equation 4 can be simplified to:

F_{ad}∝A+b\sqrt{γ_{Ch}⁺γ_{P}⁻}+c\sqrt{γ_{Ch}⁻γ_{P}^{═}} (⁵)

where A is a constant representing VDW-driven adhesion. We fitted the adhesion force data to equation 5, which is shown as a plane in FIG. 3.7. Fitting all five polymers led to a correlation coefficient of r² ˜0.88, suggesting that the differences of total adhesion forces on varied surfaces can be explained by acid-base (h-bonding interactions) of the polymer surfaces. Further, the relative contributions of acidic and basic components are not too different, b/c=1.46. Carbonyl, hydroxyl and ether oxygens in the polymers that possess them act as the major electron donor components and are able to form hydrogen bonds with —OH, —NH and —NH₂ groups on the chitin structures. Since PEO has the largest γ⁻ value, indicative of its electron donors (hydrogen bond acceptors), and because chitin has protons that can serve as hydrogen bond donors, such as —OH, —NH— and —NH₂, we conclude that the acid-base interaction between PEO and chitin are hydrogen bonds. This is consistent with FTIR data presented above.

TABLE 3.2
Contact angles (°) of polymer surfaces with three testing liquids.

| Substrate | Water | glycerol | diiodomethane |
|---|---|---|---|
| PE | 105.2 ± 4.0 | 87.3 ± 2.1 | 52.8 ± 2.0 |
| PS | 101.1 ± 3.0 | 84.2 ± 2.0 | 33.6 ± 2.0 |
| PVAc | 60.7 ± 2.9 | 70.7 ± 3.0 | 37.8 ± 3.0 |
| PVOH | 46.2 ± 1.4 | 44.0 ± 1.3 | 40.4 ± 1.4 |
| PEO | 19.0 ± 4.0 | 46.8 ± 2.0 | 33.8 ± 2.5 |
| Chitin | 56.7 ± 1.4 | 46.7 ± 1.4 | 37.4 ± 2.0 |

TABLE 3.3
Surface tension components (mJ/m²) of various polymer surfaces.

| Surface | γ^{vW} | γ⁺ | γ⁻ | γ |
|---|---|---|---|---|
| PE | 33 | 0 | 0 | 33.0 |
| PS | 43 | 0.2 | 0.4 | 43.2 |
| PVAc | 41 | 0.6 | 16.7 | 46.8 |
| PVOH | 39 | 1.1 | 28.8 | 50.4 |
| PEO | 43 | 0 | 64.0 | 43.0 |
| Chitin | 41 | 1.3 | 17.1 | 50.4 |

DSC Analysis: The melting temperature (Tₘ), enthalpy of fusion and crystallinity (X_{c}) of neat PEO and ChNF/PEO composite films were measured using DSC. The degree of crystallinity of these samples was calculated according to equation 6:[39]

$${X}_{c} = \frac{Δ {H}_{i}}{{f}_{i} Δ {H}_{i}^{m}} 100 \% \qquad ( 6 )$$

where, ΔHᵢ is the enthalpy of fusion of the prepared PEO samples, obtained from DSC measurements, ƒᵢ is the mass fraction of PEO in the composite, and ΔHᵢ^{m} is the enthalpy of fusion of 100% crystalline PEO, which is 205 J/g.[39] The neat PEO has a melting temperature of 67.3° C. and crystallinity of 86.3% (Table 4), and the crystallinity and melting temperature of PEO decreased with increasing ChNF loading. We reason that the dispersion of ChNF in the PEO matrix and strong interactions between ChNF and PEO hindered chain diffusion and folding during PEO crystallization, resulting in the low crystallinity for composite samples. The neat PEO has a T_{g} of −56.2° C. while the T_{g} of 5%, 10% and 15% ChNF/PEO composites are −49.2, −48.7 and −48.4° C., respectively. The increase in glass transition temperature and decrease in crystallinity with ChNF content for the composites is consistent with the strong adhesion between ChNF and PEO that likely restricts PEO chain mobility.

TABLE 3
Melting temperature and crystallinities
of neat PEO and PEO/ChNF composite.

| | Tₘ | ΔH | X_{c} |
|---|---|---|---|
| Sample | (° C.) | (J/g) | (%) |
| Neat PEO | 67.3 | 177.0 | 86.3 |
| 5% Chitin/PEO | 65.8 | 165.5 | 85.0 |
| 10% Chitin/PEO | 64.0 | 152.3 | 82.6 |
| 15% Chitin/PEO | 62.7 | 137.4 | 78.9 |
| 20% Chitin/PEO | 62.0 | 122.3 | 74.6 |

Conclusions

In this study, ChNF/PEO nanocomposites were successfully fabricated by an aqueous solution casting method and the structure-property relationships of the nanocomposites were investigated. ChNFs were dispersed well and formed interconnected network structures in the PEO matrix. Compared to neat PEO, the tensile strength and elastic modulus of the nanocomposites increased ˜3 times at 20% ChNF loading. In addition to ChNFs' high mechanical properties, the strong interactions between ChNF and PEO, and the ChNF network structure played important roles in efficient stress transfer from matrix to fiber and from fiber to fiber. The ATR-FTIR and AFM colloidal probe adhesion measurements support the conclusion that ChNF has strong h-bond and VDW-driven adhesion with itself and with PEO.

The crystallinities of PEO in composites are lower than that of neat PEO, which may be attributed to dispersion of ChNF in the PEO matrix and strong interactions between ChNF and PEO that restrict the chain mobility during PEO crystallization. Processing ChNFs in suspensions with slight acidity and water-soluble polymers appears to support the formation of highly interconnected networks that makes ChNF-polymer composites excellent candidates for reinforced, light-weight, renewable materials.

### REFERENCES

[1] T. Chatterjee, K. Yurekli, V. G. Hadjiev and R. Krishnamoorti, Single-walled carbon nanotube dispersions in poly(ethylene oxide), Advanced Functional Materials, 15 (2005) 1832-1838.
[2] L. A. Goettler, K. Y. Lee and H. Thakkar, Layered silicate reinforced polymer nanocomposites: Development and applications, Polymer Reviews, 47 (2007) 291-317.
[3] T. Chatterjee, C. A. Mitchell, V. G. Hadjiev and R. Krishnamoorti, Hierarchical polymer-nanotube composites, Advanced Materials, 19 (2007) 3850-+.
[4] S. Y. Fu, X. Q. Feng, B. Lauke and Y. W. Mai, Effects of particle size, particle/matrix interface adhesion and particle loading on mechanical properties of particulate-polymer composites, Composites Part B-Engineering, 39 (2008) 933-961.
[5] B. Chen, J. R. G. Evans, H. C. Greenwell, P. Boulet, P. V. Coveney, A. A. Bowden and A. Whiting, A critical appraisal of polymer-clay nanocomposites, Chemical Society Reviews, 37 (2008) 568-594.
[6] S. Bredeau, S. Peeterbroeck, D. Bonduel, M. Alexandre and P. Dubois, From carbon nanotube coatings to high-performance polymer nanocomposites, Polymer International, 57 (2008) 547-553.
[7] D. Klemm, F. Kramer, S. Moritz, T. Lindstrom, M. Ankerfors, D. Gray and A. Dorris, Nanocelluloses: A New Family of Nature-Based Materials, Angewandte Chemie-International Edition, 50 (2011) 5438-5466.
[8] M. Rinaudo, Chitin and chitosan: Properties and applications, Progress in Polymer Science, 31 (2006) 603-632.
[9] C. K. S. Pillai, W. Paul and C. P. Sharma, Chitin and chitosan polymers: Chemistry, solubility and fiber formation, Progress in Polymer Science, 34 (2009) 641-678.
[10] J.-B. Zeng, Y.-S. He, S.-L. Li and Y.-Z. Wang, Chitin Whiskers: An Overview, Biomacromolecules, 13 (2012) 1-11.
[11] J. Wu, K. Zhang, N. Girouard and J. C. Meredith, Facile Route to Produce Chitin Nanofibers as Precursors for Flexible and Transparent Gas Barrier Materials, Biomacromolecules, 15 (2014) 4614-4620.
[12] J. Wu and J. C. Meredith, Assembly of Chitin Nanofibers into Porous Biomimetic Structures via Freeze Drying, Acs Macro Letters, 3 (2014) 185-190.
[13] M. Trollsås and J. L. Hedrick, Dendrimer-like Star Polymers, Journal of the American Chemical Society, 120 (1998) 4644-4651.
[14] A. C. Albertsson and I. K. Varma, Recent developments in ring opening polymerization of lactones for biomedical applications, Biomacromolecules, 4 (2003) 1466-1486.
[15] K. Gopalan Nair and A. Dufresne, Crab shell chitin whisker reinforced natural rubber nanocomposites. 1. Processing and swelling behavior, Biomacromolecules, 4 (2003) 657-665.
[16] S. Ifuku, M. Nogi, K. Abe, M. Yoshioka, M. Morimoto, H. Saimoto and H. Yano, Preparation of chitin nanofibers with a uniform width as alpha-chitin from crab shells, Biomacromolecules, 10 (2009) 1584-1588.
[17] J. C. Meredith, A. Karim and E. J. Amis, High-throughput measurement of polymer blend phase behavior, Macromolecules, 33 (2000) 5760-5762.
[18] B. J. R. Thio, J. H. Lee and J. C. Meredith, Characterization of Ragweed Pollen Adhesion to Polyamides and Polystyrene Using Atomic Force Microscopy, Environmental Science & Technology, 43 (2009) 4308-4313.
[19] J. L. Hutter and J. Bechhoefer, Calibration of Atomic-Force Microscope Tips, Rev. Sci. Instrum., 64 (1993) 1868-1873.
[20] R. J. Good and C. J. van Oss, Modern Approach of Wettability: Theory and Applications, Plenum Press, New York, 1991.
[21] H. J. Busscher and J. Arends, Determination of the Surface Forces Gamma-S-D and Gamma-S-P from Contact-Angle Measurements on Polymers and Dental Enamel, Journal of Colloid and Interface Science, 81 (1981) 75-79.
[22] K. X. Ma, T. S. Chung and R. J. Good, Surface energy of thermotropic liquid crystalline polyesters and polyesteramide, Journal of Polymer Science Part B—Polymer Physics, 36 (1998).
[23] J. L. Sormana and J. C. Meredith, High-throughput discovery of structure-mechanical property relationships for segmented poly(urethane-urea)s, Macromolecules, 37 (2004) 2186-2195.
[24] J. L. Sormana, S. Chattopadhyay and J. C. Meredith, High-throughput mechanical characterization of free-standing polymer films, Review of Scientific Instruments, 76 (2005).
[25] M. Samir, F. Alloin, M. Paillet and A. Dufresne, Tangling effect in fibrillated cellulose reinforced nanocomposites, Macromolecules, 37 (2004) 4313-4316.
[26] M. O. Seydibeyoglu and K. Oksman, Novel nanocomposites based on polyurethane and micro fibrillated cellulose, Composites Science and Technology, 68 (2008) 908-914.
[27] A. Iwatake, M. Nogi and H. Yano, Cellulose nanofiber-reinforced polylactic acid, Composites Science and Technology, 68 (2008) 2103-2106.
[28] F. Dalmas, J.-Y. Cavaille, C. Gauthier, L. Chazeau and R. Dendievel, Viscoelastic behavior and electrical properties of flexible nanofiber filled polymer nanocomposites. Influence of processing conditions, Composites Science and Technology, 67 (2007) 829-839.
[29] Q. Cheng, S. Wang and T. G. Rials, Poly(vinyl alcohol) nanocomposites reinforced with cellulose fibrils isolated by high intensity ultrasonication, Composites Part a—Applied Science and Manufacturing, 40 (2009) 218-224.
[30] G. Chinga-Carrasco, Cellulose fibres, nanofibrils and microfibrils: The morphological sequence of MFC components from a plant physiology and fibre technology point of view, Nanoscale Research Letters, 6 (2011).
[31] K.-Y. Lee, T. Tammelin, K. Schulfter, H. Kiiskinen, J. Samela and A. Bismarck, High Performance Cellulose Nanocomposites: Comparing the Reinforcing Ability of Bacterial Cellulose and Nanofibrillated Cellulose, Acs Applied Materials & Interfaces, 4 (2012) 4078-4086.
[32] X. Xu, F. Liu, L. Jiang, J. Y. Zhu, D. Haagenson and D. P. Wiesenborn, Cellulose Nanocrystals vs. Cellulose Nanofibrils: A Comparative Study on Their Microstructures and Effects as Polymer Reinforcing Agents, Acs Applied Materials & Interfaces, 5 (2013) 2999-3009.
[33] J. Jin, P. Hassanzadeh, G. Perotto, W. Sun, M. A. Brenckle, D. Kaplan, F. G. Omenetto and M. Rolandi, A Biomimetic Composite from Solution Self-Assembly of Chitin Nanofibers in a Silk Fibroin Matrix, Advanced Materials, 25 (2013) 4482-4487.
[34] E. E. Brown and M.-P. G. Laborie, Bloengineering bacterial cellulose/poly(ethylene oxide) nanocomposites, Biomacromolecules, 8 (2007) 3074-3081.
[35] J. Emsley, Very Strong Hydrogen-Bonding, Chemical Society Reviews, 9 (1980) 91-124.
[36] J. W. Larson and T. B. McMahon, Gas-phase bihalide and pseudobihalide ions. An ion cyclotron resonance determination of hydrogen bond energies in XHY-species (X, Y═F, Cl, Br, CN), Inorganic Chemistry, 23 (1984) 2029-2033.
[37] J. Israelachvili, Intermolecular and Surface Forces, Acadamic Press, London, 1992.
[38] H. Lin, I. Gomez and J. C. Meredith, Pollenkitt Wetting Mechanism Enables Species-Specific Tunable Pollen Adhesion, Langmuir, 29 (2013) 3012-3023.
[39] I. T. Kim, J. H. Lee, M. L. Shofner, K. Jacob and R. Tannenbaum, Crystallization kinetics and anisotropic properties of polyethylene oxide/magnetic carbon nanotubes composite films, Polymer, 53 (2012) 2402-2411.

### Example 4

Foam stabilization by particles has recently attracted intense interests from the soft and porous materials communities due to opportunities for a wide range of applications. However, most particles employed in this fields are derived from non-renewable resources and possess low aspect ratio, such as spherical shape. Here, we report a new kind of aqueous foam stabilized by renewable high-aspect-ratio chitin nanofibers (ChNFs) and the produced liquid foam exhibited strong hindrance on drainage, coalescence and disproportionation. The results showed that ChNFs themselves were not effective stabilizers of the air-water interface but short-chain amphiphile treated ChNFs displayed excellent foaming ability. The effects of CNF and valeric acid concentration on surface tension, foaming ability and stability of the aqueous phase were elucidated. Quartz Crystal Microbalance (QCM) data illustrated that there is a strong affinity between CNF and amphiphile (valeric acid). Interestingly, the surface tension of aqueous dispersions was largely decreased with the combined addition of CNF and valeric acid in water. SEM images confirmed that CNFs were absorbed, intertwined and formed particle layers at the air-water interface, which played significant roles in stabilizing air bubbles. Due to chitin's unique inherent properties, such as renewability, abundance, biodegradability and high stiffness, we expect that CNF-based aqueous foams should be useful for many applications.

Foams are useful as intermediates and end-products for a variety of fields, such as food, cosmetics, oil-recovery, flotation, insulation, and materials for transportation and biomedical engineering [1-13]. However, aqueous foams are not thermodynamically stable because of their large air-water interfacial free energy so that they show quite short lifetimes. Surfactants and biomolecules are able to lower interfacial free energy but they still cannot strongly hinder film drainage, coalescence or disproportionation of liquid foams [14-20]. Recently, the foam stabilization by particles (Pickering foams) has attracted much attention from researchers because of the remarkable stability of the resultant foams. The detachment energy of particles (ΔG_{particle}) from the air-water interface

ΔG_{particle}=πR²γ_{αβ}(1−|cos θ|)² Equation 4.1

is several orders of magnitude larger than thermal energy (kT, k is the Boltzmann's constant and T is the temperature) in marked contrast to few kT of interfacial desorption energy for surfactants. Thus the formed particle layer at the interface behaves as an interfacial armor to effectively resist bubble coalescence or disproportionation. In equation 4.1, R is the particle radius, γ_{αβ} is the interfacial tension and θ is the wetting angle of the particle at the air-water interface [21-31]. Currently, there are tremendous needs for renewable materials in society to mitigate energy depletion of fossil fuel, and this drives much research on developing advanced materials from renewable resources. Despite a variety of particles that have already been demonstrated as effective stabilizers of air-water interface over the last decade, including metal oxide (silica, alumina etc.), metal (titanium, gold etc.) and polymers (PVDF, PTFE, and PS etc.), Pickering foams produced from renewable materials are seldom reported [32-46].

Chitin is the second most abundant macromolecule in nature, existing in the exoskeleton of arthropods or the cell walls of fungi and yeast. Chitin is poly (β-(1-4)-N-acetyl-D-glucosamine) having amino, amide and hydroxyl functional groups in polymer chains. Chitin exhibits many excellent properties, such as renewability, biodegradability, and biocompatibility, strong affinity to proteins and high stiffness. However, even though having these inherent benefits, the applications of chitin-based materials are still quite limited mainly due to its strong molecular interactions [47-50]. Up to now, the stabilization properties of chitin at air-water interface have not been reported in the literature before. Recently, our group successfully extracted chitin nanofibers (CNFs) with diameters of ˜20 nm from crab shells without employing chitin dissolution. In this Example, we aim to investigate the interfacial and foaming properties of CNFs in an aqueous phase. Meanwhile, we aim to develop aqueous foams stabilized by renewable CNFs. Particles with low aspect ratio such as spheres are often used as foam stabilizers. Previous research indicated that particles with high aspect ratio were more efficient to prevent foam destabilization than spheres [22, 34, 51]. Thus, it is potential to produce highly stable CNF-based foams because of its relatively high aspect ratio.

### Experimental Method

### Materials

Dried crab shell flakes were purchased from TCI America. Deionized water (18.2 MCI cm) was prepared in a Barnstead Easypure RoDi purification system. Hydrochloric acid, sodium hydroxide, acetone and ethanol were purchased from EMD Chemical Inc. Propionic acid, valeric acid, enanthic acid, caprylic acid and 16-hexadecanoic acid (Sigma-Aldrich, CO., St. Louis, Mo. USA) were used as received without further purification. Sulfuric acid (97 wt %, BDH Chemicals Ltd.) and hydrogen peroxide (30 wt. %, BDH Chemicals Ltd) were used for treating silicon wafer.

### Chitin Purification and Fibrillation

Dried crab shell flakes were processed to obtain purified chitin [49, 52]. Ground crab shells were refluxed in 5 wt % sodium hydroxide in DI water for 6 h to remove protein. The suspension was filtered and rinsed with DI water until the pH was 7. Next, the filtered solids were treated with 7% hydrochloric acid for 6 h at room temperature to remove minerals. After filtration and washing with DI water, the treated sample was refluxed in a 5% NaOH solution for 2 days to remove residual proteins and the other residues were eliminated by acetone and ethanol extraction. The purified chitin was dispersed in distilled water under an acidic condition and then this mixture was passed through a high-pressure homogenizer (Bee International Inc., MA USA) to generate CNFs (aqueous medium pH is ˜4.1). A shorter homogenizing duration was used for preparing CNFs in this Example.

### Aqueous Foam Preparation and Characterization

A CNF/water dispersion was obtained from the high pressure homogenization process, and its pH value was adjusted from ˜4 to ˜7 using a diluted sodium hydroxide solution. The CNF dispersion at each pH was frothed using a rotor-stator homogenizer (IKA UltraTurrax T10) at 20000 rpm for 15 minutes. For CNF/carboxylic acid/water foaming, a small amount of carboxylic acid (propionic acid, valeric acid, enanthic acid or caprylic acid) were added to a CNF/water dispersion. The resulting mixture was agitated using the rotor-stator homogenizer at 8000 rpm for 20 minutes, and subsequently frothed at 20000 rpm for 15 minutes.

After frothing, digital images of chitin samples were immediately taken. A small amount of CNF liquid foam was placed on the top of a microscope glass slide, and observed using the transmission mode of an optical microscope (Olympus BX51, Olympus America, Inc., Center Valley, Pa. USA) equipped with a digital camera system. A small amount of CNF liquid foam was dropped on a Piranha solution cleaned silicon wafer (Piranha solution: 75% H₂SO₄+25% H₂O_{2>} treated at 80° C. for 1 hour). The droplet was immediately dried with a dry nitrogen jet, and then was coated with a thin layer of gold/palladium (Hummer IV Sputtering System). SEM images were taken using a Zeiss Ultra60 field emission scanning electron microscope (accelerating voltage: 5 kV). The zeta potential of CNF/water dispersion was measured by Zetasizer Nano S90. Three measurements (each measurement was averaged over 20 runs) was taken and averaged. The surface tension of CNF dispersion with or without carboxylic acids were measured by a surface tensiometer (Rame-Hart Model 250 Goniometer) based on pendent drop method, and was determined using drop shape analysis of liquid droplet. CNFs/water dispersion was blade-casted on Piranha solution cleaned silicon wafer. The casted film was firstly dried in fume hood at room temperature and further dried at 50° C. in convection oven. The contact angle of CNF film was measured by using a video contact angle system (AST products 2500XE, Billerica, Mass.). The foaming ability of CNF dispersion was accessed by measuring the ratio of foam volume immediately after frothing to the initial liquid volume. The foam stability was evaluated by monitoring this ratio over time at room temperature.

### Quartz Crystal Microbalance (QCM) Measurement

The QCM-D has been widely used to evaluate surface properties including adsorption rate, adsorbed mass and viscoelasticity of adsorbed layers for many years. Changes in the resonant frequency of coated QCM sensors can be measured by switching on and off an applied voltage. The shift in the resonant frequency due to bulk adsorption is employed to calculate the areal adsorption by means of the Sauerbrey equation,

$$Δ m = - c \frac{Δ f}{n} \qquad Equation 4.2$$

Where Δm is the mass change per area on the crystal surface, Δƒ is the resonant frequency change, n is the overtone number (n=1, 3, 5, 7, etc.) and c is a characteristic constant related to the sensitivity of the resonator to changes in mass [53, 54]. In this Example, QCM-D was used to characterize the adsorption behavior of carboxylic acid on the surface of CNFs at ambient temperature.

Quartz sensors coated with gold were used in QCM-D experiments. These sensors were firstly functionalized with a self-assembled monolayer of 16-hexadecanoic acid. Briefly, gold sensors were first cleaned by UV ozone (UV/Ozone ProCleaner, Bioforce Nanosciences, Inc., IA, USA) for 10 minutes, followed by a 5 min incubation in 5:1:1 H₂O:NH₃:H₂O₂ at 75° C. The sensors were then rinsed with DI water, and dried with N2. Sensors were then immersed in a 1 mM ethanolic solution of 16-hexadecanoic acid, adjusted to pH-2 with concentrated HC1. After 48 hours, the self-assembly was terminated by rinsing the substrate in 200 proof ethanol, 10 min sonication in fresh solvent, and then drying under N₂. Following COOH-SAM formation, the CNFs were spin-coated onto the acid treated'sensor (Aqueous CNF dispersion: pH ˜4.9, 5000 rpm). These nanochitin-sensors were used for all QCM-D measurements (Q-Sense El system, Biolin Scientific, Inc., Vastra Frolunda, Sweden). QCM-D was used to measure the in-situ interaction with a solution flow rate of 0.1 ml/min at 22° C. A single measurement consisted of four steps: (1) baseline the sensor in dry air; (2) baseline sensor in DI water at pH ˜4.9, allowing the chitin film to fully hydrate; (3) exposure to carboxylic acid solution; (4) exposure to DI water with medium pH ˜4.9. For each step, flow continued until the resonance frequency change plateaued, which indicated that the sensor surface had effectively reached equilibrium with the solution. The 1st, 3rd, 5th, 7th, 9th, 11th, and 13th harmonics were measured simultaneously during all QCM-D experiments. Of these harmonics, the 5th harmonic was selected for analyses.

### Results and Discussion

### Foaming Ability of CNF Dispersion

FIG. 4.2A shows the morphology of the fibrillated CNFs produced from the purified chitin by a high pressure homogenization process, and the resulting CNFs have diameters of around 20 nm, and lengths ranging from hundreds of nanometers to several micrometers. The CNF dispersion with medium pH of ˜4.1 exhibits high optical transparency and CNF has a zeta potential of more than +50 my that resulted from the protonated —NH₃+groups. When the dispersion was frothed by a rotor-stator homogenizer, no stable foam was generated (FIGS. 4.3A-D). A previous study showed that electrostatic repulsion between highly charged particles can induce an adsorption barrier for their attachment at the air/water interface, and when their surface charges were lowered, these particles were able to absorb at the interface and stabilize air bubbles [31, 43]. The surface charge of CNF decreased when increasing medium pH from ˜4 to ˜7 and its pKa is around 6.5 [47,48]. When pH was increased from 4.1 to 5.0 to 5.8 until 7, the CNF dispersion still could not achieve stable foams even using vigorous mechanical frothing (FIG. 4.3C and 5.3D). Wetting properties of particles significantly influence their foaming ability and particles with a contact angle of 90° have highest detachment energy from air/water interface according to equation 5.1 [18, 27, 28]. The contact angle of CNF is 57°, so its detachment energy from the air-water interface should be much greater than thermal energy. However, no stable foams could be produced using solely CNF particles. Since CNF has much higher aspect ratio than that of spherical particle, the equation 5.1 does not fit CNF well and also CNF may show different contact angle at air-water interface in dispersion in comparison to bulk contact angle measurement. The hydrophobicity of CNF at the interface is possibly still not high enough to stabilize air bubbles. Therefore, the foaming ability of CNFs may possibly be improved by increasing their hydrophobicity.

### Foaming Ability and Foam Stability of CNF/Valeric Acid Dispersion

One approach to hydrophobize CNF is to utilize in-situ physical adsorption of an amphiphile on its surface [32-34]. One end of an anionic amphiphile has a hydrophobic hydrocarbon tail, and the other end has negative charge under acidic condition, which can interact with the protonated —NH₃⁺ groups of CNF via electrostatic attraction. Consequently, the hydrophobic tail would be exposed to surrounding aqueous environment, as shown in FIG. 4.4. On the basis of this principle, valeric acid should be a great candidate for CNF hydrophobization because it is a short-chain amphiphile that shows negative charge at pH>pKa=4.84) and has a high critical micelle concentration in water [32, 33].

Different amounts of valeric acid were added to the 0.1% CNF dispersion to evaluate the effect of acid concentration on CNF foaming. 1 mmol/l valeric acid addition still could not make bubble stable (FIG. 4.5 D). However, stable foams were obtained when the amount of added valeric acid was 5 mmol/l and 25 mmol/l (FIGS. 4.5 E and 4.5F). When aerating different concentrated valeric acid aqueous solutions (1 mmol/l, 5 mmol/l, 25 mmol/l and 50 mmol/l), bubbles were generated during frothing, but once frothing was terminated, the bubbles collapsed in a very short time (FIG. 4.5 A-C). The stabilized bubble size mainly ranged from 10 μm to 100 μm, as illustrated in FIG. 4.6. SEM images of one droplet of CNF/valeric acid foam showed that there were bubble clusters and single dispersed bubbles in the substrate, as shown in FIGS. 4.7A and 4.7B.

When enlarging bubble edge and center regions, FIGS. 4.7 C and 4.7D clearly showed that these bubbles were covered with the intertwined CNF network layers, which indicated that the CNFs were absorbed to the air-water interface. FIGS. 4.5G-I showed the evolution of these two foams over time at room temperature. Film drainage occurred within 2 minutes after frothing. The bubble size increased markedly 24 hours after frothing.

The different amounts of valeric acids were also added to 1% CNF dispersion. The results showed that only acid concentrations of above 5 mmol/l can produce stable aqueous foams, which is similar to 0.1% CNF (FIGS. 4.8A-C). However, the foams produced from 1% CNF exhibited much higher foam stability compared with the 0.1% CNF dispersion. As shown in FIGS. 4.8D-F, no drainage was observed at 24 hours after frothing. The rate of bubble size increment was dramatically decreased. Foam stability was quantitatively evaluated by measuring the ratio of frothed foam volume to initial dispersion volume as a function of time. Around 40% air was initially incorporated in the dispersion and the aerated foams then remained a constant volume over 24 hours. FIG. 4.9 shows that bubble size mainly ranged from 10 μm to 100 μm. Bubble clusters and single bubbles were also observed for 1% CNF (FIGS. 4.10A-C).

SEM images revealed that the CNFs were absorbed at the air-water interface in terms of the layers of CNF formation on the bubble surface (FIGS. 4.10D-F). Previously, researchers showed that chitin nanocrystals easily form network structures and the gel strength increased with increased particle concentration [55]. The 0.1% CNF dispersion can flow easily under gravity but the 1% CNF showed very strong gelling behavior (FIGS. 4.11A-B). The high foam stability of 1% CNF dispersion may result from two reasons. One is that the relatively strong CNF networks among bubbles halted or slowed down the film drainage and bubble coalescence, and led to reduced gas diffusion between small and large bubbles, resulting in slow disproportionation [28, 56]. The other possible reason is that the CNF layers at the air-water interface for 1% CNF may be much thicker than those of 0.1% CNF, so that the resulting foams were more effective to prevent bubble coalescence and disproportionation.

### Investigation of the Role of Valeric Acid in CNF Dispersion

We hypothesize that the role of valeric acids in CNF dispersion is to hydrophobize CNF by absorbing on the surface of CNFs via electrostatic attraction and subsequently exposing their hydrophobic tails to water. The adsorption of valeric acids on CNF surface was investigated using QCM-D. FIG. 4.12 showed the frequency change of the CNF coated gold sensor as a function of time. After introducing 5 mmol/l valeric acid solution (pH 4.9) into QCM chamber, the frequency was abruptly shifted. The frequency change is an indication of fast mass uptake by the resonators due to the valeric acid absorption. When the frequency reached near-plateau region, water was flowed to remove any excess of loosely bound valeric acids. After rinsing, there was still absorbed valeric acid on the sensor. When injecting 25 mmol/l valeric acid, the QCM frequency shift followed the same trend with the lower concentrated one, but more valeric acid remained on the chitin surface. QCM data demonstrated the adsorption of valeric acid on the CNF surface.

TABLE 4.1
Surface tensions of valeric acid, CNF and
CNF/valeric acid aqueous dispersions.

| | Surface Tension | Stable Foam |
|---|---|---|
| Sample | (mN/m) | (Yes or No) |
| DI Water | 72.38 | No |
| 0.1% CNF/water | 72.44 | No |
| 0.5% CNF/water | 68.41 | No |
| 1% CNF/water | 68.14 | No |
| 1 mmol/l valeric acid | 71.7 | No |
| 5 mmol/l valeric acid | 70.35 | No |
| 25 mmol/l valeric acid | 63.59 | No |
| 50 mmol/l valeric acid | 57.18 | No |
| 0.1% CNF/0.5 mmol/l valeric acid | 71.5 | No |
| 0.1% CNF/1 mmol/l valeric acid | 71.14 | No |
| 0.1% CNF/5 mmol/l valeric acid | 70.6 | Yes |
| 0.1% CNF/25 mmol/l valeric acid | 61.37 | Yes |
| 1% CNF/1 mmol/l valeric acid | 67.79 | No |
| 1% CNF/5 mmol/l valeric acid | 56.82 | Yes |
| 1% CNF/25 mmol/l valeric acid | 55.44 | Yes |

In addition to SEM images that proved the attachment of CNFs at the air-water interface, the surface tensions of different concentrated valeric acid, CNF and CNF/valeric acid dispersions were also measured to illustrate the adsorption of modified CNFs to the interface. As shown in Table 4.1, valeric acid is able to lower the surface tension, especially for higher concentrated acids (63.59 mN/m for 25 mmol/l and 57.18 mN/m for 50 mmol/l). The higher concentrated CNF (0.5 and 1 wt. %) can slightly reduce the surface tensions of aqueous dispersion. Interestingly, the surface tension of 1% CNF dispersion was decreased from 68.14 to 56.82 mN/m with addition of relatively small amount of valeric acids (5 mmol/l). It is worth mentioning that a fraction of the added valeric acids would not absorb on the CNF surface, and preferred absorbing at the air-water interface, which contributed to the part of the surface tension reduction. The amount of reduction resulted from free valeric acids and CNFs were not estimated here, but the 5 mmol/l valeric acid or 1% CNF can only slightly decrease the surface tension (70.35 mN/m for 5 mmol/l valeric acid and 68.14 mN/m for 1% CNF). Therefore, the relatively abrupt decrease of the surface tension was mainly attributed to the attachment of the valeric acid treated CNFs to the air-water interface.

TABLE 4.2
Chemical structures and pKa values of carboxylic acids [35]

| Acid | Chemical formula | pKa |
|---|---|---|
| Propionic acid | CH3CH2COOH | 4.86 |
| Valeric acid | CH₃(CH₂)₃COOH | 4.84 |
| Enanthic acid | CH₃(CH₂)₅COOH | 4.89 |
| Caprylic acid | CH₃(CH₂)₆COOH | 4.89 |

In addition to valeric acid, propionic acid, enanthic acid and caprylic acid are also short-chain amphiphiles and possess similar pKa values (Table 4.2), but have different lengths of hydrocarbon tails. The effect of these three additional acids on the foaming ability of the CNF dispersion was also investigated. Different amounts of propionic acid ranging from 1 mmol/l to 25 mmol/l were added to the CNF dispersion and then the corresponding mixtures were vigorously aerated by a rotor-stator homogenizer, but no stable foams were produced for each condition (FIG. 4.13A). In contrast, the addition of only 0.5 mmol/l enanthic acid or caprylic acid were able to stabilize air bubbles (FIG. 4.13B and 4.13C). Previous studies indicated that the carboxylic acids with shorter hydrocarbon tails had higher critical concentration for particle foaming [32, 33, 36]. The propionic acid has a very short tail so that its critical concentration for foaming is higher compared to valeric acid, suggesting that over 25 mmol/l propionic acid may enable CNFs to stabilize air bubbles, whereas enanthic acid and caprylic acid have relatively long hydrocarbon tails and can hydrophobize CNF to the required extent by using smaller amounts of acid.

### Conclusions

We designed and developed the first aqueous foams stabilized by renewable high-aspect-ratio CNFs. The produced wet foams exhibited excellent stabilization against film drainage, coalescence and disproportionation, which were attributed to the formation of CNF layers at the air-water interface and network structures in the aqueous phase. The fibrillated CNFs did not show foaming ability even though the medium pH was tuned from ˜4 to 18 7. However, the highly stable aqueous foams can be achieved when CNFs were modified via the physical adsorption of valeric acids on their surface. We found that there was critical concentration of valeric acids for CNF foaming and the concentration of CNF had a great impact on the lifetime of the prepared liquid foams, low concentrated CNF showing poor stability. The valeric acids had strong affinity on the CNF surface and the modified CNFs were able to absorb at the air-water interface and reduce the surface tension of aqueous dispersion. In terms of the excellent inherent properties of chitin, such as renewability, abundance, biodegradable, antibacterial activity and high stiffness, the resulting chitin-based aqueous foams should be attractive for many applications, such as packaging, insulation and biomedical engineering.

### REFERENCES

[1]. Murray, B. S.; Ettelaie, R. Foam Stability: Proteins and Nanoparticles. Current Opinion in Colloid and Interface Science 2004, 9, 314-320.
[2]. Dickinson, E. Food Emulsions and Foams: Stabilization by Particles. Current Opinion in Colloid and Interface Science 2010, 15, 40-49.
[3]. Pei, Z. J; Schmidt, K. A. Ice Cream: Foam Formation and Stabilization—A Review. Food Reviews International 2010, 26, 122-137.
[4]. Binks, B. P.; Murakami, R. Phase Inversion of Particle-stabilized Materials from Foams to Dry Water. Nature Materials 2006, 5, 865-869.
[5]. Farajzadeh, R.; Andrianov, A.; Krastev, R.; Hirasaki, G. J.; Rossen, W. R. Foam-oil Interaction in Porous Media: Implications for Foam assisted Enhanced Oil Recovery. Advanced in Colloid and Interface Science 2012, 183, 1-13.
[6]. Lee, J.; Nikolov, A.; Wasan, D. Stability of Aqueous Foams in the Presence of Oil: On the Importance of Dispersed vs Solubilized Oil. Industrial and Engineering Chemistry Research 2013, 52, 66-72.
[7]. Shibata, J.; Fuerstenau, D. W. Flocculation and Flotation Characteristics of Fine Hematite with Sodium Oleate. International Journal of Mineral Processing 2003, 72, 25-32.
[8]. Clyne, T. W.; Golosnoy, I. O.; Tan, J. C; Markaki, A. E. Porous Materials for Thermal Management under Extreme Conditions. Philosophical Transactions of the Royal Society A 2006, 364, 125-146.
[9]. Banhart, J. Metal Foams: Production and Stability. Advanced Engineering Materials 2006, 8, 781-794.
[10]. Studart, A.; Nelson, A.; Iwanovsky, B.; Kotyrba, M.; Ktindig, A. A.; Dalla Torre, F. H.; Gonzenbach, U. T.; Gauckler, L. J.; Loffler, J. F. Metallic Foams from Nanoparticle-stabilized Wet Foams and Emulsions. Journal of Materials Chemistry 2012, 22, 820-823.
[11]. Dinsmore. A. D.; Hsu, M. F.; Nikolaides, M. G.; Marquez, M.; Bausch. A. R.; Weitz, D. A. Colloidosomes: Selectively Permeable Capsules Composed of Colloidal Particles. Science 2002, 298, 1006-1009.
[12]. Lindner, J. R. Microbubbles in Medical Imaging: Current Applications and Future Directions. Nature 2004, 3, 527-532.
[13]. Mohamedi, G.; Azmin, M.; Pastoriza-Santos, I.; Huang, V.; Perez-Juste, J.; Liz-Marzan, L.; Edirisinghe, M.; Stride, E. Effects of Gold Nanoparticles on the Stability of Microbubbles. Langmuir 2012, 28, 13808-13815.
[14]. Pugh, R. J. Foaming, Foam Films, Antifoaming and Defoaming. Advances in Colloid and Interface Science 1996, 64, 67-142.
[15]. Binks, B. P. Particles as Surfactants-Similarities and Differences. Current Opinion in Colloid and Interface Science 2002, 7, 21-41.
[16]. Kaptay, G. Interfacial Criteria for Stabilization of Liquid Foams by Solid Particles. Colloids and Surfaces A: Physicochemical and Engineering Aspects 2004, 230, 67-80.
[17]. Saint-Jalmes, A. Physical Chemistry in Foam Drainage and Coarsening. Soft Matter 2006, 2, 836-849.
[18]. Studart, A. R.; Gonzenbach, U. T.; Tervoort, E.; Gauckler, L. J. Processing Routes to Macroporous Ceramics: A Review. Journal of American Ceramic Society 2006, 89, 1771-1789.
[19]. Fameau, A; Saint-Jalmes, A.; Cousin, F.; Houssou, B. H.; Novales, B.; Navailles, L. Nallet, F.; Gaillard, C; Boue, F.; Douliez, J. Smart Foams: Switching Reversibly between Ultrastable and Unstable Foams. Angewandte Chemie International Edition 2011, 123, 8414-8419.
[20]. Carl, A.; Klitzing, R. Smart Foams: New Perspectives towards Responsive Composite Materials. Angewandte Chemie International Edition 2011, 50, 11290-11292.
[21]. Du, Z.; Bilbao-Montoya, M. P.; Binks, B. P.; Dickinson, E.; Ettelaie, R.; Murray, B. S. Outstanding Stability of Particle-Stabilized Bubbles. Langmuir 2003, 19, 3106-3108.
[22]. Alargova, R. G.; Warhadpande, D. S.; Paunov, V. N.; Velev, O. D. Foam Superstabilization by Polymer Microrods. Langmuir 2004, 20, 10371-10374.
[23]. Dickinson, E.; Ettelaie, R.; Kostakis, T.; Murray, B. S. Factors Controlling the Formation and Stability of Air Bubbles Stabilized by Partially Hydrophobic Silica Nanoparticles. Langmuir 2004, 20, 8517-8525.
[24]. Binks, B. P.; Horozov, T. S. Aqueous Foams Stabilized Solely by Silica Nanoparticles. Angewandte Chemie International Edition 2005, 44, 3722-3725.
[25]. Subramaniam, A. B.; Abkarian, M.; Mahadevan, L.; Stone, H. A. Mechanics of Interfacial Composite Materials. Langmuir 2006, 22, 10204-10208.
[26]. Abkarian, M.; Subramaniam, A. B.; Kim, S.; Larsen, R. J.; Yang, S; Stone, H. A. Dissolution Arrest and Stability of Particle-Covered Bubbles. Physical Review Letters 2007, 99, 188301.
[27]. Hunter, T. N.; Pugh, R. J.; Franks, G. V.; Jameson, G. J. The Role of Particles in Stabilising Foams and Emulsions. Advances in Colloid and Interface Science 2008, 137, 57-81.
[28]. Horozov, T. S. Foams and Foam Films Stabilised by Solid Particles. Current Opinion in Colloid and Interface Science 2008, 13, 134-140.
[29]. Martinez, A. C; Rio, E.; Delon, G.; Saint-Jalmes, A.; Langevin, D.; Binks, B. P. On the Origin of the Remarkable Stability of Aqueous Foams Stabilised by Nanoparticles: Link with Microscopic Surface Properties. Soft Matter 2008, 4, 1531-1535.
[30]. Stocco, A.; Drenckhan, W.; Rio, E.; Langevin, D.; Binks, B. P. Particle-stabilised Foams: An Interfacial Study. Soft Matter 2009, 5, 2215-2222.
[31]. Stocco, A.; Rio, E.; Binks, B. P.; Langevin, D. Aqueous Foams Stabilized Solely by Particles. Soft Matter 2011, 7, 1260-1267.
[32]. Gonzenbach, U. T.; Studart, A. R.; Tervoort, E.; Gauckler, L. J. Ultrastable Particle-Stabilized Foams. Angewandte Chemie International Edition 2006, 45, 3526-3530.
[33]. Gonzenbach, U. T.; Studart, A. R.; Tervoort, E.; Gauckler, L. J. Stabilization of Foams with Inorganic Colloidal Particles. Langmuir 2006, 22, 10983-10988.
[34]. Studart, A. R.; Gonzenbach, U. T.; Akartuna, I.; Tervoort, E.; Gauckler, L. J. Materials from Foams and Emulsions Stabilized by Colloidal Particles. Journal of Materials Chemistry 2007′, 17, 3283-3289.
[35]. Gonzenbach, U. T.; Studart, A. R.; Steinlin, D.; Tervoort, E.; Gauckler, L. J. Processing of Particle-Stabilized Wet Foams into Porous Ceramics. Journal of American Ceramic Society 2007, 90, 3407-3414.
[36]. Gonzenbach, U. T.; Studart, A. R.; Tervoort, E.; Gauckler, L. J. Tailoring the Microstructure of Particle-Stabilized Wet Foams. Langmuir 2007, 23, 1025-1032.
[37]. Gonzenbach, U. T.; Studart, A. R.; Tervoort, E.; Gauckler, L. J. Macroporous Ceramics from Particle-stabilized Wet Foams. Journal of American Ceramic Society 2007, 90, 16-22.
[38]. Wong, J. C. H.; Tervoort, E.; Busato, S.; Gonzenbach, U. T.; Studart, A. R.; Ermanni, P.; Gauckler, L. J. Macroporous Polymers from Particle-stabilized Foams. Journal of Materials Chemistry 2009, 19, 5129-5133.
[39]. Zhou, W.; Cao, J.; Liu, W.; Stoyanov, S. How Rigid Rods Self-assemble at Curved Surfaces. Journal of American Ceramic Society 2009, 48, 378-381.
[40]. Wong, J. C. H.; Tervoort, E.; Busato, S.; Gonzenbach, U. T.; Studart, A. R.; Ermanni, P.; Gauckler, L. J. Designing Macroporous Polymers from Particle-stabilized Foams. Journal of Materials Chemistry 2010, 20, 5628-5640.
[41]. Fujii, S.; Mochizuki, M.; Aono, K.; Hamasaki, S.; Murakami, R.; Nakamura, Y. pH-Responsive Aqueous Foams Stabilized by Hairy Latex Particles. Langmuir 2011, 27, 12902-12909.
[42]. Arriaga, L. R.; Drenckhan, W.; Salonen, A.; Rodrigues, J.; Iniguez-Palomares, R.; Rio, E.; Langevin, D. On the Long-term Stability of Foams Stabilised by Mixtures of Nano-particles and Oppositely Charged Short Chain Surfactants. Soft Matter 2012, 8, 11085-11097.
[43]. Jin, H.; Zhou, W.; Cao, J.; Stoyanov, S. D.; Blijdenstein, T. B. J.; Groot, P. W. N.; Arnaudov, L. N.; Pelan, E. G. Super Stable Foams Stabilized by Colloidal Ethyl Cellulose Particles. Soft Matter 2012, 8, 2194-2205.
[44]. Wong, J. C. H.; Tervoort, E.; Busato, S.; Ermanni, P.; Gauckler, L. J. Engineering Macroporous Composite Materials Using Competitive Adsorption in Particle-stabilized Foams. Journal of Colloid and Interface Science 2012, 383, 1-12.
[45]. Guevara, J. S.; Mejia, A. F.; Shuai, M.; Chang, Y.; Mannan, M. S.; Cheng, Z. Stabilization of Pickering Foams by High-aspect-ratio Nano-sheets. Soft Matter 2013, 9, 1327-1336.
[46]. Fameau, A.; Lam, S.; Velev, 0. D. Multi-stimuli Responsive Foams Combining Particles and Self-assembling Fatty Acids. Chemical Science 2013, 4, 3874-3881.
[47]. Rinaudo, M. Chitin and Chitosan: Properties and Applications. Progress in Polymer Science 2006, 31, 603-632.
[48]. Pillai, C. K. S.; Paul, W.; Sharma, C. P. Chitin and Chitosan Polymers: Chemistry, Solubility and Fiber Formation. Progress in Polymer Science 2009, 34, 641-678.
[49]. Nair, K. G.; Dufresne, A. Crab Shell Chitin Whisker Reinforced Natural Rubber Nanocomposites. 1. Processing and Swelling Behavior. Biomacromolecules 2003, 4, 657-665.
[50]. Raabe, D.; Sachs, C; Romano, P. The Crustacean Exoskeleton as An Example of A Structurally and Mechanically Graded Biological Nanocomposite Material. Acta Materials 2005, 53, 4281-4292.
[51]. Karakashev, S. I.; Ozdemir, O.; Hampton, M. A.; Nguyen, A.V. Formation and Stability of Foams Stabilized by Fine Particles with Similar Size, Contact Angle and Different Shapes. Colloids and Surfaces A: Physicochemical and Engineering Aspects 2011, 382, 132-138.
[52]. Ifuku, S.; Nogi, M.; Abe, K.; Yoshioka, M.; Morimoto, M.; Saimoto, H.; Yano, H. Preparation of Chitin Nanofibers with A Uniform Width as Alpha-chitin from Crab Shells. Biomacromolecules 2009, 10, 1584-1588.
[53]. Liu, X.; Wu, D.; Turgman-Cohen, S.; Genzer, J.; Theyson, T. W.; Rojas, O. J. Adsorption of a Nonionic Symmetric Triblock Copolymer on Surfaces with Different Hydrophobicity. Langmuir 2010, 26, 9565-9574.
[54]. Liu. X.; Vesterinen, A.; Genzer, J.; Seppala, J. V.; Rojas, O. J. Adsorption of PEO-PPO-PEO Triblock Copolymers with End-Capped Cationic Chains of Poly(2-dimethylaminoethyl methacrylate). Langmuir 2011, 27, 9769-9780.
[55]. Tzoumaki, M. V.; Moschakis, T.; Biliaderis, C. G. Metastability of Nematic Gels Made of Aqueous Chitin Nanocrystal Dispersions. Biomacromolecules 2010, 11, 175-181.
[56]. Martin, A. H.; Grolle, K.; Bos, M. A.; Stuart, M. A. C; Vliet, T. Network Forming Properties of Various Proteins Adsorbed at the Air/Water Interface in Relation to Foam Stability. Journal of Colloid and Interface Science 2002, 254, 175-183.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

We claim:

1. A composition comprising:
a suspension of nonaggregated stabilized cationized chitin nanofibers at a pH of about 1 to 6, wherein the chitin nanofiber has a zeta potential of about 10 to 100 mV, wherein each chitin nanofiber has an aspect ratio of about 1 to 1000, wherein the chitin nanofibers have an average diameter of about 20 nm and a diameter range of about 2 to 100 nm, and wherein the suspension has a viscosity of about 0.002 to 10 Pa·s.

2. A structure comprising: stabilized cationized chitin nanofibers, wherein each chitin nanofiber has an aspect ratio of about 1 to 100, wherein the chitin nanofibers have an average diameter of about 20 nm and a diameter range of about 5 to 50 nm.

3. The structure of claim 2, wherein the structure is a film, wherein the film has a thickness of 100 nm to 500 μm, wherein the film is optically transparent, wherein the film has a porosity of about 2 to 4%, wherein the film has a tensile strength of about 120 to 180 MPa, wherein the film has a Young's modulus of about 4.0 to 6.0 GPa.

4. The structure of claim 2, wherein the structure is a self-standing film or a film coating applied to a polymeric material.

5. The structure of claim 3, wherein the film has a CO₂ gas permeability of up to about 0.020 barrer, wherein the film has a O₂ gas permeability of up to about 0.007 barrer.

6. The structure of claim 3, wherein the film is made of 100% cationized chitin nanofibers.

7. The structure of claim 2, wherein the structure is a porous solid foam having an open structure or a closed structure, wherein the foam has a thickness of about 10 μm to 20 cm.

8. The structure of claim 2, wherein the cationized chitin nanofiber is modified by the adsorption of an anionic amphiphile to its surface.

9. The structure of claim 8, wherein the structure is a porous liquid foam having a closed structure, wherein the foam has a thickness of 1 mm to 1 m.

10. The structure of claim 7, wherein the pore size is selected from about 2.5 to 4 μm and a porosity of about 98 to 99%, about 50 to 70 μm and a porosity of about 99 to 99.9%, about 80 to 110 μm and a porosity of about 99 to 99.9%, or about 0.3 to 0.35 μm and a porosity of about 99 to 99.9%.

11. The structure of claim 2, further comprising a polymeric material, where the polymeric material may be a thermoplastic, thermoset, or elastomer, where the concentration of chitin is between 0.5 wt % to 90 wt %.

12. The structure of claim 11, wherein the structure is packaging.

13. A method, comprising:
providing a first mixture aqueous of aggregated chitin;
adjusting the pH of the first mixture to a pH of about 1 to 5 to form a second mixture;
homogenizing the second mixture at a first pressure to form a third mixture; and
homogenizing the third mixture at a second pressure to form a fourth mixture, wherein the first pressure and the second pressure are different, wherein the fourth mixture includes a suspension of nonaggregated stabilized cationized chitin nanofibers at a pH of about 1 to 5, wherein the chitin nanofiber has a zeta potential of about 55 to 60 mV, wherein each chitin nanofiber has an aspect ratio of about 1 to 100, wherein the chitin nanofibers have an average diameter of about 20 nm and a diameter range of about 5 to 50 nm, and wherein the suspension has a viscosity of about 0.002 to 10 Pa·s.

14. The method of claim 13, wherein homogenizing the second mixture includes passing the second mixture through a first restriction at the first pressure to cause a pressure shear and so that the second mixture impinges upon an end of the first restriction, the pressure shear and impingement upon the end of the restriction lead to defibrillation of the aggregated chitin.

15. The method of claim 14, wherein the diameter of the first restriction is about 0.1 to 0.3 mm.

16. The method of claim 14, wherein the first pressure is about 5,000 to 45,000 psia.

17. The method of claim 14, wherein homogenizing the second mixture includes passing the second mixture through a second restriction at the second pressure so that the second mixture impinges upon an end of the second restriction, the pressure shear and impingement upon the end of the restriction lead to defibrillation of the aggregated chitin and the pH causes the chiton fibers to become cationized chitin nanofibers that form a suspension of nonaggregated stabilized cationized chitin nanofibers.

18. The method of claim 17, wherein the diameter of the second restriction is about 0.1 to 0.3 mm, wherein the diameter of the first restriction and the second restriction are different.

19. The method of claim 17, wherein the second pressure is about 20,000 to 30,000 psi.

20. The method of claim 17, wherein the pH is about 4 to 4.5.

21. A method, comprising:
providing a suspension of nonaggregated stabilized cationized chitin nanofibers at a pH of about 1 to 5, wherein the chitin nanofiber has a zeta potential of about 55 to 60 mV, wherein each chitin nanofiber has an aspect ratio of about 1 to 100, wherein the chitin nanofibers have an average diameter of about 20 nm and a diameter range of about 5 to 50 nm, and wherein the suspension has a viscosity of about 0.002 to 10 Pa·s;
freezing the suspension at a temperature of about −5 to −200° C. to form a frozen suspension; and
exposing the frozen suspension to a vacuum to remove the water crystals to form a cationized chitin nanofiber foam.

22. The method of claim 21, wherein when the freezing temperature is about −20° C. the foam has a pore size of about 0.3 to 4 μm and a porosity of about 90 to 99.99%, wherein when the freezing temperature is about −80° C. the foam has a pore size is about 50 to 70 μm and a porosity of about 99 to 99.9%, or wherein when the freezing temperature is about −200° C. the foam has a pore size is about 80 to 110 μm and a porosity of about 99 to 99.9%.
